(19) United States
(12) Patent Application Publication
(10) Pub. No.: US 2011/0042234 A1
(43) Pub. Date: Feb. 24, 2011

(54) INTEGRATED ELECTROLYTIC AND CHEMICAL METHOD FOR PRODUCING CLEAN TREATED WATER WHEREIN CYANIDE SPECIES CONCENTRATION IS LESS THAN 1 MILLIGRAM PER LITER

(75) Inventor: Filip Magalnik, Ashkelon (IL)

Correspondence Address: MARTIN D. MOYNIHAN d/b/a PRTSI, INC., P.O. BOX 16446, ARLINGTON, VA, 22215, US

(73) Assignee: P2W CY Limited, Limassoi (CY)

(21) Appl. No.: 12/989,810

(22) PCT Filed: Apr. 26, 2009
(86) PCT No.: PCT/IL2009/000444

§ 371 Date: Oct. 27, 2010

Related U.S. Application Data
(62) Division of application No. 61/071,413, filed on Apr. 28, 2008.

(51) Int. Cl. C02F 1/461

(52) U.S. Cl. 205/744

(57) ABSTRACT

Integrated electrolytic and chemical method for producing clean treated water having cyanide species concentration less than 1 mg/liter. (a) Electrolytically treating cyanide-containing water having initial cyanide species concentration less than about 500 mg/liter, via synchronized operation of units: input, electrolytic reactor, recycle, output, and, power supply and process control, forming recycled electrolytically treated cyanide-containing water. (b) Stopping electrolytic treatment when cyanide species concentration decreases to first concentration value of about 10 percent initial concentration, forming recycled electrolytically treated cyanide-containing water of first concentration value inside recycle tank of recycle unit. (c) Chemically treating recycled electrolytically treated cyanide-containing water with in-situ real time freshly generated hypochlorite ion solution electrolytically produced by an in-situ hypochlorite ion solution generating electrolytic reactor assembly in-line with recycle tank. (d) Stopping chemical treatment when cyanide species concentration decreases to second concentration value less than 1 mg/liter, forming clean treated water, (e) output to output unit.

### FIELD OF THE INVENTION

The present invention relates to electrolytically and chemically removing cyanide species from cyanide-containing water, and more particularly, to an integrated electrolytic and chemical method for electrolytically and chemically removing cyanide species from cyanide-containing water, for producing clean treated water wherein cyanide species concentration is less than 1 milligram per liter (mg/l) [1 part per million (ppm)]. The present invention is particularly applicable for electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1 cubic meter per hour (m³/hr)]) commercial scale industrial process, such as a mining, metal electroplating, chemical, petrochemical, metallurgical, or paper milling, process. The present invention is generally applicable to removing cyanide species from various different types or kinds (sources) of cyanide-containing water, wherein the cyanide-containing water includes a single type or kind of cyanide species, or includes a combination of two or more different types or kinds of cyanide species. The present invention is readily commercially applicable, practical, and economically feasible to implement. Implementation of the integrated cyanide removal method of the present invention is significantly less time consuming than implementing a cyanide removal method based on similar electrolytic only treatment (i.e., without chemical treatment of the method of the present invention).

### BACKGROUND OF THE INVENTION

Removing cyanide species from cyanide-containing water, theories, principles, and practices thereof, and, related and associated applications and subjects thereof, are well known and taught about in scientific, technical, and patent, literature, and currently practiced in a wide variety of numerous different fields and areas of technology. For the purpose of establishing the scope, meaning, and fields or areas of application, of the present invention, the following background includes selected definitions and exemplary usages of terminology which are relevant to, and used for, disclosing the present invention.

### Cyanide Species and Cyanide-Containing Water

It is well known that free cyanide (typically, more simply referred to as cyanide, being the cyanide ion [CN⁻]), or/and compounds, radicals, or/and ions (such as metal complex radicals or/and ions), containing cyanide, herein, all of these generally being referred to as cyanide species, at sufficiently high concentrations, are toxic or potentially toxic inside of living organisms (humans, animals, plants). Accordingly, any source of water which eventually comes in direct or indirect contact with living organisms should have a total concentration of cyanide species as low as possible. In particular, environmental or health regulatory agencies in many countries throughout the world typically have a standard requirement for surface or drinking water wherein the concentration of weak acid dissociable (WAD) cyanide is not to exceed about 0.2 milligram per liter (mg/l) [0.2 part per million (ppm)], and in some countries, not to exceed about 0.1 milligram per liter (mg/l) [0.1 part per million (ppm)]. As a result, in cyanide-containing water which actively or potentially comes in contact with surface or drinking water, the total concentration of cyanide species needs to be monitored, and if necessary, decreased to an environmentally acceptable level, before actually contacting the surface or drinking water.

Cyanide-containing water, herein, refers to a water (aqueous) solution containing any combination of any number of a wide variety of different forms of cyanide species, such as in the form of free cyanide [CN⁻], or/and in the form of a compound containing cyanide, or/and, in the form of a radical or ion containing cyanide (such as a metal cyanide complex radical or ion). Main categories of compounds containing cyanide are hydrogen cyanide or cyanic acid [HCN], simple salts of cyanide, simple metal cyanides, complex alkali-metallic cyanides, and complex ammonium-metallic cyanides.

Exemplary simple salts of cyanide, which may be present in cyanide-containing water, are sodium cyanide [NaCN], potassium cyanide [KCN], calcium cyanide [Ca(CN)₂], and ammonium cyanide [NH₄CN]. Exemplary simple metal cyanides, which may be present in cyanide-containing water, are transition metal cyanides, such as nickel cyanide [Ni(CN)₂], copper cyanide [CuCN], zinc cyanide [Zn(CN)₂], silver cyanide [AgCN], cadmium cyanide [CdCN], gold cyanide [AuCN], and mercury cyanide [Hg(CN)₂]. Exemplary complex alkali-metallic cyanides and complex ammonium-metallic cyanides, which may be present in cyanide-containing water, are generally represented by the formula [A_{y}M(CN)ₓ], where A is an alkali (for example, sodium, potassium) or ammonium specie, y is the number of alkali or ammonium species, M is a metal specie, such as of a transition metal (for example, iron, nickel, copper, zinc, silver, cadmium, tin, gold, mercury) or alloy of two or more transition metals (for example, copper and zinc), and x is the number of cyanide [CN] groups. The value of x is equal to the valence of A taken y times, plus the valence of the metal specie.

In water, a soluble complex alkali-metallic cyanide or complex ammonium-metallic cyanide dissociates into the alkali or ammonium species, A, and the metal cyanide complex radical or ion, [M(CN)ₓ], typically, as a metal cyanide complex anion, [M(CN)ₓ]^{-z}, where −z is the total negative charge of the metal cyanide complex anion. Exemplary metal cyanide complex anions, [M(CN)ₓ]^{-z}, which may be present in cyanide-containing water, are [Fe(CN)₆]⁻³, [Ni(CN)₄]⁻², [Cu(CN)₂]⁻¹, [Zn(CN)₄]⁻², [CuZn(CN)₃]⁻², [Ag(CN)₂]⁻¹, [Cd(CN)₃]⁻², [Cd(CN)₄]⁻², [Sn(CN)₃]⁻², [Sn(CN)₄]⁻², [Au(CN)₂]⁻¹, and [Hg(CN)₄]⁻². Under appropriate conditions, the metal cyanide complex radical or ion may itself undergo dissociation into the metal ion and the cyanide ions [CN⁻]. Metal cyanide complex ions may be considered as the soluble products of the reaction between the corresponding insoluble simple salt of cyanide and excess cyanide ion.

Cyanide-containing water, being a water (aqueous) solution containing any combination of any number of a wide variety of different forms of cyanide species, is most commonly produced during an industrial process. There exists a wide variety of different types of industrial processes which involve the production of cyanide-containing water. Among the most well known and currently employed types of industrial processes which involve the production of cyanide-containing water are mining (for example, gold and silver mining), metal electroplating (for example, transition or noble metal electroplating), chemical, petrochemical, metallurgical (for example, manufacturing and finishing of metals), and paper milling, processes.

In cyanide-containing water the actual form or forms of a particular cyanide specie, associated or/and dissociated components thereof, and relative concentrations thereof, are determined by, and are direct functions of, the physicochemical properties, parameters, and characteristics, of the particular cyanide specie, and of the cyanide-containing water. Primary physicochemical properties, parameters, and characteristics, are the equilibrium constant of the particular cyanide specie, the temperature of the cyanide-containing water, the pH of the cyanide-containing water, and if applicable, the possible additional presence and physicochemical properties, parameters, and characteristics, of any number of different types and forms of non-cyanide chemical species (compounds, radicals, ions) in the cyanide-containing water. In turn, these primary physicochemical properties, parameters, and characteristics, are determined by, and are direct functions of, the physicochemical properties, parameters, characteristics, and operating conditions, of the particular industrial process which produces the cyanide-containing water.

Removing Cyanide Species from Cyanide-Containing Water

There is a wide variety of various different teachings for removing cyanide species from cyanide-containing water. Among the most well known and currently employed teachings for removing cyanide species from cyanide-containing water are those based on theories and practices of natural degradation (involving a combination of the naturally occurring processes of evaporation, hydrolysis, photodegradation, dissociation, chemical and bacterial oxidation, or/and precipitation); chemical oxidation (involving use of an oxidizing agent, such as chlorine or/and its oxygen containing compounds (for example, hypochlorite), ozone, hydrogen peroxide, or ammonium polysulphide); acidification/volatilization/reneutralization; adsorption (involving ion exchange, activated carbon, ion flotation, or precipitation flotation); electrochemistry (involving electrolysis based on electroreduction, electrooxidation, or electrochlorination); electrodialysis; complexation; precipitation; sedimentation; and bio-degradation.

A brief, but concise, description of each of these teachings, as well as a detailed description of an invention for rendering a cyanide-containing compound substantially insoluble in an aqueous solution or suspension, or, in a solid, form of a cyanide-containing material, via complexation, is provided by Misra, et al. [1]. According to a given set of the above indicated physicochemical properties, parameters, and characteristics, of the particular cyanide species present in the cyanide-containing water, and of the cyanide-containing water, and according to a given set of the physicochemical properties, parameters, characteristics, and operating conditions, of the particular industrial process which produces the cyanide-containing water, each teaching for removing cyanide species from cyanide-containing water has unique advantages and disadvantages, particularly with respect to commercial applicability, practicality, or/and economical feasibility of implementation, especially for a high volume throughput commercial scale industrial process where there is need for decreasing low levels (less than about 500 milligrams per liter (mg/l) [500 parts per million (ppm)] of cyanide species concentration in cyanide-containing water to less than 1 milligram per liter (mg/l) [1 part per million (ppm)] in the clean treated water.

Electrolytically Removing Cyanide Species from Cyanide-Containing Water, and Limitations Thereof

The present invention is focused on using an electrolysis or electrolytic based technique as the main or primary process for removing the major portion of cyanide species from cyanide-containing water.

In a conventional electrolytic cell, direct current is applied to spaced electrodes immersed in a solution undergoing treatment, and the electrical circuit of the system is completed solely through ionization of the solution and migration of the ions to the surfaces of the electrodes. Thus, all of the current in a conventional electrolytic cell is carried through the solution by ion migration. At the surface of the electrode, an electrical charge is transferred between the ions in solution and conductive electrode. At the anode, electrons from the ions (anions) are lost to the electrode, or oxidation occurs; at the cathode, the ions (cations) gain electrons from the electrode, or reduction occurs. The electrodes thus act as catalytic surfaces on which the electrochemical (electrolytic) reactions take place in a localized manner.

Since the current or flow of electrons within the electrolyte is carried only by the ions, for any given fixed applied potential at the electrodes, the amount of current passing through the system is, in general, proportional to the concentration of the ions present in solution. Hence, as the ion content decreases, the current in the system also decreases, and since the reactions which occur at the electrode surfaces are dependent on the flow of electrons, clearly, the rates of the reactions decrease with decreasing concentrations of the ions. Accordingly, the resistance or resistivity of the electrolyte itself increases with decreasing concentration of ions present. Thus, for a fixed applied potential, in order to maintain a substantially constant rate of electron flow it is necessary to decrease the distance between the electrodes as ion concentration decreases. This phenomenon presents significant limitations with respect to the design and operation of conventional electrolytic cells for selectively removing contaminant chemicals, such as cyanide species, from contaminated water, in particular, with respect to commercial applicability, practicality, or/and economical feasibility of implementation, especially for a high volume throughput commercial scale industrial process where there is need for decreasing low levels (less than about 500 milligrams per liter (mg/l) [500 parts per million (ppm)] of cyanide species concentration in cyanide-containing water to less than 1 milligram per liter (mg/l) [1 part per million (ppm)] in the clean treated water.

An additional significant limitation associated with the use of conventional electrolytic techniques for selectively removing contaminant chemicals, for example, cyanide species, especially at low concentrations, from contaminated water, such as cyanide-containing water, is based on the phenomenon that as the total concentration of (charged) cyanide species decreases, progressively longer times are required to achieve further decrease in cyanide species concentration, for example, to as low as on the order of about 1 milligram per liter (mg/l) [1 part per million (ppm)], under fixed electrolytic conditions. For example, typically, electrolytic decomposition of cyanide species in cyanide-containing effluents exiting from metal finishing processes, using a conventional electrolytic cell type reactor system, is efficient only for (charged) cyanide species being present at relatively high concentrations (typically, substantially higher than about 500 milligrams per liter (mg/l) [500 parts per million (ppm)]). For (charged) cyanide species at concentrations below about 500 milligrams per liter (mg/l) [500 parts per million (ppm)] the efficiency of the electrolytic system drops to a value so low as to become commercially inapplicable, impractical, or/and economically unfeasible to implement, especially for a high volume throughput commercial scale industrial process where there is need for decreasing low levels (less than about 500 milligrams per liter (mg/l) [500 parts per million (ppm)]) of cyanide species concentration in cyanide-containing water to less than 1 milligram per liter (mg/l) [1 part per million (ppm)] in the clean treated water.

There are extensive teachings [e.g., 2-7] of using an electrolysis or electrolytic based technique as a ‘stand-alone’ single process for removing cyanide species from cyanide-containing water. Such teachings either include the just described significant limitations associated with the use of conventional electrolytic techniques, or introduce at least one other significant limitation so as to become commercially inapplicable, impractical, or/and economically unfeasible to implement, especially for a high volume throughput commercial scale industrial process where there is need for decreasing low levels (less than about 500 milligrams per liter (mg/l) [500 parts per million (ppm)]) of cyanide species concentration in cyanide-containing water to less than 1 milligram per liter (mg/l) [1 part per million (ppm)] in the clean treated water.

Chemically (Via Oxidation) Removing, Cyanide Species from Cyanide-Containing Water

In addition to being focused on using an electrolysis or electrolytic based technique as the main or primary process for removing the major portion of cyanide species from cyanide-containing water, the present invention includes using a chemical oxidation based technique as the secondary process for removing the minor remaining portion of cyanide species from the cyanide-containing water.

Chemical oxidation based techniques which are used for removing cyanide species from cyanide-containing water involve use of an oxidizing agent, such as chlorine or/and its oxygen containing compounds (for example, hypochlorite), ozone, hydrogen peroxide, or ammonium polysulphide.

There are extensive teachings [e.g., 4, 8-24] of using a chemical oxidation based technique as a ‘stand-alone’ single process for removing cyanide species from cyanide-containing water.

There are also extensive teachings [e.g., 25-28] of removing cyanide species from cyanide-containing water by utilizing an electrolysis or electrolytic based technique as the main or primary process, combined with required, or optional, use of a chemical oxidation based technique (involving, for example, hypochlorite, ozone, hydrogen peroxide, or ammonium polysulphide) as the secondary process for additionally or further removing cyanide species from the cyanide-containing water.

Each of the above referenced teachings for removing cyanide species from cyanide-containing water has unique advantages and disadvantages, particularly with respect to commercial applicability, practicality, or/and economical feasibility of implementation, especially for a high volume throughput commercial scale industrial process where there is need for decreasing low levels (less than about 500 milligrams per liter (mg/l) [500 parts per million (ppm)]) of cyanide species concentration in cyanide-containing water to less than 1 milligram per liter (mg/l) [1 part per million (ppm)] in the clean treated water.

Based on the continuous need for monitoring and decreasing concentrations of cyanide species in cyanide-containing water, typically produced during commercial scale industrial processes, to environmentally acceptable levels before such sources of water come in direct or indirect contact with living organisms, there is an on-going need for designing, developing, and implementing, improved or/and new techniques for removing cyanide species from cyanide-containing water. Moreover, despite the existence of extensive teachings in the fields and areas of application encompassing the subject of removing cyanide species from cyanide-containing water, and in view of the above described various significant limitations associated with such teachings, there also is an on-going need for developing and practicing improved or/and new techniques for removing cyanide species from cyanide-containing water.

There is thus a need for, and it would be highly advantageous and useful to have an integrated electrolytic and chemical method for electrolytically and chemically removing cyanide species from cyanide-containing water, for producing clean treated water wherein cyanide species concentration is less than 1 milligram per liter (mg/l) [1 part per million (ppm)]. There is also need for such an invention which is particularly applicable for electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1000 cubic meters per hour (m³/hr)]) commercial scale industrial process, such as a mining, metal electroplating, chemical, petrochemical, metallurgical, or paper milling, process. There is also need for such an invention which is generally applicable to removing cyanide species from various different types or kinds (sources) of cyanide-containing water, wherein the cyanide-containing water includes a single type or kind of cyanide species, or includes a combination of two or more different types or kinds of cyanide species. There is further need for such an invention which is readily commercially applicable, practical, and economically feasible to implement.

### SUMMARY OF THE INVENTION

The present invention relates to an integrated electrolytic and chemical method for electrolytically and chemically removing cyanide species from cyanide-containing water, for producing clean treated water wherein cyanide species concentration is less than 1 milligram per liter (mg/l) [1 part per million (ppm)]. The present invention is particularly applicable for electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1000 cubic meters per hour (m³/hr)]) commercial scale industrial process, such as a mining, metal electroplating, chemical, petrochemical, metallurgical, or paper milling, process. The present invention is generally applicable to removing cyanide species from various different types or kinds (sources) of cyanide-containing water, wherein the cyanide-containing water includes a single type or kind of cyanide species, or includes a combination of two or more different types or kinds of cyanide species. The present invention is readily commercially applicable, practical, and economically feasible to implement. Implementation of the integrated cyanide removal method of the present invention is significantly less time consuming than implementing a cyanide removal method based on similar electrolytic only treatment (i.e., without chemical treatment of the method of the present invention).

Thus, according to a main aspect of some embodiments of the present invention, there is provided an integrated electrolytic and chemical method for producing clean treated water wherein cyanide species concentration is less than 1 milligram per liter (mg/l) [1 part per million (ppm)], the method comprising: electrolytically treating a batch amount of cyanide-containing water wherein initial cyanide species concentration is less than about 500 milligrams per liter, via synchronized operation of an input unit, an electrolytic reactor unit, a recycle unit, an output unit, and, a power supply and process control unit, for forming recycled electrolytically treated cyanide-containing water; stopping the electrolytic treatment when cyanide species concentration of the recycled electrolytically treated cyanide-containing water decreases to a first concentration value of about 10 percent of the initial concentration, for forming recycled electrolytically treated cyanide-containing water of the first concentration value contained inside a recycle tank of the recycle unit; chemically treating the recycled electrolytically treated cyanide-containing water of the first concentration value inside the recycle tank with in-situ real time freshly generated hypochlorite ion solution electrolytically produced by an in-situ hypochlorite ion solution generating electrolytic reactor assembly configured in-line with the recycle tank; stopping the chemical treatment when cyanide species concentration inside the recycle tank decreases to a second concentration value of less than 1 milligram per liter, for forming clean treated water of the second concentration value contained inside the recycle tank; and outputting the clean treated water of the second concentration value from the recycle tank to the output unit.

According to some embodiments of the present invention, the synchronized operation includes utilizing an empirically determined database of empirically determined values derived from an empirically determined calibration curve or table of empirically determined values of redox potential of the recycled electrolytically treated cyanide-containing water as a function of empirically known or/and determined values of the cyanide species concentration of the recycled electrolytically treated cyanide-containing water.

According to some embodiments of the present invention, the step of stopping the electrolytic treatment is performed by utilizing data and information provided by the empirically determined database.

According to some embodiments of the present invention, the step of stopping the electrolytic treatment includes stopping the recycled electrolytically treated cyanide-containing water inside the recycle tank from exiting the recycle tank.

According to some embodiments of the present invention, the step of stopping the electrolytic treatment includes temporarily stopping of supplying power to electrodes of the electrolytic reactor unit, thereby saving energy (electricity) for operating said electrolytic reactor unit.

According to some embodiments of the present invention, the step of chemically treating the recycled electrolytically treated cyanide-containing water includes preparing a fresh aqueous solution of sodium chloride in a mixing vessel operatively connected to the in-situ hypochlorite ion solution generating electrolytic reactor assembly.

According to some embodiments of the present invention, the sodium chloride is provided to the mixing vessel and is dissolved in water originating from a water source selected from the group consisting of: an externally available water source, and an internally available water source being the recycled electrolytically treated cyanide-containing water of the first concentration value contained inside the recycle tank.

According to some embodiments of the present invention, the sodium chloride is provided to the mixing vessel and is dissolved in water originating from an internally available water source being the recycled electrolytically treated cyanide-containing water of the first concentration value contained inside the recycle tank.

According to some embodiments of the present invention, the freshly prepared aqueous solution of sodium chloride has a sodium chloride concentration in a range of between 40 grams per liter and about 60 grams per liter.

According to some embodiments of the present invention, the electrolytic production of the in-situ real time freshly generated hypochlorite ion solution by the in-situ hypochlorite ion solution generating electrolytic reactor assembly is initiated and performed at a time before, during, or following, the stopping of the electrolytic treatment.

According to some embodiments of the present invention, the in-situ real time freshly generated hypochlorite ion solution has a hypochlorite ion concentration in a range of between 8 grams per liter and about 12 grams per liter.

According to some embodiments of the present invention, the in-situ real time freshly generated hypochlorite ion solution and the recycled electrolytically treated cyanide-containing water continuously mix and react with each other while inside of the recycle tank, and while circulating through components of a cyanide species measuring loop operatively connected to the recycle tank.

According to some embodiments of the present invention, the step of stopping the chemical treatment is performed by utilizing data and information provided by the empirically determined database.

According to some embodiments of the present invention, the step of stopping the chemical treatment includes temporarily stopping of supplying power to electrodes of the in-situ hypochlorite ion solution generating electrolytic reactor assembly, in a manner for temporarily stopping the electrolytic production of the in-situ real time freshly generated hypochlorite ion solution, thereby saving energy (electricity) for operating the in-situ hypochlorite ion solution generating electrolytic reactor assembly.

According to some embodiments of the present invention, the clean treated water of the second concentration value contained inside the recycle tank has a cyanide concentration of about 0.1 milligram per liter.

According to some embodiments of the present invention, the step of chemically treating the recycled electrolytically treated cyanide-containing water is performed for a duration of time in a range of between about 5-17% of total duration of time required to decrease the cyanide species concentration from the initial cyanide species concentration to the second concentration value of the clean treated water contained inside the recycle tank.

According to some embodiments of the present invention, the step of chemically treating the recycled electrolytically treated cyanide-containing water is performed for a duration of time in a range of between about 4.5-6.3% of total duration of time required to decrease the cyanide species concentration from the initial cyanide species concentration to the second concentration value of the clean treated water contained inside the recycle tank.

According to some embodiments of the present invention, the batch of the cyanide-containing water contains cyanide species in a form selected from the group consisting of free cyanide [CN⁻], a compound containing cyanide, and a radical or ion containing cyanide.

According to some embodiments of the present invention, the compound containing cyanide is selected from the group consisting of hydrogen cyanide or cyanic acid [HCN], simple salts of cyanide, simple metal cyanides, complex alkali-metallic cyanides, and complex ammonium-metallic cyanides.

According to some embodiments of the present invention, the simple metal cyanide is a transition metal cyanide selected from the group consisting of nickel cyanide [Ni(CN)₂], copper cyanide [CuCN], zinc cyanide [Zn(CN)₂], silver cyanide [AgCN], cadmium cyanide [CdCN], gold cyanide [AuCN], and mercury cyanide [Hg(CN)₂].

According to some embodiments of the present invention, said batch of said cyanide-containing water is obtained from an external source being (effluent) output of a commercial scale industrial mining, metal electroplating, chemical, petrochemical, metallurgical, or paper milling, process.

According to some embodiments of the present invention, said batch of said cyanide-containing water has a volume of at least about 1000 liters.

According to some embodiments of the present invention, the initial cyanide species concentration is less than about 100 milligrams per liter.

The present invention is implemented by performing steps or procedures, and sub-steps or sub-procedures, in a manner selected from the group consisting of manually, semi-automatically, fully automatically, and a combination thereof, involving use and operation of system units, system sub-units, devices, assemblies, sub-assemblies, mechanisms, structures, components, and elements, and, peripheral equipment, utilities, accessories, and materials. Moreover, according to actual steps or procedures, sub-steps or sub-procedures, system units, system sub-units, devices, assemblies, sub-assemblies, mechanisms, structures, components, and elements, and, peripheral equipment, utilities, accessories, and materials, used for implementing a particular embodiment of the disclosed invention, the steps or procedures, and sub-steps or sub-procedures, are performed by using hardware, software, or/and an integrated combination thereof, and the system units, sub-units, devices, assemblies, sub-assemblies, mechanisms, structures, components, and elements, and, peripheral equipment, utilities, accessories, and materials, operate by using hardware, software, or/and an integrated combination thereof.

For example, software used, via an operating system, for implementing the present invention can include operatively interfaced, integrated, connected, or/and functioning written or/and printed data, in the form of software programs, software routines, software sub-routines, software symbolic languages, software code, software instructions or protocols, software algorithms, or a combination thereof. For example, hardware used for implementing the present invention can include operatively interfaced, integrated, connected, or/and functioning electrical, electronic or/and electromechanical system units, sub-units, devices, assemblies, sub-assemblies, mechanisms, structures, components, and elements, and, peripheral equipment, utilities, accessories, and materials, which may include one or more computer chips, integrated circuits, electronic circuits, electronic sub-circuits, hard-wired electrical circuits, or a combination thereof, involving digital or/and analog operations. The present invention can be implemented by using an integrated combination of the just described exemplary software and hardware.

In exemplary embodiments of the present invention, steps or procedures, and sub-steps or sub-procedures, can be performed by a data processor, such as a computing platform, for executing a plurality of instructions. Optionally, the data processor includes volatile memory for storing instructions or/and data, or/and includes non-volatile storage, for example, a magnetic hard-disk or/and removable media, for storing instructions or/and data. Optionally, exemplary embodiments of the present invention include a network connection. Optionally, exemplary embodiments of the present invention include a display device and a user input device, such as a keyboard or/and ‘mouse’.

### BRIEF DESCRIPTION OF THE DRAWINGS

Some embodiments of the present invention are herein described, by way of example only, with reference to the accompanying drawings. With specific reference now to the drawings in detail, it is stressed that the particulars shown are by way of example and for purposes of illustrative description of some embodiments of the present invention. In this regard, the description taken together with the accompanying drawings make apparent to those skilled in the art how some embodiments of the present invention may be practiced.

In the drawings:

FIG. 1 is a (block-type) flow diagram of an exemplary embodiment of the main steps (procedures) of the integrated electrolytic and chemical method (‘the integrated cyanide species removal method’) for electrolytically and chemically removing cyanide species from cyanide-containing water, for producing clean treated water wherein cyanide species concentration is less than 1 milligram per liter (mg/l) [1 part per million (ppm)], in accordance with the present invention; and

FIG. 2 is a schematic diagram illustrating an exemplary embodiment of an exemplary integrated electrolytic and chemical type of cyanide species removal system (‘the integrated cyanide species removal system’) which can be used for implementing some embodiments of the method of the present invention illustrated in FIG. 1, in accordance with the present invention.

### DESCRIPTION OF SPECIFIC EMBODIMENTS OF THE INVENTION

The present invention relates to an integrated electrolytic and chemical method for electrolytically and chemically removing cyanide species from cyanide-containing water, for producing clean treated water wherein cyanide species concentration is less than 1 milligram per liter (mg/l) [1 part per million (ppm)]. The present invention is particularly applicable for electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1000 cubic meters per hour (m³/hr)]) commercial scale industrial process, such as a mining, metal electroplating, chemical, petrochemical, metallurgical, or paper milling, process. The present invention is generally applicable to removing cyanide species from various different types or kinds (sources) of cyanide-containing water, wherein the cyanide-containing water includes a single type or kind of cyanide species, or includes a combination of two or more different types or kinds of cyanide species. The present invention is readily commercially applicable, practical, and economically feasible to implement. Implementation of the integrated cyanide removal method of the present invention is significantly less time consuming than implementing a cyanide removal method based on similar electrolytic only treatment (i.e., without chemical treatment of the method of the present invention).

A main aspect of some embodiments of the present invention is provision of an integrated electrolytic and chemical method for producing clean treated water wherein cyanide species concentration is less than 1 milligram per liter (mg/l) [1 part per million (ppm)], the method including the following main steps or procedures, and, components and functionalities thereof: (a) electrolytically treating a batch amount of cyanide-containing water wherein initial cyanide species concentration is less than about 500 milligrams per liter, via synchronized operation of an input unit, an electrolytic reactor unit, a recycle unit, an output unit, and, a power supply and process control unit, for forming recycled electrolytically treated cyanide-containing water; (b) stopping the electrolytic treatment when cyanide species concentration of the recycled electrolytically treated cyanide-containing water decreases to a first concentration value of about 10 percent of the initial concentration, for forming recycled electrolytically treated cyanide-containing water of the first concentration value contained inside a recycle tank of the recycle unit; (c) chemically treating the recycled electrolytically treated cyanide-containing water of the first concentration value inside the recycle tank with in-situ real time freshly generated hypochlorite ion solution electrolytically produced by an in-situ hypochlorite ion solution generating electrolytic reactor assembly configured in-line with the recycle tank; (d) stopping the chemical treatment when cyanide species concentration inside the recycle tank decreases to a second concentration value of less than 1 milligram per liter, for forming clean treated water of the second concentration value contained inside the recycle tank; and (e) outputting the clean treated water of the second concentration value from the recycle tank to the output unit.

Embodiments of the present invention include several special technical features, and, aspects of novelty and inventiveness over prior art teachings of electrolytically and chemically removing cyanide species from cyanide-containing water.

As stated hereinabove in the Background section, a significant limitation associated with the use of conventional electrolytic techniques for selectively removing contaminant chemicals, for example, cyanide species, especially at low concentrations, from contaminated water, such as cyanide-containing water, is based on the phenomenon that as the total concentration of (charged) cyanide species decreases, progressively longer times are required to achieve further decrease in cyanide species concentration, for example, to as low as on the order of about 1 milligram per liter (mg/l) [1 part per million (ppm)], under fixed electrolytic conditions. For example, typically, electrolytic decomposition of cyanide species in cyanide-containing effluents exiting from metal finishing processes, using a conventional electrolytic cell type reactor system, is efficient only for (charged) cyanide species being present at relatively high concentrations (typically, substantially higher than about 500 milligrams per liter (mg/l) [500 parts per million (ppm)]). For (charged) cyanide species at concentrations below about 500 milligrams per liter (mg/l) [500 parts per million (ppm)] the efficiency of the electrolytic system drops to a value so low as to become commercially inapplicable, impractical, or/and economically unfeasible to implement, especially for a high volume throughput commercial scale industrial process where there is need for decreasing low levels (less than about 500 milligrams per liter (mg/l) [500 parts per million (ppm)]) of cyanide species concentration in cyanide-containing water to less than 1 milligram per liter (mg/l) [1 part per million (ppm)] in the clean treated water.

The integrated electrolytic and chemical method for electrolytically and chemically removing cyanide species from cyanide-containing water, for producing clean treated water wherein cyanide species concentration is less than 1 milligram per liter (mg/l) [1 part per million (ppm)], of the present invention, readily overcomes the just stated significant limitation, as well as other limitations, associated with conventional electrolytic techniques that are currently used for selectively removing cyanide species, particularly at low concentrations (less than about 500 milligrams per liter (mg/l) [500 parts per million (ppm)]), from cyanide-containing water.

In the context of the field and art of the present invention, and in view of the preceding described significant limitation associated with the use of conventional electrolytic techniques for selectively removing contaminant chemicals, for example, cyanide species, especially at low concentrations, from contaminated water, such as cyanide-containing water, it is well known that processing time constraints, and therefore, processing time parameters, are critically important during operation of essentially any commercial scale industrial process, such as a mining, metal electroplating, chemical, petrochemical, metallurgical, or paper milling, process, wherein there is need for decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1 cubic meter per hour (m³/hr)]). Accordingly, actual processing time constraints, and therefore, actual processing time parameters, must be measured and analyzed in order to determine whether or not a given cyanide species removal process is commercially applicable, practical, and economically feasible to implement.

Various special technical features of some embodiments of the present invention relate to the definition and use of the critically important processing time parameter of the ‘cyanide species concentration reduction processing time’ (also referred to as the ‘electrolytic and chemical treatment total processing time’).

As stated hereinbelow at the end of the section containing illustrative description of Step (d), and explained in further illustrative detail in the section preceding the hereinbelow Examples section, for characterizing some embodiments of the integrated cyanide removal method of the present invention, in general, and for characterizing the performing of Steps (b)-(d), in particular, herein, there is defined and used the critically important processing time parameter of: the ‘cyanide species concentration reduction processing time’ (also referred to as the ‘electrolytic and chemical treatment total processing time’). The ‘cyanide species concentration reduction processing time’ (the ‘electrolytic and chemical treatment total processing time’) refers to the total duration (interval or period) of time required to decrease the cyanide species concentration from the initial cyanide species concentration (i.e., of less than about 500 milligrams per liter (mg/l) [500 parts per million (ppm)]) in the cyanide-containing water to the second concentration value (i.e., of less than 1 milligram per liter (mg/l) [1 part per million (ppm)]) of the clean (electrolytically and chemically) treated water (clean treated water) contained inside the recycle tank of the recycle unit.

More specifically, with respect to implementing some embodiments of the integrated cyanide removal method of the present invention, the ‘cyanide species concentration reduction processing time’ refers to the total duration (interval or period) of time spanning from the time of starting the procedure in Step (a) of initiating and directing electrolytic reactor unit feed solution to flow from the water holding and mixing vessel of the input unit and into the reactor housing bottom section of the reactor housing assembly of the electrolytic reactor unit, through the time of completing the procedure in Step (d) of forming the clean (electrolytically and chemically) treated water (clean treated water) of the second concentration value contained inside the recycle tank of the recycle unit. Since the integrated cyanide removal method of the present invention is based on integration of an electrolytic treatment and a chemical treatment of the cyanide-containing water, therefore, the ‘cyanide species concentration reduction processing time’ corresponds to an ‘electrolytic and chemical treatment total processing time’.

The time parameter ‘cyanide species concentration reduction processing time’ is especially useful when comparing implementation of some embodiments of the integrated cyanide removal method of the present invention to either a first case of implementation of a cyanide removal method based on similar electrolytic only treatment (i.e., without chemical treatment [via Steps (b)-(d) of the method of the present invention]) of the cyanide-containing water, or, to a second case of implementation of a cyanide removal method based on similar chemical only treatment (i.e., without electrolytic treatment [via Steps (a)-(b) of the method of the present invention]) of the cyanide-containing water. In such first and second cases, the ‘cyanide species concentration reduction processing time’ corresponds to either an ‘electrolytic only treatment total processing time’, or, to a ‘chemical only treatment processing time’, respectively.

As described and exemplified hereinbelow in the Examples section, while performing experiments for the objective of trying to decrease the ‘cyanide species concentration reduction processing time’ by feasibly and optimally integrating a chemical treatment of cyanide-containing water into an electrolytic treatment of cyanide-containing water (e.g., via Steps (b)-(d) of the method of the present invention), the inventors unexpectedly observed that the ‘cyanide species concentration reduction processing time’ (i.e., the ‘electrolytic and chemical treatment total processing time’) of some embodiments of the integrated cyanide removal method of the present invention was unexpectedly, significantly less (e.g., up to about 65% less) compared to the ‘cyanide species concentration reduction processing time’ (i.e., the ‘electrolytic only treatment total processing time’) of a cyanide removal method based on similar electrolytic only treatment (i.e., without chemical treatment [via Steps (b)-(d) of the method of the present invention]) of the cyanide-containing water.

By further analyzing the ‘cyanide species concentration reduction processing time’ data of the stated comparative studies provided in the Examples section, the inventors made the following two critically important observations.

First, when implementing some embodiments of the integrated cyanide removal method of the present invention, the step of chemically treating the recycled electrolytically treated cyanide-containing water requires, and is therefore performed for, a ‘duration of time’ in a range of between about 5-17%, and even for ‘as low as’ in a range of between about 4.5-6.3%, of the ‘total duration of time’ required to decrease the cyanide species concentration from the initial cyanide species concentration to the second concentration value of the clean treated water contained inside the recycle tank. More specifically, the duration (interval or period) of time required for (chemically) further decreasing the cyanide species concentration inside the recycle tank from the first concentration value {i.e., of about 10 percent of the initial concentration (of the cyanide-containing water of less than about 500 milligrams per liter (mg/l) [500 parts per million (ppm)])}, corresponding to the point of time between completion of Step (b) and initiation of Step (c), to the (final, clean treated water) second concentration value {i.e., of less than 1 milligram per liter (mg/l) [1 part per million (ppm)}, corresponding to the point of time at completion of Step (d), unexpectedly accounted for in a range of between about 5-17%, and even for ‘as low as’ in a range of between about 4.5-6.3%, of the ‘cyanide species concentration reduction processing time’ (i.e., the ‘electrolytic and chemical treatment total processing time’).

Second, by strong contrast, when implementing a cyanide removal method based on similar electrolytic only treatment (i.e., without chemical treatment [via Steps (b)-(d) of the method of the present invention]) of the cyanide-containing water, the duration (interval or period) of time required for (electrolytically only) further decreasing the cyanide species concentration inside the recycle tank from the first concentration value {i.e., of about 10 percent of the initial concentration (of the cyanide-containing water of less than about 500 milligrams per liter (mg/l) [500 parts per million (ppm)])}, to the (final, clean treated water) second concentration value {i.e., of less than 1 milligram per liter (mg/l) [1 part per million (ppm)}, accounted for ‘as high as’ in a range of between about 58-83% of the ‘cyanide species concentration reduction processing time’ (i.e., the ‘electrolytic only treatment total processing time’).

The preceding two critically important observations lead the inventors to therefore generally conclude that when implementing some embodiments of the integrated cyanide removal method of the present invention, the duration (interval or period) of time required for (chemically) further decreasing the cyanide species concentration inside the recycle tank from the first concentration value {i.e., of about 10 percent of the initial concentration (of cyanide-containing water 12 of less than about 500 milligrams per liter (mg/l) [500 parts per million (ppm)])}, to the (final, clean treated water) second concentration value {i.e., of less than 1 milligram per liter (mg/l) [1 part per million (ppm)}, is in a range of between about 6% and 23% [i.e., about 5-17% compared to about 58-83%] of the duration (interval or period) of time required for (electrolytically only) further decreasing the cyanide species concentration when implementing a cyanide removal method based on similar electrolytic only treatment (i.e., without chemical treatment [via Steps (b)-(d) of the method of the present invention]) of the cyanide-containing water.

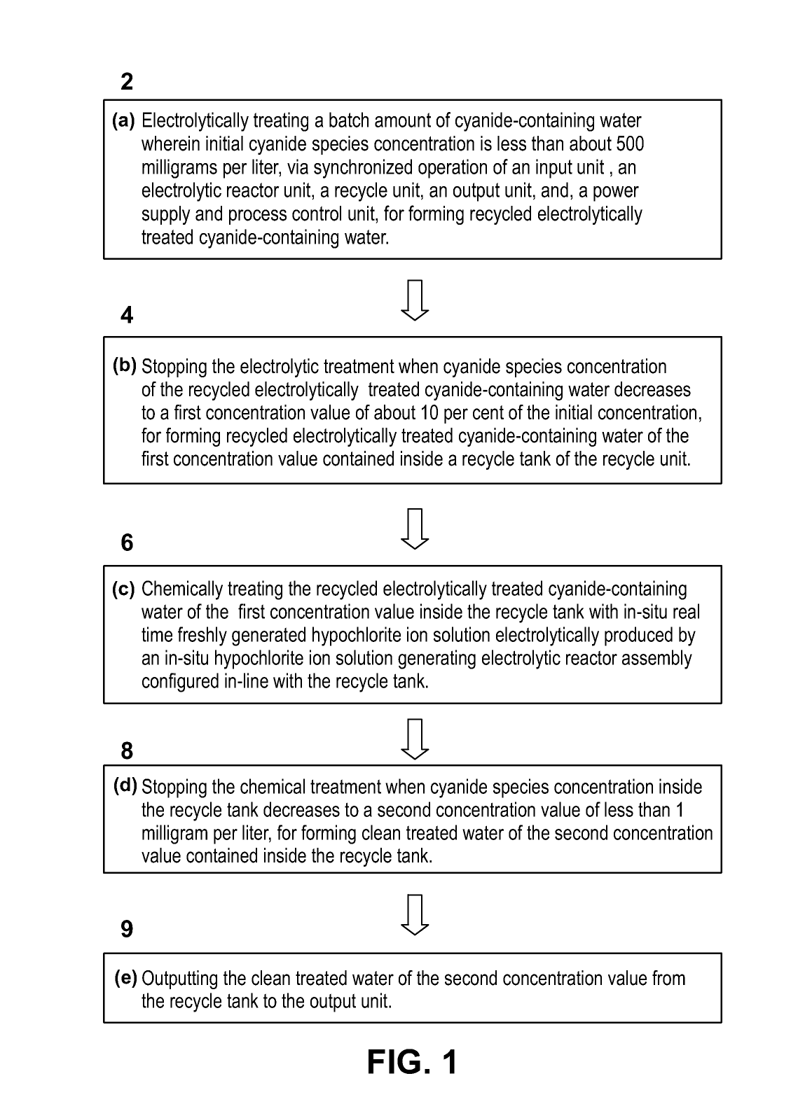

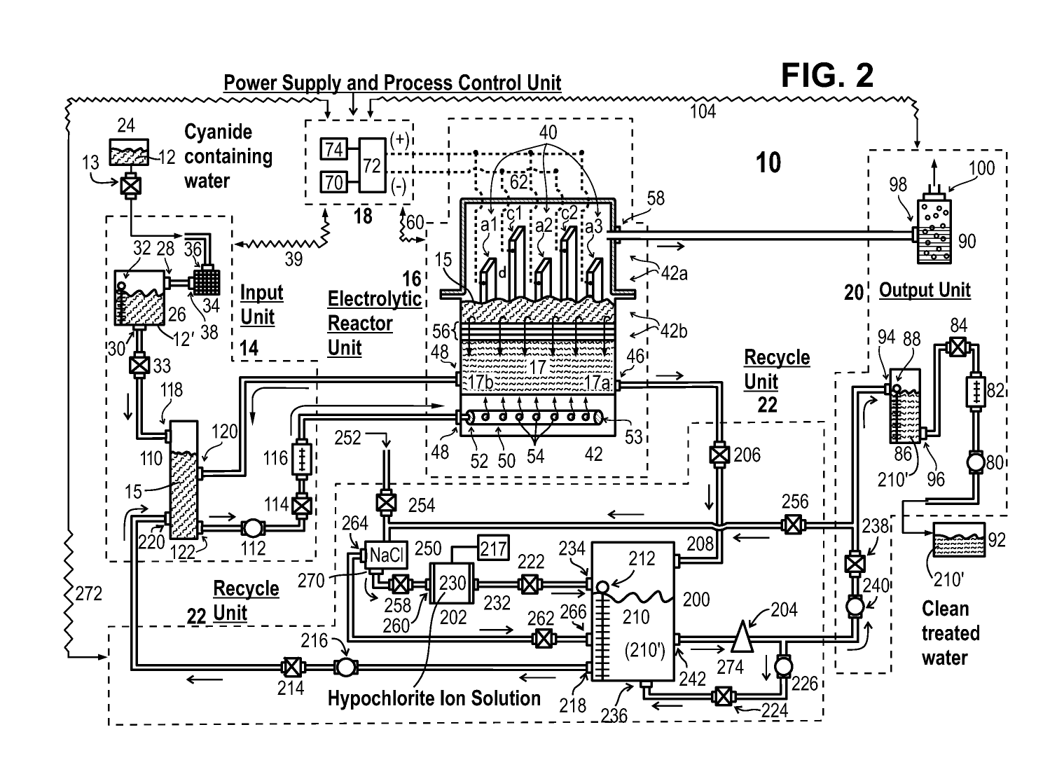

The preceding discussion leads to the overall general conclusion that implementing some embodiments of the hereinabove illustratively described, and hereinbelow exemplified, integrated cyanide removal method (FIG. 1) of the present invention, for example, by using the hereinabove illustratively described integrated cyanide removal system (FIG. 2), is significantly less time consuming than implementing a cyanide removal method based on similar electrolytic only treatment (i.e., without chemical treatment [via Steps (b)-(d) of the method of the present invention]).

Additional special technical features of some embodiments of the present invention relate to the manner by which the main steps, and sub-steps thereof, of the chemical treatment, are synchronously integrated with the main steps, and sub-steps thereof, of the electrolytic treatment.

Specifically, the electrolytic treatment of the cyanide-containing water is initiated, and performed by including recycling of electrolytically treated cyanide-containing water, for forming recycled electrolytically treated cyanide-containing water. When cyanide species concentration of the recycled electrolytically treated cyanide-containing water decreases to a first concentration value of about 10 percent of the initial concentration, the electrolytic treatment is stopped (terminated), for forming recycled electrolytically treated cyanide-containing water of the first concentration value contained inside the recycle tank of the recycle unit. Only following stopping (termination) of the electrolytic treatment is there commencement of the chemical treatment of the recycled electrolytically treated cyanide-containing water of the first concentration value inside the recycle tank, with in-situ real time freshly generated hypochlorite ion solution electrolytically produced by an in-situ hypochlorite ion solution generating electrolytic reactor assembly configured in-line with the recycle tank. Thereafter, when cyanide species concentration inside the recycle tank decreases to a second concentration value of less than 1 milligram per liter, the chemical treatment is stopped (terminated), for forming clean (electrolytically and chemically) treated water of the second concentration value contained inside the recycle tank. Thereafter, the clean (electrolytically and chemically) treated water of the second concentration value is output from the recycle tank to the output unit. The preceding sequence of main steps, and sub-steps thereof, is performed in a distinctly and inventively synchronous manner, for producing clean treated water wherein cyanide species concentration is less than 1 milligram per liter (mg/l) [1 part per million (ppm)].

Additional special technical features of some embodiments of the present invention relate to the manner of performing the main steps, and sub-steps thereof, of the chemical treatment.

Specifically, in accordance with Step (c), the recycled electrolytically treated cyanide-containing water of the first concentration value inside the recycle tank is chemically treated with in-situ real time freshly generated hypochlorite ion solution electrolytically produced by an in-situ hypochlorite ion solution generating electrolytic reactor assembly configured in-line with the recycle tank. Step (c), and sub-steps thereof, are performed in a distinctly and inventively synchronous manner, in relation to the electrolytic treatment of the cyanide-containing water. Thus, the integrated cyanide removal method of the present invention is based on spatial (physical) and temporal (synchronous) integration of an electrolytic treatment and a chemical treatment of the cyanide-containing water.

Additional special technical feature of some embodiments of the present invention are apparent throughout the following illustrative description, and in the Examples section thereafter.

It is to be understood that the present invention is not limited in its application to the details of the order or sequence, and number, of steps or procedures, and sub-steps or sub-procedures, of operation or implementation of some embodiments of the method, or to the details of type, composition, construction, arrangement, order, and number, of the system units, system sub-units, devices, assemblies, sub-assemblies, mechanisms, structures, components, elements, and configurations, and, peripheral equipment, utilities, accessories, chemical reagents, and materials, of the exemplary system, set forth in the following illustrative description and accompanying drawings, unless otherwise specifically stated herein. For example, the following illustrative description includes detail of an exemplary embodiment of an exemplary integrated electrolytic and chemical type of cyanide species removal system which can be used for implementing some embodiments of the method of the present invention, in order to illustrate implementation of some embodiments of the present invention. Other embodiments of an integrated electrolytic and chemical type of cyanide species removal system can be used for implementing some embodiments of the method of the present invention. Accordingly, the present invention can be practiced or implemented according to various other alternative embodiments and in various other alternative ways.

It is also to be understood that all technical and scientific words, terms, or/and phrases, used herein throughout the present disclosure have either the identical or similar meaning as commonly understood by one of ordinary skill in the art to which this invention belongs, unless otherwise specifically defined or stated herein. Phraseology, terminology, and, notation, employed herein throughout the present disclosure are for the purpose of description and should not be regarded as limiting. Moreover, all technical and scientific words, terms, or/and phrases, introduced, defined, described, or/and exemplified, in the above Field and Background sections, are equally or similarly applicable in the illustrative description of the specific embodiments, examples, and appended claims, of the present invention. Immediately following are selected definitions and exemplary usages of words, terms, or/and phrases, which are used throughout the illustrative description of the preferred embodiments, examples, and appended claims, of the present invention, and are especially relevant for understanding thereof.

The phrase ‘cyanide species’, as used herein, refers to free cyanide (typically, more simply referred to as cyanide, being the cyanide ion [CN⁻]), or/and compounds, radicals, or/and ions (such as metal complex radicals or/and ions), containing cyanide.

The phrase ‘cyanide-containing water’, as used herein, refers to a water (aqueous) solution containing any combination of any number of a wide variety of different forms of cyanide species, such as in the form of free cyanide [CN⁻], or/and in the form of a compound containing cyanide, or/and, in the form of a radical or ion containing cyanide (such as a metal cyanide complex radical or ion). Main categories of compounds containing cyanide are hydrogen cyanide or cyanic acid [HCN], simple salts of cyanide, simple metal cyanides, complex alkali-metallic cyanides, and complex ammonium-metallic cyanides.

Cyanide-containing water, being a water (aqueous) solution containing any combination of any number of a wide variety of different forms of cyanide species, is most commonly produced during an industrial process. There exists a wide variety of different types of industrial processes which involve the production of cyanide-containing water. Among the most well known and currently employed types of industrial processes which involve the production of cyanide-containing water are mining (for example, gold and silver mining), metal electroplating (for example, transition or noble metal electroplating), chemical, petrochemical, metallurgical (for example, manufacturing and finishing of metals), and paper milling, processes.

In cyanide-containing water the actual form or forms of a particular cyanide specie, associated or/and dissociated components thereof, and relative concentrations thereof, are determined by, and are direct functions of, the physicochemical properties, parameters, and characteristics, of the particular cyanide specie, and of the cyanide-containing water. Primary physicochemical properties, parameters, and characteristics, are the equilibrium constant of the particular cyanide specie, the temperature of the cyanide-containing water, the pH of the cyanide-containing water, and if applicable, the possible additional presence and physicochemical properties, parameters, and characteristics, of any number of different types and forms of non-cyanide chemical species (compounds, radicals, ions) in the cyanide-containing water. In turn, these primary physicochemical properties, parameters, and characteristics, are determined by, and are direct functions of, the physicochemical properties, parameters, characteristics, and operating conditions, of the particular industrial process which produces the cyanide-containing water.

The phrase ‘recycled electrolytically treated cyanide-containing water’, as used herein, refers to the batch amount of cyanide-containing water wherein the initial cyanide species concentration is less than about 500 milligrams per liter (mg/l) [500 parts per million (ppm)] that is provided by an external source; followed by being fed into and transported through the input unit; followed by being fed into, transported through, and electrolytically treated or processed by the electrolytic reactor unit; followed by being fed into, and transported through the recycle unit; and followed by being recycled (at least once, typically, a number of times or cycles) into, transported through, and electrolytically treated or processed by the electrolytic reactor unit. Accordingly, the batch amount of cyanide-containing water wherein initial cyanide species concentration is less than about 500 milligrams per liter, is electrolytically treated via synchronized operation of the input unit, the electrolytic reactor unit, the recycle unit, and, the power supply and process control unit, for forming the ‘recycled electrolytically treated cyanide-containing water’.

The phrase ‘clean treated water’, as used herein, refers to recycled electrolytically treated cyanide-containing water wherein cyanide species concentration has decreased (at the stoppage or termination of the electrolytic treatment of the batch amount of cyanide-containing water) to a first concentration value of about 10 percent of the initial cyanide species concentration and which is subsequently chemically treated (in the recycle tank of the recycle unit) with in-situ real time freshly generated hypochlorite ion solution (electrolytically produced by an in-situ hypochlorite ion solution generating electrolytic reactor assembly configured in-line with the recycle tank), and whose cyanide species concentration (in the recycle tank of the recycle unit) has decreased (at the stoppage or termination of the chemical treatment) to a second concentration value of less than 1 milligram per liter (mg/l) [1 part per million (ppm)]. The ‘clean treated water’ exits the recycle tank of the recycle unit, and, is fed into and transported through the output unit of the integrated electrolytic and chemical type of cyanide species removal system.

The phrase ‘operatively connected’, as used herein, equivalently refers to the corresponding synonymous phrases ‘operatively joined’, and ‘operatively attached’, where the operative connection, operative joint, or operative attachment, is according to a physical, or/and electrical, or/and electronic, or/and mechanical, or/and electro-mechanical, manner or nature, involving various types and kinds of hardware or/and software equipment and components. With respect to operatively connected components which are structured and function for holding, mixing, transferring, measuring a parameter of, electrolytically treating, or/and chemically treating, a fluid, such as cyanide-containing water or a reaction product gas or/and vapor, then, the phrase ‘operatively connected’, and corresponding synonyms thereof, as used herein, mean that the operatively connected components are in fluid communication with each other.

Each of the following terms written in singular grammatical form: ‘a’, ‘an’, and ‘the’, as used herein, may also refer to, and encompass, a plurality of the stated entity or object, unless otherwise specifically defined or stated herein, or, unless the context clearly dictates otherwise. For example, the phrases: ‘a unit’, ‘a device’, ‘an assembly’, ‘a mechanism’, ‘a component’, and ‘an element’, as used herein, may also refer to, and encompass, a plurality of units, a plurality of devices, a plurality of assemblies, a plurality of mechanisms, a plurality of components, and a plurality of elements, respectively.

Each of the following terms: ‘includes’, ‘including’, ‘has’, ‘having’, ‘comprises’, and ‘comprising’, and, their linguistic/grammatical variants, derivatives, or/and conjugates, as used herein, means ‘including, but not limited to’.

Each of the phrases ‘consisting of’ and ‘consists of’, as used herein, means ‘including and limited to’.

The term ‘about’ refers to ±10% of the stated numerical value.

The phrase ‘room temperature’ refers to a temperature in a range of between about 20° C. and about 25° C.

Herein, distance is expressed in units of millimeters (mm), and centimeters (cm).

Herein, area is expressed in units of square centimeters (cm²), and square meters (m²).

The phrase ‘milligram(s) per liter’, as used herein, refers to concentration of an indicated species (typically, cyanide species) expressed in terms of mass (weight) (i.e., milligrams) of the indicated species, per unit volume (i.e., liter) of water (e.g., in the form of cyanide-containing water, electrolytically treated cyanide-containing water, or clean treated water), and is herein abbreviated as ‘mg/l’. The phrase ‘part(s) per million’, as used herein, refers to concentration of an indicated species (typically, cyanide species) expressed in terms of part(s) of the indicated species per one million parts of water (e.g., in the form of cyanide-containing water, electrolytically treated cyanide-containing water, or clean treated water), and is herein abbreviated as ‘ppm’. With respect to concentration of an indicated species (typically, cyanide species), the phrases ‘milligram(s) per liter’ and ‘part(s) per million’, as used herein, are synonymous and equivalent.

The phrase ‘liters per hour’, as used herein, refers to volumetric flow rate of water (e.g., in the form of cyanide-containing water, electrolytically treated cyanide-containing water, or clean treated water) expressed in terms of (liquid) volume (i.e., liters) of the water per unit time (i.e., hour), and is herein abbreviated as ‘l/hr’. The phrase ‘cubic meters per hour’, as used herein, refers to volumetric flow rate of water (e.g., in the form of cyanide-containing water, electrolytically treated cyanide-containing water, or clean treated water) expressed in terms of (spatial) volume (i.e., cubic meters) per unit time (i.e., hour), and is herein abbreviated as ‘m³/hr’. With respect to volumetric flow rate of the different forms of water, since 1000 liters per hour (l/hr)=1 cubic meter per hour (m³/hr), therefore, the phrases ‘1000 liters per hour’ and ‘1 cubic meter per hour’, as used herein, are synonymous and equivalent.

Throughout the illustrative description of some embodiments, the examples, and the appended claims, of the present invention, a numerical value of a parameter, feature, object, or dimension, may be stated or described in terms of a numerical range format. It is to be fully understood that the stated numerical range format is provided for illustrating implementation of some embodiments of the present invention, and is not to be understood or construed as inflexibly limiting the scope of embodiments of the present invention.

Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably. For example, for stating or describing the numerical range of room temperature, the phrase ‘room temperature refers to a temperature in a range of between about 20° C. and about 25° C.’, is considered equivalent to, and meaning the same as, the phrase ‘room temperature refers to a temperature in a range of from about 20° C. to about 25° C.’.

Steps or procedures, sub-steps or sub-procedures, and, equipment and materials, system units, system sub-units, devices, assemblies, sub-assemblies, mechanisms, structures, components, elements, and configurations, and, peripheral equipment, utilities, accessories, chemical reagents, and materials, as well as operation and implementation, of exemplary embodiments, alternative embodiments, specific configurations, and, additional and optional aspects, characteristics, or features, thereof, of the integrated electrolytic and chemical method for producing clean treated water wherein cyanide species concentration is less than 1 milligram per liter, according to the present invention, are better understood with reference to the following illustrative description and accompanying drawings. Throughout the following illustrative description and accompanying drawings, same reference notation and terminology (i.e., numbers, letters, or/and symbols), refer to same system units, system sub-units, devices, assemblies, sub-assemblies, mechanisms, structures, components, elements, and configurations, and, peripheral equipment, utilities, chemical reagents, accessories, and materials, components, elements, or/and parameters.

According to the main aspect of some embodiments of the present invention, there is provision of an integrated electrolytic and chemical method for producing clean treated water wherein cyanide species concentration is less than 1 milligram per liter.

Referring now to the drawings, FIG. 1 is a (block-type) flow diagram of an exemplary embodiment of the main steps (procedures) of the integrated electrolytic and chemical method (herein, for brevity, also referred to as ‘the integrated cyanide species removal method’) for electrolytically and chemically removing cyanide species from cyanide-containing water, for producing clean treated water wherein cyanide species concentration is less than 1 milligram per liter (mg/l) [1 part per million (ppm)], of the present invention. In FIG. 1, each main step (procedure) of the exemplary embodiment of the integrated cyanide species removal method is enclosed inside a separate block (frame) which is assigned a reference number. Accordingly, main steps (a), (b), (c), (d), and (e), are enclosed inside of blocks (frames) 2, 4, 6, 8, and 9, respectively. FIG. 2 is a schematic diagram illustrating an exemplary embodiment of an exemplary integrated electrolytic and chemical type of cyanide species removal system 10 (herein, for brevity, also referred to as ‘the integrated cyanide species removal system’ 10) which can be used for implementing some embodiments of the integrated cyanide species removal method of the present invention illustrated in FIG. 1. Phraseology, terminology, and, notation, appearing in the following illustrative description of the present invention are consistent with those appearing in the flow diagram of the exemplary embodiment of the method illustrated in FIG. 1, and with those appearing in the integrated cyanide species removal system illustrated in FIG. 2.

The integrated electrolytic and chemical method for electrolytically and chemically removing cyanide species from cyanide-containing water, for producing clean treated water wherein cyanide species concentration is less than 1 milligram per liter (mg/l) [1 part per million (ppm)], of the present invention, is implemented by appropriately designing, configuring, constructing, and operating, an integrated cyanide species removal system, such as integrated cyanide species removal system 10 shown in FIG. 2, for performing main Steps (a), (b), (c), (d), and (e), shown in blocks (frames) 2, 4, 6, 8, and 9, respectively, in FIG. 1, and various sub-steps thereof. For performing main steps (a), (b), (c), (d), and (e), of some embodiments of the integrated cyanide species removal method, integrated cyanide species removal system 10 includes the main components of: an input unit 14, an electrolytic reactor unit 16, a recycle unit 22, an output unit 20, and, a power supply and process control unit 18. Relevant structure and function (operation) of each main component (and components thereof), and synchronized operation of the combination of the main components (and components thereof), of integrated cyanide species removal system 10 are illustratively described hereinbelow in the context of illustratively describing the main steps of some embodiments of the integrated cyanide species removal method of the present invention.

Electrolytically Treating a Batch Amount of Cyanide-Containing Water Wherein Initial Cyanide Species Concentration is Less than about 500 Milligrams Per Liter

In Step (a) (block 2, FIG. 1) of some embodiments of the integrated electrolytic and chemical method for producing clean treated water wherein cyanide species concentration is less than 1 milligram per liter (mg/l) [1 part per million (ppm)], of the present invention, there is electrolytically treating a batch amount of cyanide-containing water (hereinafter, referred to as cyanide-containing water 12, as shown in FIG. 2) wherein initial cyanide species concentration is less than about 500 milligrams per liter, via synchronized operation of an input unit, an electrolytic reactor unit, a recycle unit, an output unit, and, a power supply and process control unit, (for example, input unit 14, electrolytic reactor unit 16, recycle unit 22, output unit 20, and, power supply and process control unit 18, respectively, of integrated cyanide species removal system 10 shown in FIG. 2), for forming recycled electrolytically treated cyanide-containing water (for example, recycled electrolytically treated cyanide-containing water 210, FIG. 2).

### Supplying, Receiving, Holding, and Transferring, the Cyanide-Containing Water

Cyanide-containing water 12 is supplied by an external source 24, and is fed into input unit 14 of integrated cyanide species removal system 10, for example, via a valve 13 (in an open position) located between the outlet of external source 24 and input of input unit 14. External source 24, in general, is essentially any type of source or supply of water which contains cyanide species, such as that defined and referred to herein as cyanide-containing water 12. External source 24, typically, is a source or supply of cyanide-containing water 12 which is most commonly produced during an industrial process. Without limiting implementation of the present invention, among the most well known and currently employed types of industrial processes which involve the production of cyanide-containing water 12 are mining (for example, gold and silver mining), metal electroplating (for example, transition or noble metal electroplating), chemical, petrochemical, metallurgical (for example, manufacturing and finishing of metals), and paper milling, processes. Some embodiments of the integrated cyanide species removal method of the present invention can be implemented, for example, by utilizing integrated cyanide species removal system 10, for electrolytically and chemically removing cyanide species from cyanide-containing water 12 produced by any of the just stated types of industrial processes.

Cyanide-containing water 12 generally refers to a water (aqueous) solution containing any combination of any number of a wide variety of different forms of cyanide species, such as in the form of free cyanide [CN⁻], or/and in the form of a compound containing cyanide, or/and, in the form of a radical or ion containing cyanide (such as a metal cyanide complex radical or ion). Main categories of compounds containing cyanide, which may be present in cyanide-containing water 12, are hydrogen cyanide or cyanic acid [HCN], simple salts of cyanide, simple metal cyanides, complex alkali-metallic cyanides, and complex ammonium-metallic cyanides.

Exemplary simple salts of cyanide, which may be present in cyanide-containing water 12, are sodium cyanide [NaCN], potassium cyanide [KCN], calcium cyanide [Ca(CN)₂], and ammonium cyanide [NH₄CN]. Exemplary simple metal cyanides, which may be present in cyanide-containing water 12, are transition metal cyanides, such as nickel cyanide [Ni(CN)₂], copper cyanide [CuCN], zinc cyanide [Zn(CN)₂], silver cyanide [AgCN], cadmium cyanide [CdCN], gold cyanide [AuCN], and mercury cyanide [Hg(CN)₂]. Exemplary complex alkali-metallic cyanides and complex ammonium-metallic cyanides, which may be present in cyanide-containing water 12, are generally represented by the formula [A_{y}M(CN)ₓ], where A is an alkali (for example, sodium, potassium) or ammonium specie, y is the number of alkali or ammonium species, M is a metal specie, such as of a transition metal (for example, iron, nickel, copper, zinc, silver, cadmium, tin, gold, mercury) or alloy of two or more transition metals (for example, copper and zinc), and x is the number of cyanide [CN] groups. The value of x is equal to the valence of A taken y times, plus the valence of the metal specie.

In cyanide-containing water 12 supplied by external source 24 the actual form or forms of a particular cyanide specie, associated or/and dissociated components thereof, and relative concentrations thereof, are determined by, and are direct functions of, the physicochemical properties, parameters, and characteristics, of the particular cyanide specie, and of cyanide-containing water 12. Primary physicochemical properties, parameters, and characteristics, are the equilibrium constant of the particular cyanide specie, the temperature of cyanide-containing water 12, the pH of cyanide-containing water 12, and if applicable, the possible additional presence and physicochemical properties, parameters, and characteristics, of any number of different types and forms of non-cyanide chemical species (compounds, radicals, ions) in cyanide-containing water 12. In turn, these primary physicochemical properties, parameters, and characteristics, are determined by, and are direct functions of, the physicochemical properties, parameters, characteristics, and operating conditions, of the particular industrial process which produces cyanide-containing water 12.

Cyanide-containing water 12 which is supplied from external source 24 and fed into input unit 14, and which contains any combination of any number of a wide variety of different forms of cyanide species, has an initial cyanide species concentration of less than about 500 milligrams per liter (mg/l) [500 parts per million (ppm)].

For cyanide-containing water 12 containing cyanide species originating from a metal, for example, simple metal salts of cyanide, simple metal cyanides, complex alkali-metallic cyanides, or/and complex ammonium-metallic cyanides, the concentration of the metal, in the form of a metal ion is, preferably, in a range of between about 100 milligrams per liter (mg/l) [100 parts per million (ppm)] and about 0.05 milligram per liter (mg/l) [0.05 part per million (ppm)], more preferably, in a range of between about 70 milligrams per liter (mg/l) [70 parts per million (ppm)] and about 10 milligrams per liter (mg/l) [10 parts per million (ppm)], and most preferably, in a range of between about 40 milligrams per liter (mg/l) [40 parts per million (ppm)] and about 20 milligrams per liter (mg/l) [20 parts per million (ppm)]. A typical concentration of a metal, in the form of a metal ion, in cyanide-containing water 12 supplied by external source 24 of, for example, any of the above indicated industrial processes, is of the order of about 40 milligrams per liter (mg/l) [40 parts per million (ppm)], which is one of the concentrations of a metal in samples of cyanide-containing water 12 tested while reducing the method of the present invention to practice.

Cyanide-containing water 12 has a pH, preferably, in a range of between about 8.5 and about 12.5, and more preferably, in a range of between about 10.5 and about 11. Preferably, cyanide-containing water 12 has an alkaline pH value, in particular, equal to or above about 8.5, at which pH value there is no or minimal amount of hydrogen cyanide or cyanic acid [HCN], in order to preserve whatever cyanide species are in cyanide-containing water 12 in a salt form, as is the case for metal cyanides. In the event cyanide-containing water 12 has a pH lower than about 8.5, then, preferably, there is inclusion of a pH adjustment step for increasing the pH of cyanide-containing water 12. Such a pH adjustment step involves, for example, adding a base (caustic) to cyanide-containing water 12 at a stage prior to input unit 14 receiving cyanide-containing water 12 from external source 24, or/and, at a stage prior to feeding cyanide-containing water 12 to a water holding and mixing vessel 110, or/and, at a stage prior to feeding electrolytic reactor unit feed solution 15 to the electrolytic reactor unit 16.

Cyanide-containing water 12 has a temperature, preferably, in a range of between about 5° C. and about 80° C., more preferably, in a range of between about 15° C. and about 40° C., and most preferably, in a range of between about 20° C. and about 30° C.

In integrated cyanide species removal system 10, input unit 14 includes the main components of: (i) an input unit water holding vessel 26, (ii) an automatic water (volumetric or mass) input level monitoring (measuring) and controlling mechanism 32, (iii) a water holding and mixing vessel 110, (iv) valves 33 and 114, (v) a water pump 112, and (vi) a water flow rate measuring mechanism 116. Input unit 14, optionally, and preferably, also includes a water filter assembly 34. Each main component of input unit 14 is configured for being operatively connected to power supply and process control unit 18, via input unit electronic input/output control signal communications line 39.

Input unit water holding vessel 26 is configured and functions for holding or containing a (volumetric or mass) batch amount of cyanide-containing water 12 which is supplied from external source 24 and fed into input unit 14. Input unit water holding vessel 26 includes an inlet assembly 28 for receiving (preferably, filtered) cyanide-containing water 12 supplied from external source 24, and an outlet assembly 30 through which (preferably, filtered) cyanide-containing water 12 exits input unit water holding vessel 26, and enters water holding and mixing vessel 110.

Just before cyanide-containing water 12 is supplied by external source 24 and fed, via a valve 13, into input unit 14 of integrated cyanide species removal system 10, central programming and electronic input/output control signal processing assembly 74 of power supply and process control unit 18, via input unit electronic input/output control signal communications line 39, sends a {valve-open} process control signal to valve 33 of input unit 14 for actuating and opening valve 33, thereby enabling (preferably, filtered) cyanide-containing water 12 to exit input unit water holding vessel 26 and flow into water holding and mixing vessel 110.

Step (a), optionally, and preferably, includes filtering cyanide-containing water 12 supplied from external source 24 before being fed, via valve 13, into input unit water holding vessel 26 of input unit 14, for forming filtered cyanide-containing water 12′. Filtering cyanide-containing water 12 before being fed into input unit water holding vessel 26 and into water holding and mixing vessel 110, and therefore, before being fed into electrolytic reactor unit 16, removes undesirably large sized particulates which otherwise may interfere with proper operation of electrolytic reactor unit 16, especially therein, regarding the various electrochemical reactions taking place on or/and immediately near the electrode surfaces. Filtering of cyanide-containing water 12 is performed by water filter assembly 34. Water filter assembly 34 includes an inlet assembly 36 for receiving cyanide-containing water 12 supplied from external source 24, via valve 13, and an outlet assembly 38 through which filtered cyanide-containing water 12′ exits water filter assembly 34 and enters input unit water holding vessel 26, via inlet assembly 28.

Cyanide-containing water 12 (filtered cyanide-containing water 12′) exits input unit water holding vessel 26, via outlet assembly 30, passes through valve 33, and enters water holding and mixing vessel 110. Water holding and mixing vessel 110 includes: (i) a first inlet assembly 118 for receiving cyanide-containing water 12 (filtered cyanide-containing water 12′) exiting from input unit water holding vessel 26, via outlet assembly 30; (ii) a second inlet assembly 120 for receiving a second portion (overflow) 17b of electrolytically treated cyanide-containing water 17 exiting from electrolytic reactor unit 16, via a reactor housing second outlet assembly 48; and (iii) an outlet assembly 122 through which electrolytic reactor unit feed solution 15 exits from water holding and mixing vessel 110, and eventually exits from input unit 14.

A first configuration and function of water holding and mixing vessel 110 is for holding or containing, and mixing, cyanide-containing water 12 (filtered cyanide-containing water 12′) which eventually exits from input unit 14, in the form of electrolytic reactor unit feed solution 15. A second configuration and function of water holding and mixing vessel 110 is for receiving second portion 17b of electrolytically treated cyanide-containing water 17 which may exit, as an overflow, from electrolytic reactor unit 16. In such a case, electrolytic reactor unit feed solution 15 includes cyanide-containing water 12 (filtered cyanide-containing water 12′) and second portion (overflow) 17b of electrolytically treated cyanide-containing water 17. A third configuration and function of water holding and mixing vessel 110 is for receiving electrolytically treated cyanide-containing water 210 (of recycle unit 22) which originates from first portion 17a of electrolytically treated cyanide-containing water 17 that exits from electrolytic reactor unit 16. In such a case, electrolytic reactor unit feed solution 15 includes cyanide-containing water 12 (filtered cyanide-containing water 12′) and possible second portion (overflow) 17b of electrolytically treated cyanide-containing water 17 and electrolytically treated cyanide-containing water 210 (of recycle unit 22).

Cyanide-containing water 12 (filtered cyanide-containing water 12′) enters water holding vessel 26 until the instantaneous level thereof inside water holding vessel 26 increases to (i.e., equals) a pre-determined minimum level sufficient for operation of water pump 112. The instantaneous level, and therefore, the instantaneous (volumetric or mass) amount, of cyanide-containing water 12 (filtered cyanide-containing water 12′) inside of water holding vessel 26 is monitored (measured) and controlled by operation of automatic water (volumetric or mass) level monitoring (measuring) and controlling mechanism 32 which is configured for being operatively connected to power supply and process control unit 18, via input unit electronic input/output control signal communications line 39. Automatic water output level monitoring (measuring) and controlling mechanism 32 is preferably located inside of water holding vessel 26, as shown in FIG. 2.

When the instantaneous level of cyanide-containing water 12 (filtered cyanide-containing water 12′) inside water holding vessel 26 increases to (i.e., equals) the pre-determined minimum level sufficient for operation of water pump 112, central programming and electronic input/output control signal processing assembly 74 of power supply and process control unit 18, via input unit electronic input/output control signal communications line 39, sends a {valve-open} process control signal to valve 114 for actuating and opening valve 114, and simultaneously sends a {pump-on} process control signal to water pump 112 for actuating and turning-on water pump 112, thereby initiating and directing electrolytic reactor unit feed solution 15 to flow from water holding and mixing vessel 110, via outlet assembly 122, through water pump 112, through valve 114, then through water flow rate measuring mechanism 116, and into a reactor housing bottom section 42b of a reactor housing assembly 42 of electrolytic reactor unit 16, via a reactor housing inlet assembly 44.

Electrolytic reactor unit feed solution 15, pumped by water pump 112 from water holding and mixing vessel 110 and into electrolytic reactor unit 16, has a volumetric flow rate, preferably, in a range of between about 0.5 liter per hour (l/hr) [0.0005 cubic meter per hour (m³/hr)] and about 20,000 liters per hour (l/hr) [20 cubic meter per hour (m³/hr)], more preferably, in a range of between about 10 liters per hour (l/hr) [0.01 cubic meter per hour (m³/hr)] and about 10,000 liters per hour (l/hr) [10 cubic meters per hour (m³/hr)], most preferably, in a range of between about 100 liters per hour (l/hr) [0.1 cubic meter per hour (m³/hr)] and about 2000 liters per hour (l/hr) [2 cubic meters per hour (m³/hr)], with a most preferred flow rate of about 1000 liters per hour (l/hr) [1 cubic meter per hour (m³/hr)].

The (volumetric or mass) flow rate of electrolytic reactor unit feed solution 15 exiting from water holding and mixing vessel 110 and entering electrolytic reactor unit 16 is controlled by valve 114, and is measured by water flow rate measuring mechanism 116, for example, a flow meter configured and operable for measuring flow rates of a liquid, particularly, water, such as water containing cyanide species. Valve 114 and water flow rate measuring mechanism 116 are each configured for being operatively connected to power supply and process control unit 18, via input unit electronic input/output control signal communications line 39.

### Electrolytically Treating the Cyanide-Containing Water

In a synchronous manner, at about the same time of, or shortly after, initiating and directing electrolytic reactor unit feed solution 15 to flow from water holding and mixing vessel 110 and into reactor housing bottom section 42b of reactor housing assembly 42 of electrolytic reactor unit 16, central programming and electronic input/output control signal processing assembly 74 sends a {power-on} process control signal to power supply monitoring (measuring) and controlling mechanism 70, for actuating (and turning-on) and controlling power supply assembly 72 in a manner such that power supply assembly 72 starts supplying power to the electrodes of an electrode set 40 of electrolytic reactor unit 16. Therein, various electrolytic (electrochemical) reactions are initiated for electrolytically (electrochemically) reducing the concentration of cyanide species in cyanide-containing water 12 (filtered cyanide-containing water 12′).

Electrolytic reactor unit feed solution 15 flows into an inlet feed tube 50 via an inlet assembly 52, then flows out of inlet feed tube 50 via perforations or holes 54 (as indicated in FIG. 2 by the small wavy arrows vertically emerging from perforations or holes 54) and into reactor housing bottom section 42b of reactor housing assembly 42 of electrolytic reactor unit 16, and subsequently upwardly flows into the immediate vicinity of electrode set 40 and the electrodes therein, wherein various electrolytic (electrochemical) reactions take place for electrolytically (electrochemically) reducing the concentration of cyanide species in cyanide-containing water 12.

Electrolytic reactor unit 16 is configured for being operatively connected to input unit 14, recycle unit 22, output unit 20, and, power supply and process control unit 18. Electrolytic reactor unit 16 functions for electrolytically treating a batch amount of cyanide-containing water 12 wherein initial cyanide species concentration is less than about 500 milligrams per liter, via synchronized operation with input unit 14, recycle unit 22, output unit 20, and, power supply and process control unit 18, for forming electrolytically treated cyanide-containing water 17 [first portion 17a and possible second portion (overflow) 17b]. Electrolytic reactor unit 16 includes the main components of: (i) a set 40 of electrodes, herein, also referred to as an electrode set 40, and (ii) a reactor housing assembly 42. Each main component of electrolytic reactor unit 16 is configured for being operatively connected to power supply and process control unit 18, via electrolytic reactor unit electronic input/output control signal communications line 60.

As shown in FIG. 2, in electrolytic reactor unit 16, set 40 of electrodes, or electrode set 40, includes at least one metal cathode, for example, two metal cathodes, metal cathodes c1 and c2, and at least two graphite or metal anodes, for example, three graphite or metal anodes, graphite or metal anodes a1, a2, and a3, which are configured relative to each other in an alternating manner such that each metal cathode is positioned in between two immediately neighboring graphite or metal anodes. For example, as shown in FIG. 2, metal cathode c1 is positioned in between the two immediately neighboring graphite or metal anodes a1 and a2, and metal cathode c2 is positioned in between the two immediately neighboring graphite or metal anodes a2 and a3.

In general, electrode set 40 of electrolytic reactor unit 16, preferably, includes a number, N (for example, 1, 2, 3, 4), of at least one metal cathode, and a corresponding number, N+1 (for example, 2, 3, 4, 5, respectively), of at least two graphite or metal anodes, which are configured relative to each other in an alternating manner such that each metal cathode is positioned in between two immediately neighboring graphite or metal anodes. A particular case of this is shown in FIG. 2, wherein electrolytic reactor unit 16 includes electrode set 40 of two (N=2) metal cathodes c1 and c2, and three (N+1=3) graphite or metal anodes a1, a2, and a3, and where the electrodes are configured relative to each other in the above described alternating manner. In FIG. 2, for a metal cathode (cj), j equals an integer, for example, j=1 or 2, corresponding to a metal cathode c1 or c2, respectively. For an immediately neighboring graphite or metal anode (ai), i equals an integer, for example, i=1, 2, or 3, corresponding to an immediately neighboring graphite or metal anode a1, or a2, or a3, respectively, of electrode set 40.

In electrode set 40 of electrolytic reactor unit 16, each electrode generally has a top end portion and a bottom end portion. The top end portion of each metal cathode (cj) and of each graphite or metal anode (ai) are each electrically connected, for example, via respective negative (−) and positive (+) electrical leads 62 (for example, as shown in FIG. 2) to power supply assembly 72 of power supply and process control unit 18. During operation of electrode set 40 of electrolytic reactor unit 16, and while the various electrolytic (electrochemical) reactions take place for electrolytically (electrochemically) reducing the concentration of cyanide species in cyanide-containing water 12, the top end portion of each metal cathode (cj) and of each graphite or metal anode (ai) are each ordinarily unexposed to electrolytic reactor unit feed solution 15, while the bottom end portion of each metal cathode (cj) and of each graphite or metal anode (ai), are each ordinarily exposed to, and surrounded by, electrolytic reactor unit feed solution 15, as shown in FIG. 2.

As shown in FIG. 2, in electrode set 40 of electrolytic reactor unit 16, the top end portion of each of the at least one metal cathode, for example, metal cathodes c1 and c2, and the top end portion of each of the at least two graphite or metal anodes, for example, graphite or metal anodes a1, a2, and a3, are each generally characterized by a ‘rectangular’ geometrical shape or form. In an exemplary alternative embodiment of electrolytic reactor unit 16, the top end portion of each of the at least one metal cathode (cj), for example, metal cathodes c1 and c2, and the top end portion of each of the at least two graphite or metal anodes (ai), for example, graphite or metal anodes a1, a2, and a3, are each particularly characterized by a ‘trapezoidal-like’ geometrical shape or form. In general, the bottom end portion of each of the at least one metal cathode (cj), for example, metal cathodes c1 and c2, and the bottom end portion of each of the at least two graphite or metal anodes (ai), for example, graphite or metal anodes a1, a2, and a3, are each generally characterized by a rectangular geometrical shape or form.

For each (cathode or anode) electrode, each face and each side extending therefrom, preferably, has a flat and smooth surface. The geometrical dimensions of a (cathode or anode) electrode are defined by the geometrical dimensions of either of the two faces, and of a side extending between the two faces. More specifically, a (cathode or anode) electrode has a face whose length (L) and width (W) correspond to the length and width of either face, respectively, and has a thickness (T) corresponding to the thickness of a side extending between the two faces. Accordingly, a (cathode or anode) electrode has a face whose surface area [SA] is directly proportional to the product of the length (L) and the width (W) of that face, where the proportionality (that is, 1 or <1) is according to the actual geometrical shape or form (that is, rectangular or trapezoidal-like, respectively) of the top end portion of that face.

A metal cathode (cj), for example, metal cathode c1 or c2, has a face (f-cj), for example, face f-c1 or f-c2, respectively, whose length (L-cj) corresponds to the (vertical) distance spanning between the edge of the top end portion and the edge of the bottom end portion of the metal cathode (cj), and whose width (W-cj) corresponds to the (horizontal) distance spanning between the edge of one side to the edge of the opposite side of the face (f-cj) of the metal cathode (cj); and has a thickness (T-cj) corresponding to the (horizontal) distance spanning between one side to the opposite side of the face (f-cj) of the metal cathode (cj). Accordingly, the metal cathode (cj) has a face (f-cj) whose surface area [SA(f-cj)] is directly proportional to the product of the length (L-cj) and the width (W-cj) of that face, where the proportionality (that is, 1 or <1) is according to the actual geometrical shape or form (that is, rectangular or trapezoidal-like, respectively) of the top end portion of that face.

A graphite or metal anode (ai), for example, graphite or metal anode a1, a2, or a3, has a face (f-ai), for example, face f-a1, or f-a2, or f-a3, respectively, whose length (L-ai) corresponds to the (vertical) distance spanning between the edge of the top end portion and the edge of the bottom end portion of the graphite or metal anode (ai), and whose width (W-ai) corresponds to the (horizontal) distance spanning between the edge of one side to the edge of the opposite side of the face (f-ai) of the graphite or metal anode (ai); and has a thickness (T-ai) corresponding to the (horizontal) distance spanning between one side to the opposite side of the face (f-ai) of the graphite or metal anode (ai). Accordingly, the graphite or metal anode (ai) has a face (f-ai) whose surface area [SA(f-ai)] is directly proportional to the product of the length (L-ai) and the width (W-ai) of that face, where the proportionality (that is, 1 or <1) is according to the actual geometrical shape or form (that is, rectangular or trapezoidal-like, respectively) of the top end portion of that face.

In general, each (cathode or anode) electrode has geometrical dimensions of length (L), width (W), thickness (T), and surface area [SA], which are of magnitudes different from, or equal to, the magnitudes of the corresponding geometrical dimensions of any other electrode, cathode or anode, in electrode set 40 of electrolytic reactor unit 16. Preferably, each metal cathode (cj), for example, metal cathode c1 or c2, has geometrical dimensions which are of the same magnitudes as the magnitudes of the corresponding geometrical dimensions of each of the other at least one metal cathode (cj). Preferably, each graphite or metal anode (ai), for example, graphite or metal anode a1, or a2, or a3, has geometrical dimensions which are of the same magnitudes as the magnitudes of the corresponding geometrical dimensions of each of the other at least two graphite or metal anodes (ai).

In an exemplary specific preferred embodiment of electrode set 40 of electrolytic reactor unit 16, each metal cathode (cj) has a width (W-cj) of a same magnitude, which is equal to the magnitude of the width (W-ai) of each graphite or metal anode (ai), and, each metal cathode (cj) has a length (L-cj) of a magnitude which is larger, preferably, by about 10%, than the magnitude of the length (L-ai) of each graphite or metal anode (ai). Accordingly, in such an embodiment, each metal cathode (cj) has a face (f-cj) whose surface area [SA(f-cj)] is of a magnitude which is larger, preferably, by about 10%, than the magnitude of the surface area [SA(f-ai)] of each graphite or metal anode (ai).

Regarding the surface area of the electrodes, as previously described hereinabove, the top end portion of each metal cathode (cj) and of each graphite or metal anode (ai) are each electrically connected, for example, via respective negative (−) and positive (+) electrical leads 62, to power supply assembly 72 of power supply and process control unit 18, and during operation, are each ordinarily unexposed to electrolytic reactor unit feed solution 15, while the bottom end portion of each metal cathode (cj) and of each graphite or metal anode (ai), are each ordinarily exposed to, and surrounded by, electrolytic reactor unit feed solution 15, as shown in FIG. 2. During operation of such an exemplary embodiment of electrode set 40 of electrolytic reactor unit 16, preferably, the bottom end portion of each metal cathode (cj) and of each graphite or metal anode (ai), each have about the same amount of surface area (preferably, being more than half of the total surface area [SA(f-cj)] or [SA(f-ai)] of each metal cathode (cj) or graphite or metal anode (ai), respectively) which is exposed to, and surrounded by, electrolytic reactor unit feed solution 15.

Exemplary specific preferred ranges of magnitudes of the geometrical dimensions of length (L), width (W), thickness (T), and surface area [SA], of the cathodes (cj) and anodes (ai) in electrode set 40 of electrolytic reactor unit 16, are as follows.

A metal cathode (cj), for example, metal cathode c1 or c2, has a face (f-cj), for example, face f-c1 or f-c2, respectively, whose length (L-cj) is of a magnitude, preferably, in a range of between about 100 mm (10 cm) and about 1000 mm (100 cm), more preferably, in a range of between about 300 mm (30 cm) and about 700 mm (70 cm), and most preferably, in a range of between about 400 mm (40 cm) and about 800 mm (80 cm), with a most preferred magnitude of about 700 mm (70 cm); and whose width (W-cj) is of a magnitude, preferably, in a range of between about 50 mm (5 cm) and about 1000 mm (100 cm), more preferably, in a range of between about 100 mm (10 cm) and about 500 mm (50 cm), and most preferably, in a range of between about 200 mm (20 cm) and about 300 mm (30 cm), with a most preferred magnitude of about 250 mm (25 cm); and has a thickness (T-cj) of a magnitude, preferably, in a range of between about 1 mm and about 40 mm, and more preferably, in a range of between about 2 mm and about 10 mm. Accordingly, a metal cathode (cj) has a face (f-cj) whose surface area [SA(f-cj)] is of a most preferred magnitude of about 1750 cm² (0.1750 m²).

A graphite or metal anode (ai), for example, graphite or metal anode a1, or a2, or a3, has a face (f-ai), for example, face f-a1, or f-a2, or f-a3, respectively, whose length (L-ai) is of a magnitude, preferably, in a range of between about 100 mm (10 cm) and about 1000 mm (100 cm), more preferably, in a range of between about 300 mm (30 cm) and about 900 mm (90 cm), and most preferably, in a range of between about 400 mm (40 cm) and about 800 mm (80 cm), with a most preferred magnitude of about 700 mm (70 cm); and whose width (W-ai) is of a magnitude, preferably, in a range of between about 50 mm (5 cm) and about 1000 mm (100 cm), more preferably, in a range of between about 100 mm (10 cm) and about 500 mm (50 cm), and most preferably, in a range of between about 200 mm (20 cm) and about 300 mm (30 cm), with a most preferred magnitude of about 250 mm (25 cm); and has a thickness (T-ai) of a magnitude, preferably, in a range of between about 1 mm and about 40 mm, and more preferably, in a range of between about 2 mm and about 15 mm. Accordingly, a graphite or metal anode (ai) has a face (f-ai) whose surface area [SA(f-ai)] is of a most preferred magnitude of about 1750 cm² (0.1750 m²).

In general, each metal cathode (cj) and each immediately neighboring graphite or metal anode (ai) are separated by an inter-electrode separation distance, d, corresponding to the distance extending from the face (f-cj) of metal cathode (cj) to the face (f-ai) of graphite or metal anode (ai). For example, as shown in FIG. 2, in electrode set 40 of electrolytic reactor unit 16, metal cathode c1 and immediately neighboring graphite or metal anode a1 are separated by the inter-electrode separation distance, d. In general, in electrode set 40 of electrolytic reactor unit 16, a first pair of a metal cathode (cj) and an immediately neighboring graphite or metal anode (ai) has an inter-electrode separation distance, d, of magnitude which is different from, or the same as, the magnitude of an inter-electrode separation distance, d, of a second pair of a metal cathode (cj) and an immediately neighboring graphite or metal anode (ai). Preferably, the magnitude of the inter-electrode separation distance, d, is the same for each pair of a metal cathode (cj) and an immediately neighboring graphite or metal anode (ai). For implementation of the present invention, the magnitude of the inter-electrode separation distance, d, of each pair of a metal cathode (cj) and an immediately neighboring graphite or metal anode (ai), is, preferably, in a range of between about 5 mm (0.5 cm) and about 50 mm (5.0 cm).

As generally shown in FIG. 2, in electrode set 40 of electrolytic reactor unit 16, the top end portion of each steel cathode (cj), for example, metal cathodes c1 and c2, and the top end portion of each graphite or metal anode (ai), for example, graphite or metal anodes a1, a2, and a3, are each electrically connected, for example, via respective negative (−) and positive (+) electrical leads 62, to power supply and process control unit 18. In an alternative embodiment of electrolytic reactor unit 16, wherein the top end portion of each metal cathode (cj) and of each graphite or metal anode (ai) are each particularly characterized by a trapezoidal-like geometrical shape or form, the trapezoidal-like top end portion of each metal cathode (cj) and of each graphite or metal anode (ai), includes a set of a number of, for example, five, holes, for enabling electro-mechanical connection of respective negative (−) and positive (+) electrical leads 62 to each metal cathode (cj) and each graphite or metal anode (ai).

An important characteristic or property of the metal cathodes (cj) in electrode set 40 of electrolytic reactor unit 16, is that the metal(s) comprising at least the entire external surface area of the faces and sides of the metal cathodes (cj) be non-oxidizable, or at most, minimally oxidizable (e.g., via oxygen, chlorine, or some other oxidizing agent, present in electrolytic reactor unit feed solution 15 or/and in electrolytically treated cyanide-containing water 17) during exposure to electrolytic reactor unit feed solution 15 or/and electrolytically treated cyanide-containing water 17 in electrolytic reactor unit 16. Accordingly, the metal cathodes (cj) are preferably composed of one or more (pure, alloyed, or/and plated) metals which have this characteristic or property. Exemplary pure and alloyed metals which have this characteristic or property, and which the metal cathodes (cj) may be composed of, are selected from the group consisting of stainless steel, platinum (Pt), iridium (Ir), osmium (Os), rhenium (Re), tungsten (W), titanium (Ti), tantalum (Ta), hafnium (Hf), any alloy thereof, and any combination thereof. An exemplary plated metal which has this characteristic or property, and which the metal cathodes (cj) may be composed of, is titanium (Ti) plated with a metal oxide selected from the group consisting cobalt oxide, ruthenium oxide, iridium oxide, lead oxide, tungsten oxide, manganese oxide, and any combination thereof.

An important characteristic or property of the graphite or metal anodes (ai) in electrode set 40 of electrolytic reactor unit 16, is that the graphite or metal(s) comprising at least the entire external surface area of the faces and sides of the graphite or metal anodes (ai) be insoluble, or at most, minimally soluble (e.g., via corrosion or rust), i.e., during exposure to electrolytic reactor unit feed solution 15 or/and electrolytically treated cyanide-containing water 17 in electrolytic reactor unit 16. Accordingly, the anodes (ai) are preferably composed of graphite, which has this characteristic or property. Alternatively, the anodes (ai) are composed of one or more (pure, alloyed, or/and plated) metals which have this characteristic or property. Exemplary pure and alloyed metals which have this characteristic or property, and which the anodes (ai) may be composed of, are selected from the group consisting of platinum (Pt), iridium (Ir), osmium (Os), rhenium (Re), tungsten (W), tantalum (Ta), hafnium (Hf), any alloy thereof, and any combination thereof. An exemplary plated metal which has this characteristic or property, and which the anodes (ai) may be composed of, is titanium (Ti) plated with a metal oxide selected from the group consisting cobalt oxide, ruthenium oxide, iridium oxide, lead oxide, tungsten oxide, manganese oxide, and any combination thereof.

In general, metal cathodes (cj), and graphite or metal anodes (ai) in electrode set 40 of electrolytic reactor unit 16, may be of various different types of structural configurations. For example, as shown in FIG. 2, metal cathodes (cj) and graphite or metal anodes (ai) in electrode set 40 are each of a ‘solid’ type of structural configuration. In alternative embodiments of electrode set 40, metal cathodes (cj) or/and metal (i.e., not graphite) anodes (ai) may be of a ‘perforated’ type of structural configuration, i.e., a solid perforated with perforations (openings or holes) extending through the thickness (T) of the solid electrode. In additional alternative embodiments of electrode set 40, metal cathodes (cj) or/and metal anodes (ai) may be of a ‘honeycomb shaped lattice’ type of structural configuration, i.e., a solid honeycomb shaped lattice containing openings or holes extending through the thickness (T) of the solid electrode.

In an exemplary embodiment featuring a perforated type of electrode structural configuration, each metal cathode (cj) and metal anode (ai) is perforated with a plurality of perforations (openings or holes) p, which are located throughout the metal cathode face (f-cj), and throughout the metal anode face (f-ai), respectively, wherein each perforation (opening or hole) extends through the entire thickness (T-cj) of the metal cathode (cj), and through the entire thickness (T-ai) of the metal anode (ai), respectively.

In general, the perforations (openings or holes) p may be of a variety of different geometrical shapes or forms, such as elliptical, circular, triangular, or/and rectangular (e.g., square, pentagonal, hexagonal, heptagonal, octagonal, etc.). In general, each of the perforations (openings or holes) p has a characteristic size dimension (e.g., longest length between two sides, average length or width between two sides, diameter, or other dimension which is characteristic of the particular geometrical shape or form of the perforation (opening or hole)) whose magnitude is the same or different among the plurality of perforations (openings or holes) p. Each of the plurality of perforations (openings or holes) p has a characteristic size dimension whose magnitude is, preferably, in a range of between about 2 millimeters (mm) and about 15 mm. Accordingly, for example, each of a plurality of elliptical perforations (openings or holes) p has a characteristic size dimension, for example, minor axis or major axis of the elliptical shape or form, whose magnitude is, preferably, in a range of between about 2 millimeters (mm) and about 15 mm.

In an exemplary embodiment featuring a honeycomb shaped lattice type of electrode structural configuration, each metal cathode (cj) and metal anode (ai) has a plurality of openings or holes h, which are located throughout the metal cathode face (f-cj), and throughout the metal anode face (f-ai), respectively, wherein each opening or hole extends through the entire thickness (T-cj) of the metal cathode (cj), and through the entire thickness (T-ai) of the metal anode (ai), respectively.

In general, openings or holes h may be of a variety of different geometrical shapes or forms, such as rectangular (e.g., square, pentagonal, hexagonal, heptagonal, octagonal, etc.), elliptical, circular, or/and triangular. For example, as shown in FIG. 5, openings or holes h are generally of a square geometrical shape or form. In general, each of the openings or holes h has a characteristic size dimension (e.g., longest length between two sides, average length or width between two sides, diameter, or other dimension which is characteristic of the particular geometrical shape or form of the opening or hole whose magnitude is the same or different among the plurality of openings or holes h. Each of the plurality of openings or holes h has a characteristic size dimension whose magnitude is, preferably, in a range of between about 2 millimeters (mm) and about 15 mm. Accordingly, for example, each of the plurality of the honeycomb openings or holes h has a characteristic size dimension, for example, length or width of the square shape or form, whose magnitude is, preferably, in a range of between about 2 millimeters (mm) and about 15 mm.

For a honeycomb shaped lattice type of structural configuration of a metal cathode (cj) and of a metal anode (ai) in electrode set 40 of electrolytic reactor unit 16, for example, the plurality of openings or holes h are separated by sides or walls sw of the geometrical shape or form. Each of the separating sides or walls sw has a thickness whose magnitude is, preferably, in a range of between about 1.5 millimeters (mm) and about 5.5 mm.

Based on the hereinabove illustratively described exemplary alternative preferred embodiments of the various different types of structural configurations of the metal cathodes (cj), and graphite or metal anodes (ai) in electrode set 40 of electrolytic reactor unit 16, following is a list of the main preferred configurations of electrode set 40 of electrolytic reactor unit 16:

(solid) metal cathodes+(solid) graphite anodes.

(perforated or/and honeycomb lattice) metal cathodes+(solid) graphite anodes.

(perforated or/and honeycomb lattice) metal cathodes+(solid) metal anodes.

(solid) metal cathodes+(perforated or/and honeycomb lattice) metal anodes.

(perforated or/and honeycomb lattice) metal cathodes+(perforated or/and honeycomb lattice) metal anodes.

The term (solid) indicates that the electrode is not of a perforated type of structural configuration, or of a honeycomb shaped lattice type of structural configuration.

Electrolytic reactor unit 16, in general, and electrode set 40 and electrodes thereof, in particular, operate with electrical power supplied, monitored, and controlled, by power supply and process control unit 18. For example, during operation of electrolytic reactor unit 16, a controllable constant direct current (dc) provided to electrode set 40 and electrodes thereof, is supplied, monitored (measured), and controlled, via power supply assembly 72, power supply monitoring (measuring) and controlling mechanism 70, and central programming and electronic input/output control signal processing assembly 74, of power supply and process control unit 18. Electrolytic reactor unit 16, in general, and electrode set 40 and electrodes thereof, in particular, are configured for being operatively connected to power supply and process control unit 18, via electrolytic reactor unit electronic input/output control signal communications line 60.

The current [expressed in units of amperes (amp)] supplied by power supply and process control unit 18, to the ‘entire’ electrode set 40 of electrodes thereof, of electrolytic reactor unit 16, is, preferably, in a range of between about 400 amp and about 1000 amp, more preferably, in a range of between about 500 amp and about 750 amp, and most preferably, in a range of between about 570 amp and about 630 amp. For the preferred embodiments of electrode set 40 and electrodes thereof, of electrolytic reactor unit 16, as illustratively described hereinabove, the magnitude of the current is equal between each pair of a metal cathode (cj) and an immediately neighboring graphite or metal anode (ai).

The electrode current density [expressed in units of amperes per square meter (amp/m²)] across the surface area of the face (f-cj) of each metal cathode (cj) and across the surface area of the face (f-ai) of each graphite or metal anode (ai) is, preferably, in a range of between about 250 amp/m² and about 1000 amp/m², more preferably, in a range of between about 300 amp/m² and about 600 amp/m², and most preferably, in a range of between about 320 amp/m² and about 450 amp/m². For the preferred embodiment of electrode set 40 and electrodes thereof, of electrolytic reactor unit 16, as illustratively described hereinabove, the magnitude of the electrode current density is constant across the surface area of the face of each metal cathode (cj) and of each graphite or metal anode (ai), in accordance with the constant current supplied to the electrodes.

The voltage [expressed in units of voltage (V)] supplied by power supply and process control unit 18 to electrode set 40 and electrodes thereof, of electrolytic reactor unit 16, is, preferably, in a range of between about 4 V and about 50 V.

The voltage supplied by power supply and process control unit 18 to electrode set 40 and electrodes thereof, varies, and is a function primarily of the following operating parameters and conditions of electrolytic reactor unit 16: (1) the electrical conductivity of electrolytic reactor unit feed solution 15 [for example, including filtered cyanide-containing water 12′, possible second portion (overflow) 17b of electrolytically treated cyanide-containing water 17, and recycled electrolytically treated cyanide-containing water 210 (of recycle unit 22)] which is fed to electrolytic reactor unit 16; (2) the size or geometrical dimensions (length (L), width (W), and thickness (T), of the electrodes (metal cathodes (cj) and graphite or metal anodes (ai)) in electrode set 40; and (3) the inter-electrode separation distance, d, between each pair of a metal cathode (cj) and an immediately neighboring graphite or metal anode (ai).

Reactor housing assembly 42 of electrolytic reactor unit 16 has several functions, and appropriate configurations and components for enabling each function.

A first function of reactor housing assembly 42 is for housing electrode set 40 and the electrodes therein, within whose immediate vicinity various electrolytic (electrochemical) reactions take place for electrolytically (electrochemically) treating a batch amount of cyanide-containing water 12, by reducing the concentration of cyanide species in cyanide-containing water 12.

A second function of reactor housing assembly 42 is for housing various inlet and outlet assemblies, as follows. A reactor housing inlet assembly 44 enables transfer of electrolytic reactor unit feed solution 15 [including filtered cyanide-containing water 12′, possible second portion (overflow) 17b of electrolytically treated cyanide-containing water 17, and recycled electrolytically treated cyanide-containing water 210 (of recycle unit 22)] from water holding and mixing vessel 110 to electrolytic reactor unit 16. A reactor housing first outlet assembly 46 enables transfer of first portion 17a of electrolytically treated cyanide-containing water 17 from electrolytic reactor unit 16 to recycle unit 22. A reactor housing second outlet assembly 48 enables transfer of possible second portion (overflow) 17b of electrolytically treated cyanide-containing water 17 from electrolytic reactor unit 16 to water holding and mixing vessel 110. A reactor housing third outlet assembly 58 enables transfer of a mixture of electrolytic reaction product gases or/and vapors from electrolytic reactor unit 16 to output unit 20.

A third function of reactor housing assembly 42 is for holding or containing a batch amount of electrolytic reactor unit feed solution 15 which is fed into electrolytic reactor unit 16, and for holding or containing a batch amount of electrolytically treated cyanide-containing water 17, of which first portion 17a and possible second portion (overflow) 17b exit from electrolytic reactor unit 16.

A fourth function of reactor housing assembly 42 is for holding or containing a mixture of varying concentrations of electrolytic (electrochemical) reaction product gases or/and vapors, for example, carbon dioxide [CO₂], nitrogen [N₂], hydrogen [H₂], or/and water [H₂O], which exit from electrolytic reactor unit 16.

A fifth function of reactor housing assembly 42 is for housing an optional reactor housing water flow separator assembly 56, which is configured and functions for separating electrolytically treated cyanide-containing water 17 upwardly flowing along and within the immediate vicinity of electrode set 40 and the electrodes therein, wherein various electrolytic (electrochemical) reactions take place for electrolytically (electrochemically) reducing the concentration of cyanide species in cyanide-containing water 12, from electrolytic reactor unit feed solution 15 flowing into electrolytic reactor unit 16.

Reactor housing assembly 42 has two main sections—a reactor housing top section 42a, and a reactor housing bottom section 42b. Electrode set 40 and the electrodes therein occupy space within both reactor housing top section 42a and reactor housing bottom section 42b. Accordingly, reactor housing assembly 42 is of geometrical shape or form, and dimensions, which are suitable for housing electrode set 40 and the electrodes therein, having the above illustratively described geometrical dimensions and magnitudes thereof.

Each of the at least one metal cathode (cj) and each of the at least two graphite or metal anodes (ai) of electrode set 40 are placed, configured, and rigidly fixed inside of reactor housing bottom section 42b, in a manner which enables operation of the above illustratively described preferred embodiment of electrode set 40 of electrolytic reactor unit 16, wherein the bottom end portion of each metal cathode (cj) and of each graphite or metal anode (ai), each have about the same amount of surface area (preferably, being more than half of the total surface area [SA(f-cj)] or [SA(f-ai)] of each metal cathode (cj), or, graphite or metal anode (ai), respectively) which is exposed to, and surrounded by, electrolytic reactor unit feed solution 15.

Reactor housing assembly 42 (reactor housing top section 42a and reactor housing bottom section 42b) includes the main components of: (i) a reactor housing inlet assembly 44, (ii) a reactor housing first outlet assembly 46, (iii) a reactor housing second outlet assembly 48, (iv) an optional reactor housing water flow separator assembly 56, and (v) a reactor housing third outlet assembly 58.

Reactor housing inlet assembly 44, housed in reactor housing bottom section 42b, is configured and functions for transferring electrolytic reactor unit feed solution 15 from water holding and mixing vessel 110 to electrolytic reactor unit 16. Reactor housing inlet assembly 44 includes an inlet feed tube 50, having an inlet assembly 52 located at the first end of inlet feed tube 50, a closure assembly 53 located at the second end of inlet feed tube 50, and preferably, also having a plurality of perforations or holes 54 spaced apart from each other and located along the length of inlet feed tube 50. Electrolytic reactor unit feed solution 15 flows into inlet feed tube 50 via inlet assembly 52, then flows out of inlet feed tube 50 via perforations or holes 54 (as indicated in FIG. 2 by the small wavy arrows vertically emerging from perforations or holes 54) and into reactor housing bottom section 42b of reactor housing assembly 42 of electrolytic reactor unit 16, and subsequently upwardly flows into the immediate vicinity of electrode set 40 and the electrodes therein, wherein various electrolytic (electrochemical) reactions take place for electrolytically (electrochemically) reducing the concentration of cyanide species in cyanide-containing water 12.

Reactor housing first outlet assembly 46, housed in reactor housing bottom section 42b, is configured and functions for transferring first portion 17a of electrolytically treated cyanide-containing water 17 from electrolytic reactor unit 16 to output unit 20.

Reactor housing second outlet assembly 48, housed in reactor housing bottom section 42b, is configured and functions for transferring second portion 17b of electrolytically treated cyanide-containing water 17 from electrolytic reactor unit 16 to recycle unit 22.

Optional reactor housing water flow separator assembly 56, housed in reactor housing bottom section 42b, is configured and functions for separating, in a highly efficient manner, electrolytically treated cyanide-containing water 17 upwardly flowing along and within the immediate vicinity of electrode set 40 and the electrodes therein, wherein various electrolytic (electrochemical) reactions take place for electrolytically (electrochemically) reducing the concentration of cyanide species in cyanide-containing water 12, from electrolytic reactor unit feed solution 15 flowing into electrolytic reactor unit 16.

More specifically, during operation of electrolytic reactor unit 16, electrolytic reactor unit feed solution 15 which is fed from water holding and mixing vessel 110 and into reactor housing bottom section 42b of electrolytic reactor unit 16, and electrolytically treated cyanide-containing water 17 formed therefrom, upwardly flow along and within the immediate vicinity of electrode set 40 and the electrodes therein, in a manner such that only the subsequently formed electrolytically treated cyanide-containing water 17 (and not electrolytic reactor unit feed solution 15) flows and spills over reactor housing water flow separator assembly 56 in reactor housing bottom section 42b (indicated in FIG. 2 by the curved tail arrows extending over reactor housing water flow separator assembly 56 into the upper region of electrolytically treated cyanide-containing water 17).

Optional reactor housing water flow separator assembly 56 is, preferably, a relatively thin wall-like structure extending across the left and right front view sides of reactor housing bottom section 42b. Reactor housing water flow separator assembly 56 has a diameter (extending into the plane of the page, and not visible in FIG. 2) whose magnitude is, preferably, in a range of between about 1 mm and about 30 mm, more preferably, in a range of between about 5 mm and about 20 mm, and most preferably, in a range of between about 8 mm and about 12 mm, with a most preferred magnitude of about 10 mm.

Reactor housing third outlet assembly 58, housed in reactor housing top section 42a, is configured and functions for transferring a mixture of varying concentrations of electrolytic (electrochemical) reaction product gases or/and vapors, for example, carbon dioxide [CO₂], nitrogen [N₂], hydrogen [H₂], or/and water [H₂O], from electrolytic reactor unit 16 to output unit 20. Such gases or/and vapors are produced by the various electrolytic (electrochemical) reactions that primarily take place in the immediate vicinity adjacent to the electrolytically reactive exposed surfaces of the graphite or metal anodes (ai) in electrode set 40, involving a variety of different forms of cyanide species, especially metal cyanide species, such as simple metal cyanides, alkali-metallic cyanides, and complex ammonium-metallic cyanides, which may be present in electrolytic reactor unit feed solution 15.

For cyanide-containing water 12, and therefore, electrolytic reactor unit feed solution 15, containing cyanide species originating from a metal, for example, simple metal salts of cyanide, simple metal cyanides, complex alkali-metallic cyanides, or/and complex ammonium-metallic cyanides, as the various electrolytic (electrochemical) reactions take place in electrolytic reactor unit 16, a first portion of the metal ions originating from the cyanide metals is adsorbed onto the surfaces (faces and sides) of the steel cathodes (cj), while a second portion remains in solution. At the operating parameters and conditions used for implementing the integrated cyanide species removal method, ordinarily, the graphite or metal anodes (ai) are essentially chemically inert to cyanide species, whereby cyanide species in electrolytic reactor unit feed solution 15 may contact the graphite or metal anodes (ai), but do not adsorb onto, or chemically react with, the graphite or metal anodes (ai). Instead of electrolytic (electrochemical) reactions taking place on the surfaces of the graphite or metal anodes (ai), the current passing through the graphite or metal anodes (ai) provides the necessary activation energy for causing various electrolytic (electrochemical) reactions to take place between the cyanide species and the water present in reactor housing bottom section 42b, in the immediate vicinity adjacent to, and not on, the surfaces (faces and sides) of the graphite or metal anodes (ai). During this time, there is produced a mixture of varying concentrations of electrolytic (electrochemical) reaction product gases or/and vapors, for example, carbon dioxide [CO₂], nitrogen [N₂], hydrogen [H₂], or/and water [H₂O]. These processes result in reducing the concentration of cyanide species in electrolytic reactor unit feed solution 15, corresponding to electrolytically (electrochemically) reducing the concentration of cyanide species in cyanide-containing water 12, thereby forming electrolytically treated cyanide-containing water 17.

During operation of electrolytic reactor unit 16, electrolytic reactor unit feed solution 15 which is fed from recycle unit 22 and into reactor housing bottom section 42b of electrolytic reactor unit 16, and electrolytically treated cyanide-containing water 17 formed therefrom, upwardly flow along and within the immediate vicinity of electrode set 40 and the electrodes therein, in a manner such that only the subsequently formed electrolytically treated cyanide-containing water 17 (and not electrolytic reactor unit feed solution 15) flows and spills over reactor housing water flow separator assembly 56 in reactor housing bottom section 42b (as indicated in FIG. 2 by the curved tail arrows extending over reactor housing water flow separator assembly 56 into the upper region of electrolytically treated cyanide-containing water 17).

Presence of reactor housing water flow separator assembly 56 enables separating, in a highly efficient manner, electrolytic reactor unit feed solution 15 [including filtered cyanide-containing water 12′, possible second portion (overflow) 17b of electrolytically treated cyanide-containing water 17, and recycled electrolytically treated cyanide-containing water 210 (of recycle unit 22)] flowing into electrolytic reactor unit 16, from electrolytically treated cyanide-containing water 17 upwardly flowing along and within the immediate vicinity of electrode set 40 and the electrodes therein, wherein various electrolytic (electrochemical) reactions take place for electrolytically (electrochemically) reducing the concentration of cyanide species in cyanide-containing water 12.

After flowing and spilling over reactor housing water flow separator assembly 56 in reactor housing bottom section 42b of reactor housing assembly 42, first portion 17a of electrolytically treated cyanide-containing water 17 exits reactor housing bottom section 42b, and therefore, exits electrolytic reactor unit 16, via reactor housing first outlet assembly 46, and enters recycle tank 200 of recycle unit 22, via inlet assembly 208. At the same time, any possible second portion (overflow) 17b of electrolytically treated cyanide-containing water 17 from electrolytic reactor unit 16 also exits reactor housing bottom section 42b, and therefore, exits electrolytic reactor unit 16, via reactor housing second outlet assembly 48, and enters water holding and mixing vessel 110 of input unit 14, via second inlet assembly 120, for ultimately mixing with filtered cyanide-containing water 12′ and recycled electrolytically treated cyanide-containing water 210 which also enter water holding and mixing vessel 110, for forming electrolytic reactor unit feed solution 15.

### Recycling the Electrolytically Treated Cyanide-Containing Water

Recycle unit 22 is configured for being operatively connected to electrolytic reactor unit 16, input unit 14, output unit 20, and, power supply and process control unit 18, and functions for removing, and therefore, decreasing the concentration of, cyanide species remaining in first portion 17a of electrolytically treated cyanide-containing water 17 which exits electrolytic reactor unit 16 and enters recycle tank 200. Removing, and therefore, decreasing the concentration of, such remaining cyanide species is effected in two ways, according to two respective procedures: (1) subjecting first portion 17a of electrolytically treated cyanide-containing water 17 to additional cycles (i.e., recycling) of the electrolytic treatment via electrolytic reactor unit 16, and (2) subjecting first portion 17a of electrolytically treated cyanide-containing water 17 to a chemical (oxidation) treatment via in-situ real time freshly generated hypochlorite ion solution electrolytically produced by an in-situ hypochlorite ion solution generating electrolytic reactor assembly which is configured in-line with recycle tank 200. The first way, and procedure, of removing, and therefore, decreasing the concentration of, cyanide species remaining in first portion 17a of electrolytically treated cyanide-containing water 17 which exits electrolytic reactor unit 16 and enters recycle tank 200, are illustratively described hereinbelow in the context of performing the present Step (a) (block 2, FIG. 1). The second way, and procedure, of removing, and therefore, decreasing the concentration of, the remaining cyanide species are illustratively described further below in the context of performing the latter Step (c) (block 6, FIG. 1).

As illustrated in FIG. 2, recycle unit 22 includes the main components of: (i) a recycle tank 200, (ii) an automatic water (volumetric or mass) output level monitoring (measuring) and controlling mechanism 212, (iii) a cyanide species concentration measuring loop 274, and (iv) an in-situ hypochlorite ion solution generating electrolytic reactor assembly 202. Each main component of recycle unit 22 is configured for being operatively connected to power supply and process control unit 18, via recycle unit electronic input/output control signal communications line 272.

First portion 17a of electrolytically treated cyanide-containing water 17 exits reactor unit 16, via reactor housing second outlet assembly 46, passes through a valve 206, and enters recycle tank 200, via inlet assembly 208 of recycle tank 200. By entering recycle tank 200, first portion 17a of electrolytically treated cyanide-containing water 17 corresponds to, and becomes, ‘recycled electrolytically treated cyanide-containing water’ 210 inside recycle tank 200.

Shortly following start of the recycling type of electrolytic treatment, that is, shortly following the start of first portion 17a of electrolytically treated cyanide-containing water 17 entering recycle tank 200 and becoming recycled electrolytically treated cyanide-containing water 210 inside recycle tank 200, cyanide species concentration measuring loop 274 is activated for starting continuous measurement of cyanide species concentration of the (recycled) first portion 17a of electrolytically treated cyanide-containing water 17, corresponding to cyanide species concentration of recycled electrolytically treated cyanide-containing water 210, inside recycle tank 200.

Cyanide species concentration measuring loop 274 includes: (i) a valve 224, (ii) a water pump 226, and (iii) a recycle water redox (reduction-oxidation) potential measuring mechanism 204. Recycle water redox (reduction-oxidation) potential measuring mechanism 204, herein, referred to as recycle water redox potential measuring mechanism 204, is configured and functions for continuously measuring the redox (reduction-oxidation) potential, herein, referred to as the redox potential, (for example, in units of millivolts) of recycled electrolytically treated cyanide-containing water 210 inside recycle tank 200. Cyanide species concentration measuring loop 274 components are operatively connected to electronic input/output control signal processing assembly 74 of power supply and process control unit 18, via recycle unit electronic input/output control signal communications line 272. During operation of cyanide species measuring loop 274, recycled electrolytically treated cyanide-containing water 210 is pumped by water pump 226, from recycle tank 200, via outlet assembly 242, through recycle water redox potential measuring mechanism 204 (which measures and registers the cyanide species concentration), through water pump 226, then, through valve 224, and back into recycle tank 200, via inlet assembly 236.

Accordingly, in a synchronous manner, when recycled electrolytically treated cyanide-containing water 210 increases to a level inside recycle tank 200 sufficient for operation of cyanide species measuring loop 274 (i.e., sufficient for operation of valve 224, water pump 226, and recycle water redox potential measuring mechanism 204), central programming and electronic input/output control signal processing assembly 74 of power supply and process control unit 18, via recycle unit electronic input/output control signal communications line 272, sends a {valve-open} process control signal to valve 224 for actuating and opening valve 224, and simultaneously sends a {pump-on} process control signal to water pump 226 for actuating and turning-on water pump 226, and simultaneously sends a {power-on} process control signal to recycle water redox potential measuring mechanism 204 for actuating and turning-on recycle water redox potential measuring mechanism 204. This synchronous operation directs recycled electrolytically treated cyanide-containing water 210 which is inside recycle tank 200 to exit and flow from recycle tank 200, via outlet assembly 242, through recycle water redox potential measuring mechanism 204 (thereby measuring the cyanide species concentration), through water pump 226, then, through valve 224, and back into recycle tank 200, via inlet assembly 236. During this time of operation of cyanide species measuring loop 274, in output unit 20, water pump 240 is off, and valve 238 is closed.

### Optional (One-Time) Addition of a Small Amount of Aqueous Sodium Chloride Solution to Recycled Electrolytically Treated Cyanide-Containing Water

This stage of performing Step (a), optionally, and preferably, includes a ‘one-time’ addition of a small (volumetric or mass) amount of aqueous sodium chloride [NaCl] solution to recycled electrolytically treated cyanide-containing water 210 inside recycle tank 200. Accordingly, in a synchronous manner, shortly following start of operation of cyanide species measuring loop 274 for continuously measuring the cyanide species concentration of recycled electrolytically treated cyanide-containing water 210 inside recycle tank 200, central programming and electronic input/output control signal processing assembly 74 of power supply and process control unit 18, via recycle unit electronic input/output control signal communications line 272, sends a {valve-open} process control signal to valve 262 of recycle unit 22 for actuating and opening valve 262, thereby initiating and directing a small (volumetric or mass) amount of aqueous sodium chloride [NaCl] solution to flow from a mixing vessel 250, via mixing vessel outlet assembly 264, through valve 262, and into recycle tank 200, via recycle tank inlet assembly 266. Immediately following addition of the small (volumetric or mass) amount of aqueous sodium chloride [NaCl] solution to recycled electrolytically treated cyanide-containing water 210 inside recycle tank 200, central programming and electronic input/output control signal processing assembly 74, via recycle unit electronic input/output control signal communications line 272, sends a {valve-close} process control signal to valve 262 for actuating and closing valve 262, thereby stopping the flow of aqueous sodium chloride [NaCl] solution from mixing vessel 250 to recycle tank 200.

The preceding (optional, and preferred) procedure provides a ‘one-time’ addition of small amounts of sodium ions [Na⁺] and chloride ions [Cl⁻] from mixing vessel 250 to recycled electrolytically treated cyanide-containing water 210 inside recycle tank 200, and is performed for the following reason. The relatively low concentration (i.e., less than about 500 milligrams per liter (mg/l) [500 parts per million (ppm)]) of cyanide species in cyanide-containing water 12 results in relatively low ion content, and therefore, relatively low electrical conductivity, of recycled electrolytically treated cyanide-containing water 210 which is recycled through electrolytic reactor unit 16. Therefore, this procedure is performed for the main purpose of increasing ion content, and therefore, increasing electrical conductivity, of recycled electrolytically treated cyanide-containing water 210 which is recycled through electrolytic reactor unit 16, thereby improving the efficiency of operation of electrolytic reactor unit 16 for electrolytically treating cyanide-containing water 12. During actual experimental testing, it was determined that the relatively small amount of chloride ions [Cl⁻] which is ‘one-time’ added to recycled electrolytically treated cyanide-containing water 210 only minimally functions as an oxidizing agent for oxidizing cyanide species in recycled electrolytically treated cyanide-containing water 210. Oxidizing cyanide species remaining in recycled electrolytically treated cyanide-containing water 210 takes place in hereinbelow illustratively described Step (c) of chemically treating recycled electrolytically treated cyanide-containing water 210 inside recycle tank 200 with in-situ real time freshly generated hypochlorite ion solution 230 electrolytically produced by an in-situ hypochlorite ion solution generating electrolytic reactor assembly 202 configured in-line with recycle tank 200.

For performing the preceding (optional, and preferred) procedure, the aqueous sodium chloride [NaCl] solution is prepared in mixing vessel 250 as illustratively described hereinbelow for performing Step (c), in the procedure of synchronous electrolytic production of in-situ real time freshly generated hypochlorite ion solution 230. In mixing vessel 250, the aqueous sodium chloride [NaCl] solution has a sodium chloride [NaCl] concentration, for example, in a range of between about 40 grams per liter (g/l) [40 parts per thousand (ppt)] and about 60 grams per liter (g/l) [60 parts per thousand (ppt)]. The (volumetric or mass) amount of aqueous sodium chloride [NaCl] solution which is (one-time) supplied from mixing vessel 250 to recycled electrolytically treated cyanide-containing water 210 inside recycle tank 200, is relatively, significantly less than the (volumetric or mass) amount of in-situ real time freshly generated hypochlorite ion solution 230 which is supplied from in-situ hypochlorite ion solution generating electrolytic reactor assembly 202 to recycled electrolytically treated cyanide-containing water 210 inside recycle tank 200.

First portion 17a of electrolytically treated cyanide-containing water 17 enters recycle tank 200 and becomes recycled electrolytically treated cyanide-containing water 210 until the instantaneous level thereof inside recycle tank 200 increases to (i.e., equals) a pre-determined maximum level, corresponding to the instantaneous (volumetric or mass) amount of recycled electrolytically treated cyanide-containing water 210 inside recycle tank 200 increasing to (i.e., equaling) a pre-determined maximum amount. The instantaneous level, and therefore, the instantaneous (volumetric or mass) amount, of recycled electrolytically treated cyanide-containing water 210 inside of recycle tank 200 is monitored (measured) and controlled by operation of an automatic water (volumetric or mass) level monitoring (measuring) and controlling mechanism 212 which is configured for being operatively connected to power supply and process control unit 18, via recycle unit electronic input/output control signal communications line 272. Automatic water output level monitoring (measuring) and controlling mechanism 212 is preferably located inside of recycle tank 200, as shown in FIG. 2.

When the instantaneous level of recycled electrolytically treated cyanide-containing water 210 increases to (i.e., equals) the pre-determined maximum level inside recycle tank 200, automatic water output level monitoring (measuring) and controlling mechanism 212 measures and registers this event of filling up of recycle tank 200 with recycled electrolytically treated cyanide-containing water 210. In a synchronous manner, following automatic water output level monitoring (measuring) and controlling mechanism 212 measuring, and registering, this event, then, automatic water output level monitoring (measuring) and controlling mechanism 212, via recycle unit electronic input/output control signal communications line 272, sends a feedback control signal (FCS-0) to central programming and electronic input/output control signal processing assembly 74 of power supply and process control unit 18.

In a sequentially synchronous manner, following central programming and electronic input/output control signal processing assembly 74 receiving, registering, and processing, the feedback control signal (FCS-0), then, central programming and electronic input/output control signal processing assembly 74, via input unit electronic input/output control signal communications line 39, sends a {valve-close} process control signal to valve 33 of input unit 14 for actuating and closing valve 33, thereby stopping the flow of filtered cyanide-containing water 12′ into water holding and mixing vessel 110. Thus, the total (volumetric or mass) batch amount of filtered cyanide-containing water 12′ which has entered into water holding and mixing vessel 110 from the time in Step (a) when external source 24 starts supplying cyanide-containing water 12 to input unit 14, until the time in Step (b) of stopping the flow of filtered cyanide-containing water 12′ into water holding and mixing vessel 110, corresponds to the total (volumetric or mass) batch amount of cyanide-containing water 12 which is electrolytically treated in electrolytic reactor unit 16.

In a synchronous manner, at about the same time when the instantaneous level of recycled electrolytically treated cyanide-containing water 210 increases to (i.e., equals) the pre-determined maximum level inside recycle tank 200, central programming and electronic input/output control signal processing assembly 74 of power supply and process control unit 18, via recycle unit electronic input/output control signal communications line 272, sends a {valve-open} process control signal to valve 214 of recycle unit 22 for actuating and opening valve 214, and simultaneously sends a {pump-on} process control signal to water pump 216 of recycle unit 22 for actuating and turning-on water pump 216. This synchronous operation directs recycled electrolytically treated cyanide-containing water 210 which is inside recycle tank 200 to exit and flow from recycle tank 200, via outlet assembly 218, through water pump 216 and valve 214, and eventually to enter water holding and mixing vessel 110, via inlet assembly 220. Recycled electrolytically treated cyanide-containing water 210 which enters water holding and mixing vessel 110 is mixed with, and becomes part of, electrolytic reactor unit feed solution 15. As illustratively described hereinabove, electrolytic reactor unit feed solution 15 exits water holding and mixing vessel 110, via outlet assembly 122, and enters reactor housing bottom section 42b of electrolytic reactor unit 16, via reactor housing inlet assembly 44. Subsequently, electrolytic reactor unit feed solution 15 is electrolytically treated in electrolytic reactor unit 16.

The preceding illustratively described recycle type of flow pattern or configuration corresponds to a closed circuit of water flowing from input unit 14 and recycling through electrolytic reactor unit 16, via recycle unit 22.

Inclusion and operation of recycle unit 22 in integrated cyanide species removal system 10 increases the overall effectiveness of electrolytically removing, and therefore, decreasing the concentration of, cyanide species in cyanide-containing water 12. Via recycle unit 22, the mixing and diluting of filtered cyanide-containing water 12′ (wherein the initial cyanide species concentration is less than about 500 milligrams per liter (mg/l) [500 parts per million (ppm)]), with recycled electrolytically treated cyanide-containing water 210 (wherein, following each cycle, the cyanide species concentration is less than the cyanide species concentration of the preceding cycle), results in removing, and therefore, decreasing the concentration of, cyanide species concentration in electrolytic reactor unit feed solution 15 which exits water holding and mixing vessel 110 and enters electrolytic reactor unit 16. This recycling process enables electrode set 40, and electrodes thereof, of electrolytic reactor unit 16, to remove, and therefore, decrease the concentration of, cyanide species remaining in first portion 17a of electrolytically treated cyanide-containing water 17 which exits electrolytic reactor unit 16. This results in a more effective overall process for removing, and therefore, decreasing the concentration of, cyanide species from cyanide-containing water 12, compared to operating integrated cyanide species removal system 10 without recycle unit 22.

As stated hereinabove, while the various electrolytic (electrochemical) reactions take place in electrolytic reactor unit 16, and during operation of recycle unit 22, in integrated cyanide species removal system 10, for forming electrolytically treated cyanide-containing water 17, there is produced a mixture of electrolytic (electrochemical) reaction product gases or/and vapors, for example, carbon dioxide [CO₂], nitrogen [N₂], hydrogen [H₂], or/and water [H₂O]. These electrolytic reaction product gases or/and vapors exit reactor housing top section 42a of reactor housing assembly 42 of electrolytic reactor unit 16, via reactor housing third outlet assembly 58, and enter gas/vapor removing device 90, of output unit 20, via inlet assembly 98. Gas/vapor removing device 90, such as a gas/vapor type of a scrubber, processes and converts the mixture of electrolytic reaction product gases or/and vapors into a non-hazardous gas/vapor mixture, which exits gas/vapor removing device 90 through outlet assembly 100, for example, to the atmosphere, or/and to a gas/vapor collection vessel, or/and to an inlet assembly of another process.

The above illustratively described synchronous operation of input unit 14, electrolytic reactor unit 16, recycle unit 22, output unit 22, and, power supply and process control unit 18, and components thereof, for performing Step (a) of the integrated cyanide species removal method, using integrated cyanide species removal system 10, results in removing, and therefore, decreasing the concentration of, cyanide species concentration in cyanide-containing water 12 (filtered cyanide-containing water 12′), and subsequently, in electrolytic reactor unit feed solution 15, which enters electrolytic reactor unit 16. By completing Step (a), there is forming recycled electrolytically treated cyanide-containing water 210 inside recycle tank 200 of recycle unit 22.

Stopping the Electrolytic Treatment when the Cyanide Species Concentration Decreases to About 10 Percent of the Initial Cyanide Species Concentration

In Step (b) (block 4, FIG. 1), there is stopping the electrolytic treatment when cyanide species concentration of the recycled electrolytically treated cyanide-containing water decreases to a first concentration value of about 10 percent of the initial concentration, for forming recycled electrolytically treated cyanide-containing water of the first concentration value contained inside a recycle tank of the recycle unit. Accordingly, with reference to FIG. 2, in Step (b), there is stopping (terminating) the electrolytic treatment when the cyanide species concentration of recycled electrolytically treated cyanide-containing water 210 decreases to a first concentration value of about 10 percent of the initial concentration (of cyanide-containing water 12 (filtered cyanide-containing water 12′) of less than about 500 milligrams per liter (mg/l) [500 parts per million (ppm)]), for forming recycled electrolytically treated cyanide-containing water 210 of the first concentration value contained inside recycle tank 200 of recycle unit 22.

In previous Step (a), shortly following the start of first portion 17a of electrolytically treated cyanide-containing water 17 entering recycle tank 200 and becoming recycled electrolytically treated cyanide-containing water 210 inside recycle tank 200, cyanide species concentration measuring loop 274 was activated for continuously measuring cyanide species concentration of the (recycled) first portion 17a of electrolytically treated cyanide-containing water 17, corresponding to continuously measuring cyanide species concentration of recycled electrolytically treated cyanide-containing water 210, inside recycle tank 200. Additionally, via Step (a), recycling first portion 17a of electrolytically treated cyanide-containing water 17 through electrolytic reactor unit 16 and recycle unit 22 results in removing cyanide species remaining in first portion 17a of electrolytically treated cyanide-containing water 17 which exits electrolytic reactor unit 16 and enters recycle tank 200, and therefore, results in decreasing cyanide species concentration of recycled electrolytically treated cyanide-containing water 210 inside recycle tank 200. Accordingly, the decrease in cyanide species concentration of recycled electrolytically treated cyanide-containing water 210 inside recycle tank 200 is continuously measured in terms of a corresponding (proportionate) decrease in the redox potential (for example, in units of millivolts) of recycled electrolytically treated cyanide-containing water 210 inside recycle tank 200, via operation of cyanide species concentration measuring loop 274, in general, and via operation of recycle water redox potential measuring mechanism 204, in particular.

### Empirically Determined Database of Redox Potential Values as a Function of Cyanide Species Concentration Values

As stated hereinabove, a main aspect of some embodiments of the present invention is that the batch amount of cyanide-containing water 12 wherein initial cyanide species concentration is less than about 500 milligrams per liter, is electrolytically treated via synchronized operation of input unit 14, electrolytic reactor unit 16, recycle unit 22, output unit 20, and, power supply and process control unit 18, for forming recycled electrolytically treated cyanide-containing water 210 inside recycle tank 200 of recycle unit 22. Such synchronized operation includes utilizing an empirically determined database of empirically determined values derived from an empirically determined calibration curve or table of empirically determined values of redox potential of recycled electrolytically treated cyanide-containing water 210 as a function of empirically known or/and determined values of the cyanide species concentration of recycled electrolytically treated cyanide-containing water 210.

More specifically, as part of setting up and implementing specific embodiments of the integrated cyanide species removal method of the present invention, via integrated cyanide species removal system 10, power supply and process control unit 18, in general, and central programming and electronic input/output control signal processing assembly 74, in particular, are configured and operative with an empirically determined database which includes ‘empirically determined values’ derived from an empirically determined calibration curve (for example, in a form of an x-y plot) or table (for example, in a form of a look-up-table (LUT)) of ‘empirically determined values’ of redox potential of cyanide-containing water (for example, of recycled electrolytically treated cyanide-containing water 210, or similar type of cyanide-containing water) inside a vessel or tank (for example, inside recycle tank 200, or similar type of tank), as a function of ‘empirically known or/and determined values’ of cyanide species concentration of the cyanide-containing water inside the vessel or tank.

The phrase ‘empirically determined value’, as used herein, refers to a specific value of an empirical parameter, particularly, redox potential of cyanide-containing water, or cyanide species concentration of cyanide-containing water, inside a vessel or tank, which is determined by either: (1) direct laboratory type experimental measurement of the actual specific value, or, (2) calculation of the specific value, for example, by using an interpolation or extrapolation type of calculation procedure involving the use of a number of direct laboratory type experimental measurements of other (e.g., neighboring) actual values in an appropriate range of values, for interpolating or extrapolating the specific value.

The empirically determined database of the empirically determined values derived from the empirically determined calibration curve (x-y plot) or table (LUT) includes (y-axis, or dependent variable) empirically determined values of redox potential (for example, in units of millivolts) of cyanide-containing water, as a function of (x-axis, or independent variable) empirically known or/and determined values of cyanide species concentration (for example, in units of milligrams per liter (mg/l) or parts per million (ppm)), of the cyanide-containing water inside the vessel or tank, for cyanide species concentration in a range of, preferably, between about 600 milligrams per liter (mg/l) [600 parts per million (ppm)] and about 0 milligram per liter (mg/l) [0 part per million (ppm)].

Thus, in the empirically determined database of the empirically determined values derived from the empirically determined calibration curve (x-y plot) or table (LUT), for a given (y-axis, or dependent variable) empirically known or/and determined value of cyanide species concentration (in units of milligrams per liter (mg/l) or parts per million (ppm)), of the cyanide-containing water inside the vessel or tank, there is a corresponding (x-axis, or independent variable) empirically determined value of the redox potential (in units of millivolts) thereof. Hereinafter, for brevity, the preceding described empirically determined database of the empirically determined values derived from the empirically determined calibration curve (x-y plot) or table (LUT) is referred to as ‘the empirically determined database [EDDb]’.

An example of utilizing the data and information obtained and made available from the empirically determined database [EDDb] is as follows. For a given implementation of the integrated cyanide species removal method of the present invention, a given batch amount of cyanide-containing water 12 which is supplied from external source 24 and fed into input unit 14, contains any combination of any number of a wide variety of different forms of cyanide species, and has an empirically determined value of an initial cyanide species concentration of less than about 500 milligrams per liter (mg/l) [500 parts per million (ppm)], and therefore, has a corresponding empirically determined value of the initial redox potential (in units of millivolts) thereof. Accordingly, from results of performing either direct laboratory type experimental measurement, or, calculation, the empirically determined database [EDDb] includes an empirically known or/and determined value of cyanide species concentration of cyanide-containing water 12 corresponding to about 10 percent (i.e., 9-11 percent, in accordance with the hereinabove defined meaning and usage of the term ‘about’) of the initial cyanide species concentration of less than about 500 milligrams per liter (mg/l) [500 parts per million (ppm)], and therefore, the empirically determined database [EDDb] also includes a corresponding empirically determined value of the redox potential (in units of millivolts) thereof.

Step (b) is performed by utilizing the data and information provided by the empirically determined database [EDDb], whereby power supply and process control unit 18, in general, and central programming and electronic input/output control signal processing assembly 74, in particular, are configured and operative with the empirically determined database [EDDb], involving storing, retrieving, analyzing, and processing, data and information of the empirically determined database [EDDb].

### Stopping (Terminating) Recycling and Electrolytic Treatment of Electrolytically Treated Cyanide-Containing Water

During Step (b), inside recycle tank 200 of recycle unit 22, when cyanide species concentration of recycled electrolytically treated cyanide-containing water 210 decreases to a first concentration value of about 10 percent of the initial concentration (of cyanide-containing water 12 (filtered cyanide-containing water 12′) of less than about 500 milligrams per liter (mg/l) [500 parts per million (ppm)]), there is a corresponding (proportional) decrease of the redox potential to a corresponding first redox potential value thereof, as measured, and registered, by recycle water redox potential measuring mechanism 204 of cyanide species concentration measuring loop 274.

Accordingly, in a synchronous manner, following recycle water redox potential measuring mechanism 204 measuring, and registering, this corresponding first redox potential value, then, recycle water redox potential measuring mechanism 204, via recycle unit electronic input/output control signal communications line 272, sends a first feedback control signal (FCS-1) to central programming and electronic input/output control signal processing assembly 74 of power supply and process control unit 18.

In a sequentially synchronous manner, following central programming and electronic input/output control signal processing assembly 74 of power supply and process control unit 18, receiving, registering, and processing, the first feedback control signal (FCS-1), along with utilizing the data and information stored in, and retrievable from, the empirically determined database [EDDb], then, central programming and electronic input/output control signal processing assembly 74, via recycle unit electronic input/output control signal communications line 272, sends a {valve-close} process control signal to valve 206 for actuating and closing valve 206, thereby stopping (terminating) the flow of the (recycled) first portion 17a of electrolytically treated cyanide-containing water 17 entering recycle tank 200 of recycle unit 22.

In a synchronous manner, at about the same time, central programming and electronic input/output control signal processing assembly 74, via recycle unit electronic input/output control signal communications line 272, sends a {pump-off} process control signal to water pump 216 for actuating and turning-off water pump 216, and simultaneously sends a {valve-close} process control signal to valve 214 for actuating and closing valve 214, thereby stopping recycled electrolytically treated cyanide-containing water 210 which is inside recycle tank 200 from exiting and flowing from recycle tank 200, via outlet assembly 218, through water pump 216 and valve 214, to water holding and mixing vessel 110.

In a synchronous manner, at about the same time, central programming and electronic input/output control signal processing assembly 74, via input unit electronic input/output control signal communications line 39, sends a sends a {pump-off} process control signal to water pump 112 for actuating and turning-off water pump 112, and simultaneously sends a {valve-close} process control signal to valve 114 for actuating and closing valve 114, thereby stopping electrolytic reactor unit feed solution 15 from exiting and flowing from water holding and mixing vessel 110 and entering into electrolytic reactor unit 16.

In a synchronous manner, either at about the same time, or shortly thereafter, central programming and electronic input/output control signal processing assembly 74 sends a {power-off} process control signal to power supply monitoring (measuring) and controlling mechanism 70, for actuating and controlling power supply assembly 72 in a manner such that power supply assembly 72 (temporarily) stops supplying power to the electrodes of electrode set 40 of electrolytic reactor unit 16. This procedure results in significant saving of energy (electricity), and therefore, of cost, for operating electrolytic reactor unit 16 during implementation of specific embodiments of the overall integrated cyanide species removal method of the present invention.

The above illustratively described synchronous operation of recycle unit 22, input unit 14, electrolytic reactor unit 16, and, power supply and process control unit 18, and components thereof, for performing Step (b) of the integrated cyanide species removal method, using integrated cyanide species removal system 10, results in stopping (terminating) additional recycling of recycled electrolytically treated cyanide-containing water 210, and therefore, results in stopping (terminating) additional cycles of electrolytic treatment of recycled electrolytically treated cyanide-containing water 210. By completing Step (b), there is forming recycled electrolytically treated cyanide-containing water 210 of the first concentration value contained inside recycle tank 200 of recycle unit 22.

Chemically Treating the Recycled Electrolytically Treated Cyanide-Containing Water with Electrolytically Produced In-Situ Real Time Freshly Generated Hypochlorite Ion Solution

In Step (c) (block 6, FIG. 1), there is chemically treating the recycled electrolytically treated cyanide-containing water of the first concentration value inside the recycle tank with in-situ real time freshly generated hypochlorite ion solution electrolytically produced by an in-situ hypochlorite ion solution generating electrolytic reactor assembly configured in-line with the recycle tank. Accordingly, with reference to FIG. 2, in Step (c), there is chemically treating recycled electrolytically treated cyanide-containing water 210 of the first concentration value inside recycle tank 200 with in-situ real time freshly generated hypochlorite ion solution 230 electrolytically produced by an in-situ hypochlorite ion solution generating electrolytic reactor assembly 202 configured in-line with recycle tank 200.

At an appropriate time sequence (as described hereinbelow) of operation of recycle unit 20, in-situ real time freshly generated hypochlorite ion solution 230 containing hypochlorite ions [ClO⁻] is fed into recycle tank 200. Therein, hypochlorite ion solution 230 and the (recycled) first portion 17a of electrolytically treated cyanide-containing water 17, corresponding to recycled electrolytically treated cyanide-containing water 210 of the first concentration value of cyanide species {i.e., from previous Step (b), of about 10 percent of the initial concentration (of cyanide-containing water 12 (filtered cyanide-containing water 12′) of less than about 500 milligrams per liter (mg/l) [500 parts per million (ppm)])}, contained inside recycle tank 200, continuously mix and react with each other. The continuous mixing and reacting inside recycle tank 200 result in removing, and therefore, decreasing the concentration of, cyanide species in recycled electrolytically treated cyanide-containing water 210 of the first concentration value of cyanide species contained inside recycle tank 200, to lower concentration values of cyanide species inside recycle tank 200.

### Synchronous Electrolytic Production of In-Situ Real Time Freshly Generated Hypochlorite Ion Solution

In-situ real time freshly generated hypochlorite ion solution 230 is electrolytically produced by in-situ hypochlorite ion solution generating electrolytic reactor assembly 202 which is configured in-line with, and operatively connected to, recycle tank 200. Accordingly, in-situ hypochlorite ion solution generating electrolytic reactor assembly 202 is configured and functions for electrolytically producing in-situ real time freshly generated hypochlorite ion solution 230 containing hypochlorite ions [ClO⁻], synchronously, during real-time implementation of the integrated cyanide species removal method, using integrated cyanide species removal system 10.

For electrolytically producing in-situ real time freshly generated hypochlorite ion solution 230 containing hypochlorite ions [ClO⁻], synchronously, during real-time implementation of the integrated cyanide species removal method, by in-situ hypochlorite ion solution generating electrolytic reactor assembly 202 of recycle unit 22 of integrated cyanide species removal system 10, there is first preparing a fresh aqueous solution of sodium chloride [NaCl] in a mixing vessel 250. A measured amount of sodium chloride [NaCl] is provided to mixing vessel 250, and is then dissolved in water originating from one of two alternative water sources: (1) an externally available water source 252, or (2) an internally available water source, being recycled electrolytically treated cyanide-containing water 210 of the first concentration value contained inside recycle tank 200 which is obtained from recycle tank 200 via output unit 20.

According to use of alternative water source (1), in a synchronous manner, central programming and electronic input/output control signal processing assembly 74 of power supply and process control unit 18, via recycle unit electronic input/output control signal communications line 272, sends a {valve-open} process control signal to valve 254 for actuating and opening valve 254, thereby initiating and directing a pre-determined (volumetric or mass) amount of water to flow from externally available water source 252, through valve 254, and into mixing vessel 250. Then, central programming and electronic input/output control signal processing assembly 74, via recycle unit electronic input/output control signal communications line 272, sends a {valve-close} process control signal to valve 254 for actuating and closing valve 254, thereby stopping the flow of water from externally available water source 252 to mixing vessel 250.

According to use of alternative water source (2), in a synchronous manner, central programming and electronic input/output control signal processing assembly 74 of power supply and process control unit 18, via recycle unit electronic input/output control signal communications line 272, sends a {valve-open} process control signal to valve 256 of recycle unit 22, and via output unit electronic input/output control signal communications line 104, sends a {valve-open} process control signal to valve 238 of output unit 20, for actuating and opening valves 256 and 238, respectively, and simultaneously, via output unit electronic input/output control signal communications line 104, sends a {pump-on} process control signal to water pump 240 for actuating and turning-on water pump 240, thereby initiating and directing a pre-determined (volumetric or mass) amount of recycled electrolytically treated cyanide-containing water 210 to flow from recycle tank 200, via outlet assembly 242, either through, or bypassing around, recycle water redox potential measuring mechanism 204, through water pump 240, then, through valves 238 and 256, and into mixing vessel 250. Then, central programming and electronic input/output control signal processing assembly 74, via output unit electronic input/output control signal communications line 104, sends a {valve-close} process control signal to each of valves 238 and 256 for actuating and closing valves 238 and 256, and simultaneously sends a {pump-off} process control signal to water pump 240 for actuating and turning-off water pump 240, thereby stopping the flow of recycled electrolytically treated cyanide-containing water 210 from recycle tank 200 to mixing vessel 250.

Via use of alternative water source (1) or (2), in mixing vessel 250, the freshly prepared aqueous solution of sodium chloride [NaCl] has a sodium chloride [NaCl] concentration, for example, in a range of between 40 grams per liter (g/l) [40 parts per thousand (ppt)] and about 60 grams per liter (g/l) [60 parts per thousand (ppt)].

In a synchronous manner, shortly thereafter, the freshly prepared aqueous solution of sodium chloride [NaCl] in mixing vessel 250 is subjected to electrolysis inside in-situ hypochlorite ion solution generating electrolytic reactor assembly 202, for electrolytically producing in-situ real time freshly generated hypochlorite ion solution 230, as follows.

In-situ hypochlorite ion solution generating electrolytic reactor assembly 202 is designed and constructed (configured) in the same manner, and is operated in a similar manner, as reactor housing assembly 42 of electrolytic reactor unit 16 which is illustratively described hereinabove in the context of performing previous Step (a).

Central programming and electronic input/output control signal processing assembly 74, via recycle unit electronic input/output control signal communications line 272, sends a {valve-open} process control signal to valve 258 for actuating and opening valve 258, thereby initiating and directing a pre-determined (volumetric or mass) amount of the freshly prepared aqueous solution of sodium chloride [NaCl] to flow from mixing vessel 250, via outlet assembly 270, through valve 258, and into in-situ hypochlorite ion solution generating electrolytic reactor assembly 202, via inlet assembly 260.

In a synchronous manner, at about the same time, or shortly thereafter, central programming and electronic input/output control signal processing assembly 74, via recycle unit electronic input/output control signal communications line 272, sends a {power-on} process control signal to power supply assembly 217 of in-situ hypochlorite ion solution generating electrolytic reactor assembly 202 for actuating and turning-on the power of power supply assembly 217, for supplying power to electrodes of in-situ hypochlorite ion solution generating electrolytic reactor assembly 202, in a manner such that there is activating in-situ hypochlorite ion solution generating electrolytic reactor assembly 202, for electrolytically producing in-situ real time freshly generated hypochlorite ion solution 230.

Synchronous electrolytic production of in-situ real time freshly generated hypochlorite ion solution 230 by in-situ hypochlorite ion solution generating electrolytic reactor assembly 202 is initiated and performed, preferably, according to any of the following three exemplary specific embodiments of time sequences (specific Cases 1, 2, and 3):

Case 1 (time sequence 1): at a time before the instantaneous level of recycled electrolytically treated cyanide-containing water 210 increases to (i.e., equals) the pre-determined maximum level inside recycle tank 200.

Case 2 (time sequence 2): at about the same time when the instantaneous level of recycled electrolytically treated cyanide-containing water 210 increases to (i.e., equals) the pre-determined maximum level inside recycle tank 200.

Case 3 (time sequence 3): at a time during, or shortly following, stopping of the electrolytic treatment when the cyanide species concentration of recycled electrolytically treated cyanide-containing water 210 decreases to the first concentration value of about 10 percent of the initial concentration (of cyanide-containing water 12 (filtered cyanide-containing water 12′) of less than about 500 milligrams per liter (mg/l) [500 parts per million (ppm)]), for forming recycled electrolytically treated cyanide-containing water 210 of the first concentration value contained inside recycle tank 200 of recycle unit 22.

In each of the preceding three exemplary specific embodiments of time sequences (specific Cases 1, 2, and 3), the synchronous operation of integrated cyanide species removal system 10 initiates electrolytic production of in-situ real time freshly generated hypochlorite ion solution 230 by in-situ hypochlorite ion solution generating electrolytic reactor assembly 202.

In-situ real time freshly generated hypochlorite ion solution 230 is electrolytically produced by in-situ hypochlorite ion solution generating electrolytic reactor assembly 202 according to a method including the following main steps (procedures): (i) a chloralkali process type electrolysis of aqueous sodium chloride [NaCl], (ii) production of aqueous sodium hypochlorite [NaOCl], (iii) dissociation of the aqueous sodium hypochlorite [NaOCl], for forming aqueous sodium ions [Na⁺] and aqueous hypochlorite ions [ClO⁻].

(i) The chloralkali process type electrolysis of aqueous sodium chloride [NaCl] is performed for producing aqueous sodium hydroxide [NaOH], gaseous chlorine [Cl₂], and gaseous hydrogen [H₂], in accordance with following equations (1) and (2):

2NaCl(aq)+2H₂O(l)-→2NaOH(aq)+Cl₂(g)+2H⁺+2e (1)

2H⁺+2e⁻-→H₂(g) (2)

where (aq)=aqueous, (l)=liquid, and (g)=gas.

(ii) Aqueous sodium hypochlorite [NaOCl] is produced by the aqueous sodium hydroxide [NaOH] reacting with the gaseous chlorine [Cl₂] of step (i), in accordance with following equation (3):

2NaOH(aq)+Cl₂(g)-→NaCl(aq)+NaOCl(aq)+H₂O (3)

(iii) Aqueous sodium hypochlorite [NaOCl] produced by step (ii) is allowed to undergo dissociation, for forming aqueous sodium ions [Na⁺] and aqueous hypochlorite ions [ClO⁻], in accordance with following equation (4):

NaOCl(aq)-→Na⁺(aq)+ClO⁻(aq) (4)

In the above exemplary embodiment, while the various electrolytic (electrochemical) reactions take place in in-situ hypochlorite ion solution generating electrolytic reactor assembly 202, for electrolytically producing in-situ real time freshly generated hypochlorite ion solution 230, there is produced a mixture of electrolytic (electrochemical) reaction product gases or/and vapors, particularly, hydrogen [H₂] and chlorine [Cl₂]. In the same manner as illustratively described hereinabove for performing Step (a) of electrolytically treating a batch amount of cyanide-containing water 12, for forming electrolytically treated cyanide-containing water 17, herein, in the just described method for electrolytically producing in-situ real time freshly generated hypochlorite ion solution 230, the unused or excess gaseous electrolytic reaction product gases or/and vapors (particularly, gaseous hydrogen [H₂] or/and chlorine [Cl₂]) are removed and transferred from in-situ hypochlorite ion solution generating electrolytic reactor assembly 202 to an operatively connected and configured output assembly. The output assembly includes a gas/vapor removing device (similar to gas/vapor removing device 90), such as a gas/vapor type of a scrubber, for processing and converting the mixture of electrolytic reaction product gases or/and vapors into a non-hazardous gas/vapor mixture, which exits the gas/vapor removing device through an outlet assembly, for example, to the atmosphere, or/and to a gas/vapor collection vessel, or/and to an inlet assembly of another process.

The electrolytically produced aqueous hypochlorite ions [ClO⁻] function as the ‘active chemical reagent’ for chemically treating recycled electrolytically treated cyanide-containing water 210 of the first concentration value of cyanide species contained inside recycle tank 200 of recycle unit 22, by mixing and reacting with the cyanide species, which are subsequently degraded and converted into various gaseous species (primarily carbon dioxide [CO₂], nitrogen [N₂], chlorine [Cl₂], and hydrogen [H₂]).

The in-situ real time freshly generated hypochlorite ion solution 230 electrolytically produced by in-situ hypochlorite ion solution generating electrolytic reactor assembly 202, and which eventually is directed into recycle tank 200, has a hypochlorite ion concentration, for example, in a range of between about 8 grams per liter (g/l) [8 parts per thousand (ppt)] and about 12 grams per liter (g/l) [12 parts per thousand (ppt)].

### Chemically Treating the Recycled Electrolytically Treated Cyanide-Containing Water

In previous Step (b), there was stopping (terminating) additional recycling of recycled electrolytically treated cyanide-containing water 210, and therefore, stopping (terminating) additional cycles of electrolytic treatment of recycled electrolytically treated cyanide-containing water 210, for forming recycled electrolytically treated cyanide-containing water 210 of the first concentration value of cyanide species {i.e., of about 10 percent of the initial concentration (of cyanide-containing water 12 (filtered cyanide-containing water 12′) of less than about 500 milligrams per liter (mg/l) [500 parts per million (ppm)])} contained inside recycle tank 200 of recycle unit 22.

In Step (c), at a time following any of the previously described three exemplary specific embodiments of time sequences (specific Cases 1, 2, and 3) implemented for electrolytically producing in-situ real time freshly generated hypochlorite ion solution 230 containing hypochlorite ions [ClO⁻], the in-situ real time freshly generated hypochlorite ion solution 230 is directed and fed into recycle tank 200, as follows.

Central programming and electronic input/output control signal processing assembly 74, via recycle unit electronic input/output control signal communications line 272, sends a {valve-open} process control signal to valve 222 for actuating and opening valve 222, thereby initiating and directing a pre-determined (volumetric or mass) amount of in-situ real time freshly generated hypochlorite ion solution 230 containing hypochlorite ions [ClO⁻] to flow from in-situ hypochlorite ion solution generating electrolytic reactor assembly 202, via outlet assembly 232, through valve 222, and into recycle tank 200, via inlet assembly 234.

In-situ real time freshly generated hypochlorite ion solution 230 and recycled electrolytically treated cyanide-containing water 210 continuously mix and react with each other while inside of recycle tank 200, and while circulating through the components of cyanide species measuring loop 274 (i.e., through recycle water redox potential measuring mechanism 204 (which measures and registers the cyanide species concentration), through water pump 226, then, through valve 224, and back into recycle tank 200).

Inside recycle tank 200, the continuous mixing and reacting of in-situ real time freshly generated hypochlorite ion solution 230 and recycled electrolytically treated cyanide-containing water 210, results in forming a reactive aqueous solution of hypochlorite ions [ClO⁻] and recycled electrolytically treated cyanide-containing water 210. Therein, the hypochlorite ions [ClO⁻] behave as the ‘active chemical reagent’ for chemically treating recycled electrolytically treated cyanide-containing water 210 of the first concentration value of cyanide species contained inside recycle tank 200, whereby cyanide species therein are subsequently degraded and converted into various gaseous species (primarily carbon dioxide [CO₂], nitrogen [N₂], chlorine [Cl₂], and hydrogen [H₂]).

The above illustratively described synchronous operation of recycle unit 22, output unit 20, and, power supply and process control unit 18, and components thereof, for performing Step (c) of the integrated cyanide species removal method, using integrated cyanide species removal system 10, results in the continuous mixing and reacting of in-situ real time freshly generated hypochlorite ion solution 230 and recycled electrolytically treated cyanide-containing water 210 inside recycle tank 200 of recycle unit 20. This, therefore, results in removing, and therefore, decreasing the concentration of, cyanide species in recycled electrolytically treated cyanide-containing water 210 of the first concentration value of cyanide species {i.e., of about 10 percent of the initial concentration (of cyanide-containing water 12 (filtered cyanide-containing water 12′) of less than about 500 milligrams per liter (mg/l) [500 parts per million (ppm)])} contained inside recycle tank 200, to lower values of cyanide species concentration inside recycle tank 200. By completing Step (c), there is forming ‘chemically treated’ recycled electrolytically treated cyanide-containing water 210 of the first concentration value of cyanide species contained inside recycle tank 200 of recycle unit 22.

Stopping the Chemical Treatment when the Cyanide Species Concentration in the Recycle Tank Decreases to Less than 1 Milligram Per Liter, for Forming Clean Treated Water

In Step (d) (block 8, FIG. 1), there is stopping the chemical treatment when cyanide species concentration inside the recycle tank decreases to a second concentration value of less than 1 milligram per liter (mg/l) [1 part per million (ppm)], for forming clean treated water of the second concentration value contained inside the recycle tank. Accordingly, with reference to FIG. 2, in Step (d), there is stopping the chemical treatment when cyanide species concentration inside recycle tank 200 decreases to a second concentration value of less than 1 milligram per liter (mg/l) [1 part per million (ppm)], for forming clean (electrolytically and chemically) treated water 210′, herein, for brevity, referred to as clean treated water 210′, of the second concentration value contained inside recycle tank 200.

In previous Step (c), during the continuous mixing and reacting of in-situ real time freshly generated hypochlorite ion solution 230 and recycled electrolytically treated cyanide-containing water 210 inside recycle tank 200, as a direct result of decreasing the concentration of cyanide species in recycled electrolytically treated cyanide-containing water 210 of the first concentration value of cyanide species contained inside recycle tank 200, to lower values of cyanide species concentration inside recycle tank 200, there is a corresponding (proportional) decrease in the redox potential thereof inside recycle tank 200. The decrease in cyanide species concentration of recycled electrolytically treated cyanide-containing water 210 inside recycle tank 200 is continuously measured in terms of the corresponding (proportionate) decrease in the redox potential (for example, in units of millivolts) of recycled electrolytically treated cyanide-containing water 210 inside recycle tank 200, via operation of cyanide species concentration measuring loop 274, in general, and via operation of recycle water redox potential measuring mechanism 204, in particular.

As for previous Step (b), Step (d) is performed by utilizing the data and information provided by the hereinabove described empirically determined database [EDDb] of the empirically determined values derived from the empirically determined calibration curve (x-y plot) or table (LUT) of (y-axis, or dependent variable) empirically determined values of redox potential (for example, in units of millivolts) of cyanide-containing water (for example, of recycled electrolytically treated cyanide-containing water 210, or similar type of cyanide-containing water) inside a vessel or tank (for example, inside recycle tank 200, or similar type of tank), as a function of empirically known or/and determined values of cyanide species concentration (for example, in units of milligrams per liter (mg/l) or parts per million (ppm)) of the cyanide-containing water inside the vessel or tank, for cyanide species concentration in a range of, preferably, between about 600 milligrams per liter (mg/l) [600 parts per million (ppm)] and about 0 milligram per liter (mg/l) [0 part per million (ppm)]. Power supply and process control unit 18, in general, and central programming and electronic input/output control signal processing assembly 74, in particular, are configured and operative with the empirically determined database [EDDb], involving storing, retrieving, analyzing, and processing, data and information of the empirically determined database [EDDb].

Accordingly, during Step (d), when cyanide species concentration of (chemically treated) recycled electrolytically treated cyanide-containing water 210 inside recycle tank 200 decreases from the first concentration value of about 10 percent of the initial concentration (of cyanide-containing water 12 (filtered cyanide-containing water 12′) of less than about 500 milligrams per liter (mg/l) [500 parts per million (ppm)]), to a second concentration value of less than 1 milligram per liter (mg/l) [1 part per million (ppm)], for forming clean (electrolytically and chemically) treated water 210′ (clean treated water 210′) of the second concentration value contained inside recycle tank 200, there is a corresponding (proportional) decrease of the redox potential to a corresponding second redox potential value thereof, as measured, and registered, by recycle water redox potential measuring mechanism 204 of cyanide species concentration measuring loop 274.

Accordingly, in a synchronous manner, following recycle water redox potential measuring mechanism 204 measuring, and registering, this corresponding second redox potential value, then, recycle water redox potential measuring mechanism 204, via recycle unit electronic input/output control signal communications line 272, sends a second feedback control signal (FCS-2) to central programming and electronic input/output control signal processing assembly 74 of power supply and process control unit 18.

In a sequentially synchronous manner, following central programming and electronic input/output control signal processing assembly 74 of power supply and process control unit 18, receiving, registering, and processing, the second feedback control signal (FCS-2), along with utilizing the data and information stored in, and retrievable from, the empirically determined database [EDDb], then, central programming and electronic input/output control signal processing assembly 74, via recycle unit electronic input/output control signal communications line 272, sends a {valve-close} process control signal to valve 222 for actuating and closing valve 222, thereby stopping (terminating) the flow of in-situ real time freshly generated hypochlorite ion solution 230 containing hypochlorite ions [ClO⁻] from in-situ hypochlorite ion solution generating electrolytic reactor assembly 202, through valve 222, and into recycle tank 200.

In a synchronous manner, at about the same time, central programming and electronic input/output control signal processing assembly 74, via recycle unit electronic input/output control signal communications line 272, sends a valve-close) process control signal to valve 258 for actuating and closing valve 258, thereby stopping the flow of the freshly prepared aqueous solution of sodium chloride [NaCl] from mixing vessel 250 to in-situ hypochlorite ion solution generating electrolytic reactor assembly 202.

In a synchronous manner, at about the same time, or shortly thereafter, central programming and electronic input/output control signal processing assembly 74, via recycle unit electronic input/output control signal communications line 272, sends a {power-off} process control signal to power supply assembly 217 of in-situ hypochlorite ion solution generating electrolytic reactor assembly 202 for actuating and turning-off the power of power supply assembly 217, thereby (temporarily) stopping supplying power to electrodes of in-situ hypochlorite ion solution generating electrolytic reactor assembly 202, in a manner such that there is (temporarily) de-activating in-situ hypochlorite ion solution generating electrolytic reactor assembly 202, for (temporarily) stopping (terminating) the electrolytic production of in-situ real time freshly generated hypochlorite ion solution 230. This procedure results in significant saving of energy (electricity), and therefore, of cost, for operating in-situ hypochlorite ion solution generating electrolytic reactor assembly 202 during implementation of specific embodiments of the overall integrated cyanide species removal method of the present invention.

The above illustratively described synchronous operation of recycle unit 22, and, power supply and process control unit 18, and components thereof, for performing Step (d) of the integrated cyanide species removal method, using integrated cyanide species removal system 10, results in stopping (terminating) the electrolytic production of in-situ real time freshly generated hypochlorite ion solution 230 containing hypochlorite ions [ClO⁻] by in-situ hypochlorite ion solution generating electrolytic reactor assembly 202, and stopping (terminating) the flow thereof into recycle tank 200. This, therefore, results in stopping (terminating) chemically treating recycled electrolytically treated cyanide-containing water 210 of the first concentration value of cyanide species contained inside recycle tank 200. By completing Step (d), there is forming clean (electrolytically and chemically) treated water 210′ (clean treated water 210′) of the second concentration value contained inside recycle tank 200 of recycle unit 22.

Clean treated water 210′ of the second concentration value contained inside recycle tank 200 of recycle unit 22, has a cyanide [CN] concentration, of less than 1 milligram per liter (mg/l) [1 part per million (ppm)], and even, for example, as low as about 0.1 milligram per liter (mg/l) [0.1 part per million (ppm)]. This latter cyanide [CN] concentration corresponds to more than a three order magnitude reduction of a typical concentration of cyanide [CN] species in cyanide-containing water 12 supplied by external source 24 of, for example, any of various different types of industrial processes, wherein initial cyanide species concentration is on the order of about 500 milligrams per liter (mg/l) [500 parts per million (ppm)].

Duration (Interval or Period) of Time Required for (Chemically) Further Decreasing Cyanide Species Concentration from the First Concentration Value to the Second Concentration Value: Duration (Interval or Period) of Time Required for Performing the Chemical Treatment (Steps (b)-(d))

As stated hereinabove, and explained in further detail in the section preceding the hereinbelow Examples section, for characterizing some embodiments of the integrated cyanide removal method of the present invention, in general, and for characterizing the performing of Steps (b)-(d), in particular, herein, there is defined and used the critically important processing time parameter of: the ‘cyanide species concentration reduction processing time’ (also referred to as the ‘electrolytic and chemical treatment total processing time’). The ‘cyanide species concentration reduction processing time’ (the ‘electrolytic and chemical treatment total processing time’) refers to the total duration (interval or period) of time required to decrease the cyanide species concentration from the initial cyanide species concentration (i.e., of less than about 500 milligrams per liter (mg/l) [500 parts per million (ppm)]) in cyanide-containing water 12 to the second concentration value (i.e., of less than 1 milligram per liter (mg/l) [1 part per million (ppm)]) of clean (electrolytically and chemically) treated water 210′ (clean treated water 210′) contained inside recycle tank 200 of recycle unit 22.

More specifically, with respect to implementing some embodiments of the integrated cyanide removal method of the present invention, the ‘cyanide species concentration reduction processing time’ refers to the total duration (interval or period) of time spanning from the time of starting the procedure in Step (a) of initiating and directing electrolytic reactor unit feed solution 15 to flow from water holding and mixing vessel 110 and into reactor housing bottom section 42b of reactor housing assembly 42 of electrolytic reactor unit 16, through the time of completing the procedure in Step (d) of forming clean (electrolytically and chemically) treated water 210′ (clean treated water 210′) of the second concentration value contained inside recycle tank 200 of recycle unit 22. Since the integrated cyanide removal method of the present invention is based on integration of an electrolytic treatment and a chemical treatment of cyanide-containing water 12, therefore, the ‘cyanide species concentration reduction processing time’ corresponds to an ‘electrolytic and chemical treatment total processing time’.

Additionally, by analyzing the ‘cyanide species concentration reduction processing time’ data of the hereinbelow provided Examples, the inventors made the following critically important observation. When implementing some embodiments of the integrated cyanide removal method of the present invention, the step of chemically treating recycled electrolytically treated cyanide-containing water 210 requires, and is therefore performed for, a ‘duration of time’ in a range of between about 5-17%, and even for ‘as low as’ in a range of between about 4.5-6.3%, of the ‘total duration of time’ required to decrease the cyanide species concentration from the initial cyanide species concentration to the second concentration value of clean treated water 210′ contained inside recycle tank 200. More specifically, the duration (interval or period) of time required for (chemically) further decreasing the cyanide species concentration inside recycle tank 200 from the first concentration value {i.e., of about 10 percent of the initial concentration (of cyanide-containing water 12 of less than about 500 milligrams per liter (mg/l) [500 parts per million (ppm)])}, corresponding to the point of time between completion of Step (b) and initiation of Step (c), to the (final, clean treated water 210′) second concentration value {i.e., of less than 1 milligram per liter (mg/l) [1 part per million (ppm)}, corresponding to the point of time at completion of Step (d), unexpectedly accounted for in a range of between about 5-17%, and even for ‘as low as’ in a range of between about 4.5-6.3%, of the ‘cyanide species concentration reduction processing time’ (i.e., the ‘electrolytic and chemical treatment total processing time’).

Outputting the Clean Treated Water from the Recycle Tank to the Output Unit

In Step (e) (block 9, FIG. 1), there is outputting the clean treated water of the second concentration value from the recycle tank to the output unit. Accordingly, with reference to FIG. 2, in Step (e), there is outputting clean treated water 210′ of the second concentration value from recycle tank 200 of recycle unit 22 to output unit 20.

In integrated cyanide species removal system 10, output unit 20 is configured for being operatively connected to electrolytic reactor unit 16, recycle unit 22, and, power supply and process control unit 18. Output unit 20 functions for (1) receiving, transferring, and removing, a mixture of electrolytic reaction product gases or/and vapors exiting from reactor housing third outlet assembly 58 of electrolytic reactor unit 16, in accordance with performing hereinabove illustratively described previous Step (a) of electrolytically treating a batch amount of cyanide-containing water 12, for forming electrolytically treated cyanide-containing water 17, and also functions for (2) receiving, holding or containing, monitoring (measuring) and controlling, and transferring, clean treated water 210′ exiting from recycle tank 200 of recycle unit 22, in accordance with Step (e).

For performing the function of (1), for receiving, transferring, and removing, gases or/and vapors exiting electrolytic reactor unit 16, output unit 20 includes as a main component, a gas/vapor removing device 90. As illustratively described hereinabove for performing Step (a), electrolytic reaction product gases or/and vapors (for example, carbon dioxide [CO₂], nitrogen [N₂], hydrogen [H₂], or/and water [H₂O]) exit reactor housing top section 42a of reactor housing assembly 42 of electrolytic reactor unit 16, via reactor housing third outlet assembly 58, and enter gas/vapor removing device 90, of output unit 20, via inlet assembly 98. Gas/vapor removing device 90, such as a gas/vapor type of a scrubber, processes and converts the mixture of electrolytic reaction product gases or/and vapors into a non-hazardous gas/vapor mixture, which exits gas/vapor removing device 90 through outlet assembly 100, for example, to the atmosphere, or/and to a gas/vapor collection vessel, or/and to an inlet assembly of another process.

Outputting and Transferring the Clean Treated Water from the Recycle Tank of the Recycle Unit to a Water Holding Vessel of the Output Unit

In Step (e), for performing the function of (2), for receiving, holding or containing, monitoring (measuring) and controlling, and transferring, clean treated water 210′ of the second concentration value exiting from recycle tank 200 of recycle unit 22, output unit 20 includes the main components of: (i) an output unit water holding vessel 86, (ii) an automatic water (volumetric or mass) output level monitoring (measuring) and controlling mechanism 88, (iii) a water flow rate measuring mechanism 82, (iv) valves 238 and 84, and (v) water pumps 240 and 80. Each main component of output unit 20 is configured for being operatively connected to power supply and process control unit 18, via output unit electronic input/output control signal communications line 104.

Output unit water holding vessel 86 is configured and functions for holding or containing a (volumetric or mass) batch amount of clean treated water 210′ of the second concentration value which is supplied and output from recycle tank 200 of recycle unit 22 and fed into output unit 20. Output unit water holding vessel 86 includes inlet assembly 94 for receiving clean treated water 210′ of the second concentration value flowing from recycle tank 200, and an outlet assembly 96 through which clean treated water 210′ of the second concentration value exits output unit water holding vessel 86, and enters an external sink 92, such as a storage tank or vessel, configured, for example, for receiving and storing clean treated water 210′ for future use.

In a synchronous manner, shortly following completion of previous Step (d) for forming clean (electrolytically and chemically) treated water 210′ of the second concentration value contained inside recycle tank 200 of recycle unit 22, herein, in Step (e), central programming and electronic input/output control signal processing assembly 74 of power supply and process control unit 18, via output unit electronic input/output control signal communications line 104, sends a {valve-open} process control signal to valve 238 for actuating and opening valve 238, and simultaneously sends a {pump-on} process control signal to water pump 240 for actuating and turning-on water pump 240, thereby initiating and directing a pre-determined (volumetric or mass) amount of clean treated water 210′ of the second concentration value to flow from recycle tank 200 of recycle unit 22, via outlet assembly 242, either through, or bypassing around, recycle water redox potential measuring mechanism 204, through water pump 240, then, through valve 238, and into output unit water holding vessel 86, via inlet assembly 94.

Clean treated water 210′ of the second concentration value exits recycle tank 200 and enters output unit water holding vessel 86 until the instantaneous level of clean treated water 210′ of the second concentration value contained inside recycle tank 200 decreases to (i.e., equals) a pre-determined minimum level, corresponding to the instantaneous (volumetric or mass) amount of clean treated water 210′ of the second concentration value contained inside recycle tank 200 decreasing to (i.e., equaling) a pre-determined minimum amount. In a similar manner as for filling up of recycle tank 200 during performance of hereinabove illustratively described previous Step (a), herein, in Step (e), during emptying of recycle tank 200, the instantaneous level, and therefore, the instantaneous (volumetric or mass) amount, of clean treated water 210′ of the second concentration value contained inside recycle tank 200 is monitored (measured) and controlled by operation of automatic water (volumetric or mass) level monitoring (measuring) and controlling mechanism 212 which is operatively connected to power supply and process control unit 18, via recycle unit electronic input/output control signal communications line 272.

When the instantaneous level of clean treated water 210′ of the second concentration value decreases to (i.e., equals) the pre-determined minimum level inside recycle tank 200, automatic water output level monitoring (measuring) and controlling mechanism 212 measures and registers this event of emptying recycle tank 200 of clean treated water 210′. In a sequentially synchronous manner, following automatic water output level monitoring (measuring) and controlling mechanism 212 measuring, and registering, this event, then, automatic water output level monitoring (measuring) and controlling mechanism 212, via recycle unit electronic input/output control signal communications line 272, sends a feedback control signal (FCS-3) to central programming and electronic input/output control signal processing assembly 74 of power supply and process control unit 18.

In a sequentially synchronous manner, following central programming and electronic input/output control signal processing assembly 74 receiving, registering, and processing, the feedback control signal (FCS-3), then, central programming and electronic input/output control signal processing assembly 74, via output unit electronic input/output control signal communications line 104, sends a {valve-close} process control signal to valve 238 for actuating and closing valve 238, and simultaneously sends a {pump-off} process control signal to water pump 240 for actuating and turning-off water pump 240, thereby stopping the flow of clean treated water 210′ of the second concentration value from recycle tank 200 into output unit water holding vessel 86.

Additionally, in a sequentially synchronous manner, following central programming and electronic input/output control signal processing assembly 74 receiving, registering, and processing, the feedback control signal (FCS-3), then, central programming and electronic input/output control signal processing assembly 74, via recycle unit electronic input/output control signal communications line 272, sends a {pump-off} process control signal to water pump 226 for actuating and turning-off water pump 226, and simultaneously sends a {valve-close} process control signal to valve 224 for actuating and closing valve 224, and simultaneously sends a {power-off} process control signal to recycle water redox potential measuring mechanism 204 for actuating and turning-off recycle water redox potential measuring mechanism 204. This synchronous operation stops directing the remaining clean treated water 210′ of the second concentration value contained inside recycle tank 200 from exiting and flowing from recycle tank 200, via outlet assembly 242, through recycle water redox potential measuring mechanism 204, through water pump 226, then, through valve 224, and back into recycle tank 200, via inlet assembly 236.

Outputting and Transferring the Clean Treated Water from the Water Holding Vessel of the Output Unit to an External Sink

In a synchronous manner, at about the same time, or shortly thereafter, when the instantaneous level of clean treated water 210′ of the second concentration value decreases to (i.e., equals) the pre-determined minimum level inside recycle tank 200, corresponding to emptying of recycle tank 200 and filling up of output unit water holding vessel 86 with clean treated water 210′ of the second concentration value, central programming and electronic input/output control signal processing assembly 74, via output unit electronic input/output control signal communications line 104, sends a {valve-open} process control signal to valve 84 for actuating and opening valve 84, and simultaneously sends a {pump-on} process control signal to water pump 80 for actuating and turning-on water pump 80, thereby initiating and directing a pre-determined (volumetric or mass) amount of clean treated water 210′ of the second concentration value to flow from output unit water holding vessel 86, via outlet assembly 96, through valve 84, through water flow rate measuring mechanism 82, then through water pump 80, and into external sink 92, such as a storage tank or vessel, configured, for example, for receiving and storing clean treated water 210′ for future use.

Clean treated water 210′ of the second concentration value exits output unit water holding vessel 86 and enters external sink 92 until the instantaneous level of clean treated water 210′ of the second concentration value contained inside output unit water holding vessel 86 decreases to (i.e., equals) a pre-determined minimum level, corresponding to the instantaneous (volumetric or mass) amount of clean treated water 210′ of the second concentration value contained inside output unit water holding vessel 86 decreasing to (i.e., equaling) a pre-determined minimum amount. As for the filling up of output unit water holding vessel 86, during emptying of output unit water holding vessel 86, the instantaneous level, and therefore, the instantaneous (volumetric or mass) amount, of clean treated water 210′ of the second concentration value contained inside of output unit water holding vessel 86 is monitored (measured) and controlled by operation of an automatic water (volumetric or mass) level monitoring (measuring) and controlling mechanism 88 which is operatively connected to power supply and process control unit 18, via output unit electronic input/output control signal communications line 104. Automatic water output level monitoring (measuring) and controlling mechanism 88 is preferably located inside of output unit water holding vessel 86, as shown in FIG. 2. The (volumetric or mass) flow rate of clean treated water 210′ of the second concentration value which exits output unit water holding vessel 86 and enters external sink 92, is controlled by valve 84, and is measured by water flow rate measuring mechanism 82, for example, a flow meter configured and operable for measuring flow rates of a liquid, particularly, water, such as clean treated water 210′.

When the instantaneous level of clean treated water 210′ of the second concentration value decreases to (i.e., equals) the pre-determined minimum level inside output unit water holding vessel 86, automatic water output level monitoring (measuring) and controlling mechanism 88 measures and registers this event of emptying output unit water holding vessel 86 of clean treated water 210′ of the second concentration value. In a sequentially synchronous manner, following automatic water output level monitoring (measuring) and controlling mechanism 88 measuring, and registering, this event, then, automatic water output level monitoring (measuring) and controlling mechanism 88, via output unit electronic input/output control signal communications line 104, sends a feedback control signal (FCS-4) to central programming and electronic input/output control signal processing assembly 74 of power supply and process control unit 18.

In a sequentially synchronous manner, following central programming and electronic input/output control signal processing assembly 74 receiving, registering, and processing, the feedback control signal (FCS-4), then, central programming and electronic input/output control signal processing assembly 74, via output unit electronic input/output control signal communications line 104, sends a {valve-close} process control signal to valve 84 for actuating and closing valve 84, and simultaneously sends a {pump-off} process control signal to water pump 80 for actuating and turning-off water pump 80, thereby stopping the flow of clean treated water 210′ of the second concentration value from output unit water holding vessel 86 into external sink 92. This procedure corresponds to emptying of output unit water holding vessel 86 and filling up of external sink 92 with clean treated water 210′ of the second concentration value.

The above illustratively described synchronous operation of recycle unit 22, output unit 20, and, power supply and process control unit 18, and components thereof, for performing Step (e) of the integrated cyanide species removal method, using integrated cyanide species removal system 10, results in outputting and transferring a pre-determined (volumetric or mass) amount of the batch of clean (electrolytically and chemically) treated water 210′ of the second concentration value contained inside recycle tank 200 of recycle unit 22, from recycle tank 200 of recycle unit 22 to an external sink 92, for example, for storage until future need for using clean treated water 210′.

Performing Step (e) involves only outputting and transferring an amount of the batch of clean treated water 210′ of the second concentration value contained inside recycle tank 200 of recycle unit 22, from recycle tank 200 of recycle unit 22 to external sink 92, whereby the physicochemical properties and characteristics, particularly, cyanide species concentration, are not affected or changed. Therefore, clean treated water 210′ of the second concentration value which is output and transferred to, and received by, external sink 92, maintains the attained extremely low second concentration value of cyanide species, i.e., less than 1 milligram per liter (mg/l) [1 part per million (ppm)], and even as low as about 0.1 milligram per liter (mg/l) [0.1 part per million (ppm)]. Thus, clean treated water 210′ of the second concentration value contained inside external sink 92 is readily usable in any of a wide variety of numerous different industrial or commercial applications which require ‘clean water’ having an extremely low cyanide species concentration of less than 1 milligram per liter (mg/l) [1 part per million (ppm)], and even as low as about 0.1 milligram per liter (mg/l) [0.1 part per million (ppm)].

### Additional Structure, Function, Operation of Integrated Cyanide Species Removal System Units and Components Thereof

Additional details regarding structure, function, and operation, of each of the units, namely, input unit 14, electrolytic reactor unit 16, recycle unit 22, output unit 20, and, power supply and process control unit 18, and components of each unit thereof, of integrated cyanide species removal system 10 shown in FIG. 2, which are relevant to implementing the hereinabove illustratively described specific embodiments of the integrated electrolytic and chemical method for electrolytically and chemically removing cyanide species from cyanide-containing water, for producing clean treated water wherein cyanide species concentration is less than 1 milligram per liter (mg/l) [1 part per million (ppm)], of the present invention, are provided in the following.

### Input Unit, and Components Thereof

Input unit 14 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling input unit 14 and components thereof to receive, filter, hold or contain, monitor (measure) and control, and transfer, a (volumetric or mass) batch amount of water, such as cyanide-containing water 12, which is supplied from external source 24.

Automatic electronic monitoring (measuring) and controlling of operating parameters and conditions of input unit 14 and components thereof, are enabled by power supply and process control unit 18 and components thereof. Electronic input/output, feedforward and feedback transmission and reception of electronic control data, information, and command, communication signals between input unit 14 and components thereof, and, power supply and process control unit 18 and components thereof, are provided by an electronic input/output control data, information, and command, communications line, such as a cable or bundle of wires, or/and a wireless communications line, herein, generally indicated in FIG. 2 as input unit electronic input/output control signal communications line 39.

Input unit 14 includes any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of input unit 14 and components thereof, by power supply and process control unit 18 and components thereof.

Input unit 14 and components thereof are configured with, constructed of, and operate with, standard mechanical, hydraulic, electrical, electronic, electro-mechanical, and (wired or/and wireless) communications, mechanisms, assemblies, structures, components, elements, and materials, known in the art of automatically receiving, filtering, holding or containing, monitoring (measuring) and controlling, and transferring, a (volumetric or mass) batch amount of water, such as cyanide-containing water 12, which is supplied from external source 24.

Input unit 14 and components thereof are preferably of configurations and constructions which are compatible with, and operated in accordance with, the physicochemical properties, parameters, and characteristics, of the particular cyanide specie(s), and of various other chemical species, of cyanide-containing water 12, and of recycled electrolytically treated cyanide-containing water 210 (of recycle unit 22) flowing into input unit 14, as well as with the physicochemical properties, parameters, characteristics, and operating conditions, of external source 24 which supplies cyanide-containing water 12 to input unit 14, as well as with the physicochemical properties, parameters, characteristics, and operating conditions, of the other units, in particular, electrolytic reactor unit 16, recycle unit 22, output unit 20, and, power supply and process control unit 18, of integrated cyanide species removal system 10, which together are configured and synchronously operated for electrolytically and chemically removing cyanide species from cyanide-containing water 12, for producing clean treated water 210′ wherein cyanide species concentration is less than 1 milligram per liter.

### Electrolytic Reactor Unit, and Components Thereof

Electrolytic reactor unit 16 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling electrolytic reactor unit 16 and components thereof to electrolytically decrease the concentration of cyanide species in cyanide-containing water 12, for forming electrolytically treated cyanide-containing water 17 exiting electrolytic reactor unit 16.

Automatic electronic monitoring (measuring) and controlling of operating parameters and conditions of electrolytic reactor unit 16 and components thereof, are enabled by power supply and process control unit 18 and components thereof.

Electronic input/output, feedforward and feedback transmission and reception of electronic control data, information, and command, communication signals between electrolytic reactor unit 16 and components thereof, and, power supply and process control unit 18 and components thereof, are provided by an electronic input/output control data, information, and command, communications line, such as a cable or bundle of wires, or/and a wireless communications line, herein, generally indicated in FIG. 2 as input unit electronic input/output control signal communications line 60.

Electrolytic reactor unit 16 and components thereof include any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of electrolytic reactor unit 16 and components thereof, by power supply and process control unit 18 and components thereof.

Electrolytic reactor unit 16 and components thereof are preferably of configurations and constructions which are compatible with, and operated in accordance with, the physicochemical properties, parameters, and characteristics, of the particular cyanide specie(s), and of various other chemical species, of electrolytic reactor unit feed solution 15 [including filtered cyanide-containing water 12′, possible second portion (overflow) 17b of electrolytically treated cyanide-containing water 17, and recycled electrolytically treated cyanide-containing water 210 (of recycle unit 22)] flowing into electrolytic reactor unit 16, and of first portion 17a of electrolytically treated cyanide-containing water 17 and electrolytic reaction product gases or/and vapors exiting electrolytic reactor unit 16, as well as with the physicochemical properties, parameters, characteristics, and operating conditions, of the other units, in particular, input unit 14, recycle unit 22, output unit 20, and, power supply and process control unit 18, of integrated cyanide species removal system 10, which together are configured and synchronously operated for electrolytically and chemically removing cyanide species from cyanide-containing water 12, for producing clean treated water 210′ wherein cyanide species concentration is less than 1 milligram per liter.

### Recycle Unit, and Components Thereof

Recycle unit 22 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling recycle unit 22 and components thereof to: (1) receive first portion 17a of electrolytically treated cyanide-containing water 17 which exits electrolytic reactor unit 16 and enters recycle tank 200 of recycle unit 22; (2) subject first portion 17a of electrolytically treated cyanide-containing water 17 to additional cycles (i.e., recycling) of the electrolytic treatment via electrolytic reactor unit 16, for forming recycled electrolytically treated cyanide-containing water 210 inside recycle tank 200; (3) subject recycled electrolytically treated cyanide-containing water 210 inside recycle tank 200 to chemical treatment with in-situ real time freshly generated hypochlorite ion solution electrolytically produced by in-situ hypochlorite ion solution generating electrolytic reactor assembly 202 configured in-line with recycle tank 200 of recycle unit 22, for forming clean (electrolytically and chemically) treated water inside recycle tank 200; and (4) output the clean treated water from recycle tank 200 to output unit 20.

Automatic electronic monitoring (measuring) and controlling of operating parameters and conditions of recycle unit 22 and components thereof, are enabled by power supply and process control unit 18 and components thereof. Electronic input/output, feedforward and feedback transmission and reception of electronic control data, information, and command, communication signals between recycle unit 22 and components thereof, and, power supply and process control unit 18 and components thereof, are provided by an electronic input/output control data, information, and command, communications line, such as a cable or bundle of wires, or/and a wireless communications line, herein, generally indicated in FIG. 2 as recycle unit electronic input/output control signal communications line 272.

Recycle unit 22 and components thereof include any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of recycle unit 22 and components thereof, by power supply and process control unit 18 and components thereof.

Recycle unit 22 and components thereof are preferably of configurations and constructions which are compatible with, and operated in accordance with, the physicochemical properties, parameters, and characteristics, of the particular cyanide specie(s), and of various other chemical species, of electrolytically treated cyanide-containing water 17 flowing into recycle unit 22, hypochlorite ion solution electrolytically produced by in-situ hypochlorite ion solution generating electrolytic reactor assembly 202 configured in-line with recycle tank 200 of recycle unit 22, and of clean (electrolytically and chemically) treated water inside recycle tank 200 which is output from recycle tank 200 to output unit 20, as well as with the physicochemical properties, parameters, characteristics, and operating conditions, of the other units, in particular, input unit 14, electrolytic reactor unit 16, output unit 20, and, power supply and process control unit 18, of integrated cyanide species removal system 10, which together are configured and synchronously operated for electrolytically and chemically removing cyanide species from cyanide-containing water 12, for producing clean treated water 210′ wherein cyanide species concentration is less than 1 milligram per liter.

### Output Unit, and Components Thereof

Output unit 20 and components thereof include any additional necessary fluid transfer equipment (the main ones of which are illustratively described hereinabove), such as pipes, tubes, connecting elements, adaptors, fittings, screws, nuts, bolts, washers, o-rings, water pumps, valves, vents, and switches, as well as mechanisms, assemblies, components, and elements thereof, which are made of suitable materials, for fully enabling output unit 20 and components thereof to receive, hold or contain, monitor (measure) and control, and transfer, clean treated water 210′ exiting from recycle tank 200 of recycle unit 22, and, to receive, transfer, and remove, a mixture of electrolytic reaction product gases or/and vapors exiting from reactor housing third outlet assembly 58 of electrolytic reactor unit 16.

Automatic electronic monitoring (measuring) and controlling of operating parameters and conditions of output unit 20 and components thereof, are enabled by power supply and process control unit 18 and components thereof. Electronic input/output, feedforward and feedback transmission and reception of electronic control data, information, and command, communication signals between output unit 20 and components thereof, and, power supply and process control unit 18 and components thereof, are provided by an electronic input/output control data, information, and command, communications line, such as a cable or bundle of wires, or/and a wireless communications line, herein, generally indicated in FIG. 2 as output unit electronic input/output control signal communications line 104.

Output unit 20 and components thereof include any additional necessary mechanical, hydraulic, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of output unit 20 and components thereof, by power supply and process control unit 18 and components thereof.

Output unit 20 and components thereof are configured with, constructed of, and operate with, standard mechanical, hydraulic, electrical, electronic, electro-mechanical, and (wired or/and wireless) communications, mechanisms, assemblies, structures, components, elements, and materials, known in the art of automatically receiving, holding or containing, monitoring (measuring) and controlling, and transferring, a (volumetric or mass) batch amount of water, such as clean treated water 210′ exiting from recycle tank 200 of recycle unit 22, and, known in the art of automatically receiving, holding or containing, monitoring (measuring) and controlling, and transferring, a mixture of electrolytic reaction product gases or/and vapors exiting from an electrolytic reactor unit, such as those exiting from reactor housing third outlet assembly 58 of electrolytic reactor unit 16.

Output unit 20 and components thereof are preferably of configurations and constructions which are compatible with, and operated in accordance with, the physicochemical properties, parameters, and characteristics, of the particular cyanide specie(s), and of various other chemical species, of clean (electrolytically and chemically) treated water 210′ exiting from recycle tank 200 of recycle unit 22, and of the mixture of electrolytic reaction product gases or/and vapors exiting from reactor housing third outlet assembly 58 of electrolytic reactor unit 16, as well as with the physicochemical properties, parameters, characteristics, and operating conditions, of the other units, in particular, input unit 14, electrolytic reactor unit 16, recycle unit 22, and, power supply and process control unit 18, of integrated cyanide species removal system 10, which together are configured and synchronously operated for electrolytically and chemically removing cyanide species from cyanide-containing water 12, for producing clean treated water 210′ wherein cyanide species concentration is less than 1 milligram per liter.

### Power Supply and Process Control Unit, and Components Thereof

Power supply and process control unit 18 is configured for being operatively connected to each of the other units, namely, input unit 14, electrolytic reactor unit 16, recycle unit 22, and output unit 20, of integrated cyanide species removal system 10. Power supply and process control unit 18 functions for supplying and controlling electrical power to, and for monitoring and controlling process operating parameters and conditions of, each unit of integrated cyanide species removal system 10. Power supply and process control unit 18 includes the main components of: a power supply assembly 72, a power supply monitoring (measuring) and controlling mechanism 70, and, a central programming and electronic input/output control signal processing assembly 74.

Power supply assembly 72 includes, for example, a multi-functional, multi-operational type of power supply, for supplying power according to any of various different types of spatial or/and temporal power configurations, modes, formats, schemes, and schedules, involving synchronous supply of power in the form of dc or/and ac voltage or/and current, to each unit, and components thereof, of integrated cyanide species removal system 10.

Power supply monitoring (measuring) and controlling mechanism 70 is for automatically monitoring (measuring) and controlling power supply assembly 72, and therefore, is for automatically monitoring (measuring) and controlling power supplied to each unit of integrated cyanide species removal system 10, according to any of various different types of spatial or/and temporal power configurations, modes, formats, schemes, and schedules, involving synchronous supply of power in the form of dc or/and ac voltage or/and current.

Central programming and electronic input/output control signal processing assembly 74 is configured, for example, as one or more computers which are part of a centralized computer work station. Central programming and electronic input/output control signal processing assembly 74 functions for: (1) centrally housing computerized software programs which are used for operating and controlling all computerized functions of integrated cyanide species removal system 10 and units thereof, according to any of various different types of spatial or/and temporal configurations, modes, formats, schemes, and schedules, and (2) centrally housing a computerized processing assembly which processes and manages all of the electronic input/output, feedforward and feedback transmission and reception of electronic control data, information, and command, communication signals between power supply and process control unit 18 and components thereof, and, each of the units and components thereof of integrated cyanide species removal system 10.

Power supply and process control unit 18, and components thereof, are electronically linked or connected to electronically operable components of each of the other units, namely, input unit 14, electrolytic reactor unit 16, recycle unit 22, and output unit 20, of integrated cyanide species removal system 10, via input unit electronic input/output control signal communications lines, such as cables or bundles of wires, or/and, a wireless network of wireless communications lines, generally indicated in FIG. 2 as input unit, electrolytic reactor unit, recycle unit, and output unit, electronic input/output control signal communications lines 39, 60, 272, and 104, respectively. Such wired or/and wireless electronic linkages or connections enable electronic feedforward and feedback transmission and reception of electronic data, information, and command, communication signals between the electronically operable components of each unit of integrated cyanide species removal system 10, with power supply and process control unit 18 and components thereof. This, in turn, enables automatic electronic monitoring (measuring) and controlling of operating parameters and conditions of each unit of integrated cyanide species removal system 10, by power supply and process control unit 18 and components thereof.

For example, regarding operation of electrolytic reactor unit 16, as shown in FIG. 2, electrolytic reactor unit 16, in general, and electrode set 40 and electrodes thereof, in particular, are configured for being operatively connected to power supply and process control unit 18, via electrolytic reactor unit electronic input/output control signal communications line 60. In electrode set 40 of electrolytic reactor unit 16, the top end portion of each metal cathode (cj) and of each graphite or metal anode (ai) are each electrically connected, for example, via respective negative (−) and positive (+) electrical leads 62, to power supply assembly 72 of power supply and process control unit 18. During operation of electrolytic reactor unit 16, a controllable constant direct current (dc) provided to electrode set 40 and electrodes thereof, is supplied, monitored (measured), and controlled, via power supply assembly 72, power supply monitoring (measuring) and controlling mechanism 70, and central programming and electronic input/output control signal processing assembly 74, of power supply and process control unit 18.

Power supply and process control unit 18 and components thereof include any additional necessary mechanical, electrical, electronic, electro-mechanical, or/and (wired or/and wireless) communications, equipment, as well as mechanisms, assemblies, components, and elements thereof, which are made of suitable materials, for fully enabling the automatic electronic monitoring (measuring) and controlling of operating parameters and conditions of the electronically operable components of each of the other units, namely, input unit 14, electrolytic reactor unit 16, recycle unit 22, and output unit 20, of integrated cyanide species removal system 10, by power supply and process control unit 18 and components thereof.

Power supply and process control unit 18 and components thereof are configured with, constructed of, and operate with, standard mechanical, electrical, electronic, electro-mechanical, and (wired or/and wireless) communications, mechanisms, assemblies, structures, components, elements, and materials, known in the art of automatically supplying, monitoring (measuring), and controlling, electrical power to electronically operable components, and known in the art of automatically monitoring (measuring) and controlling operating parameters and conditions of electronically operable components, such as electronically operable valves, water pumps, automatic water (volumetric or mass) input level monitoring (measuring) and controlling mechanisms, electrodes, redox potential measuring mechanisms, power supply assemblies, power supply monitoring (measuring) and controlling mechanisms, central programming and electronic input/output control signal processing assemblies, which are included in the various units of integrated cyanide species removal system 10.

### Electrolytically and Chemically Treating the Next (New) Batch, and Additional (New) Batches, of Cyanide-Containing Water

Commercial scale industrial processes, such as mining, metal electroplating, chemical, petrochemical, metallurgical, and paper milling, processes, typically require electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1 cubic meter per hour (m³/hr)]). Thus, in such applications, there is typically need for implementing the integrated electrolytic and chemical method for electrolytically and chemically removing cyanide species from the next (i.e., new) batch, and typically from a plurality of additional (i.e., new) batches, of cyanide-containing water 12, for producing the next (new) batch, and each additional (new) batch, of clean treated water 210′ wherein cyanide species concentration is less than 1 milligram per liter (mg/l) [1 part per million (ppm)].

For electrolytically and chemically treating the next (i.e., new) batch, and each additional (new) batch, of cyanide-containing water 12, there is sequentially and synchronously repeating implementation of the hereinabove illustratively described main Steps (a), (b), (c), (d), and (e), shown in blocks (frames) 2, 4, 6, 8, and 9, respectively, in FIG. 1, and various sub-steps thereof, of specific embodiments of the integrated cyanide species removal method, using integrated cyanide species removal system 10.

Accordingly, for implementing some embodiments of the integrated electrolytic and chemical method for electrolytically and chemically removing cyanide species from the next (i.e., new) batch of cyanide-containing water 12, for producing the next (new) batch of clean treated water 210′ wherein cyanide species concentration is less than 1 milligram per liter (mg/l) [1 part per million (ppm)], there is performing the following main steps or procedures: (a) electrolytically treating the next (i.e., new) batch amount of cyanide-containing water 12 wherein initial cyanide species concentration is less than about 500 milligrams per liter, via synchronized operation of input unit 14, electrolytic reactor unit 16, recycle unit 22, output unit 20, and, power supply and process control unit 18, for forming the next (new) batch of recycled electrolytically treated cyanide-containing water 210; (b) stopping the electrolytic treatment when cyanide species concentration of the next (new) batch of recycled electrolytically treated cyanide-containing water 210 decreases to a first concentration value of about 10 percent of the initial concentration, for forming the next (new) batch of recycled electrolytically treated cyanide-containing water 210 of the first concentration value contained inside recycle tank 200 of recycle unit 22; (c) chemically treating the next (new) batch of recycled electrolytically treated cyanide-containing water 210 of the first concentration value inside recycle tank 200 with in-situ real time freshly generated hypochlorite ion solution 230 electrolytically produced by in-situ hypochlorite ion solution generating electrolytic reactor assembly 202 configured in-line with recycle tank 200; (d) stopping the chemical treatment when cyanide species concentration inside recycle tank 200 decreases to a second concentration value of less than 1 milligram per liter, for forming the next (new) batch of clean treated water 210′ of the second concentration value contained inside recycle tank 200; and (e) outputting the next (new) batch of clean treated water 210′ of the second concentration value from recycle tank 200 to output unit 20.

As for the previous (i.e., first, or other previous) batch, the next (i.e., new) produced batch of clean treated water 210′ of the second concentration value contained inside external sink 92 is readily usable in any of a wide variety of numerous different industrial or commercial applications which require ‘clean water’ having an extremely low cyanide species concentration of less than 1 milligram per liter (mg/l) [1 part per million (ppm)], and even as low as about 0.1 milligram per liter (mg/l) [0.1 part per million (ppm)].

### Processing Time Parameters Relevant to Implementing the Integrated Cyanide Species Removal Method

In the context of the field and art of the present invention, processing time constraints, and therefore, processing time parameters, are critically important during operation of essentially any commercial scale industrial process, such as a mining, metal electroplating, chemical, petrochemical, metallurgical, or paper milling, process, wherein there is need for decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1 cubic meter per hour (m³/hr)]). Accordingly, actual processing time constraints, and therefore, processing time parameters, must be measured and analyzed in order to determine whether or not a given cyanide species removal process is commercially applicable, practical, and economically feasible to implement.

### Cyanide Species Concentration Reduction Processing Time (‘Electrolytic and Chemical Treatment Total Processing Time’)

For understanding implementation of specific embodiments of the present invention, and in the context of the field and art of the present invention, a critically important processing time parameter is the ‘cyanide species concentration reduction processing time’. As stated hereinabove, the phrase ‘cyanide species concentration reduction processing time’, as used herein, refers to the total duration (interval or period) of time required to decrease the cyanide species concentration from the initial cyanide species concentration (i.e., of less than about 500 milligrams per liter (mg/l) [500 parts per million (ppm)]) in cyanide-containing water 12 to the second concentration value (i.e., of less than 1 milligram per liter (mg/l) [1 part per million (ppm)]) of clean (electrolytically and chemically) treated water 210′ (clean treated water 210′) contained inside recycle tank 200 of recycle unit 22.

More specifically, with respect to implementing specific embodiments of the integrated cyanide removal method of the present invention, the ‘cyanide species concentration reduction processing time’ refers to the total duration (interval or period) of time spanning from the time of starting the procedure in Step (a) of initiating and directing electrolytic reactor unit feed solution 15 to flow from water holding and mixing vessel 110 and into reactor housing bottom section 42b of reactor housing assembly 42 of electrolytic reactor unit 16, through the time of completing the procedure in Step (d) of forming clean (electrolytically and chemically) treated water 210′ (clean treated water 210′) of the second concentration value contained inside recycle tank 200 of recycle unit 22. Since the integrated cyanide removal method of the present invention is based on integration of an electrolytic treatment and a chemical treatment of cyanide-containing water 12, therefore, the ‘cyanide species concentration reduction processing time’ corresponds to an ‘electrolytic and chemical treatment total processing time’.

The time parameter ‘cyanide species concentration reduction processing time’ is especially useful when comparing implementation of the integrated cyanide removal method of the present invention to either a first case of implementation of a cyanide removal method based on similar electrolytic only treatment (i.e., without chemical treatment [via Steps (b)-(d) of the method of the present invention]) of cyanide-containing water 12, or, to a second case of implementation of a cyanide removal method based on similar chemical only treatment (i.e., without electrolytic treatment [via Steps (a)-(b) of the method of the present invention]) of cyanide-containing water 12. In such first and second cases, the ‘cyanide species concentration reduction processing time’ corresponds to either an ‘electrolytic only treatment total processing time’, or, to a ‘chemical only treatment processing time’, respectively.

As stated hereinabove, and as exemplified hereinbelow in the Examples section, while performing experiments for the objective of trying to decrease the ‘cyanide species concentration reduction processing time’ by feasibly and optimally integrating a chemical treatment of cyanide-containing water into an electrolytic treatment of cyanide-containing water (e.g., via Steps (b)-(d) of specific embodiments of the method of the present invention), the inventors unexpectedly observed that the ‘cyanide species concentration reduction processing time’ (i.e., the ‘electrolytic and chemical treatment total processing time’) of the integrated cyanide removal method of the present invention was unexpectedly, significantly less (e.g., up to about 65% less) compared to the ‘cyanide species concentration reduction processing time’ (i.e., the ‘electrolytic only treatment total processing time’) of a cyanide removal method based on similar electrolytic only treatment (i.e., without chemical treatment [via Steps (b)-(d) of the method of the present invention]) of cyanide-containing water 12.

Duration (Interval or Period) of Time Required for (Chemically) Further Decreasing Cyanide Species Concentration from the First Concentration Value to the Second Concentration Value: Duration (Interval or Period) of Time Required for Performing the Chemical Treatment (Steps (b)-(d))

By further analyzing the ‘cyanide species concentration reduction processing time’ data of the preceding stated comparative studies, the inventors made the following two critically important observations.

First, when implementing some embodiments of the integrated cyanide removal method of the present invention, the step of chemically treating the recycled electrolytically treated cyanide-containing water 210 requires, and is therefore performed for, a ‘duration of time’ in a range of between about 5-17%, and even for ‘as low as’ in a range of between about 4.5-6.3%, of the ‘total duration of time’ required to decrease the cyanide species concentration from the initial cyanide species concentration to the second concentration value of the clean treated water 210′ contained inside the recycle tank 200. More specifically, the duration (interval or period) of time required for (chemically) further decreasing the cyanide species concentration inside recycle tank 200 from the first concentration value {i.e., of about 10 percent of the initial concentration (of cyanide-containing water 12 of less than about 500 milligrams per liter (mg/l) [500 parts per million (ppm)])}, corresponding to the point of time between completion of Step (b) and initiation of Step (c), to the (final, clean treated water 210′) second concentration value {i.e., of less than 1 milligram per liter (mg/l) [1 part per million (ppm)}, corresponding to the point of time at completion of Step (d), unexpectedly accounted for in a range of between about 5-17%, and even for ‘as low as’ in a range of between about 4.5-6.3%, of the ‘cyanide species concentration reduction processing time’ (i.e., the ‘electrolytic and chemical treatment total processing time’).

Second, by strong contrast, when implementing a cyanide removal method based on similar electrolytic only treatment (i.e., without chemical treatment [via Steps (b)-(d) of the method of the present invention]) of cyanide-containing water 12, the duration (interval or period) of time required for (electrolytically only) further decreasing the cyanide species concentration inside recycle tank 200 from the first concentration value {i.e., of about 10 percent of the initial concentration (of cyanide-containing water 12 of less than about 500 milligrams per liter (mg/l) [500 parts per million (ppm)])}, to the (final, clean treated water 210′) second concentration value {i.e., of less than 1 milligram per liter (mg/l) [1 part per million (ppm)}, accounted for ‘as high as’ in a range of between about 58-83% of the ‘cyanide species concentration reduction processing time’ (i.e., the ‘electrolytic only treatment total processing time’).

The preceding two critically important observations lead the inventors to therefore generally conclude that when implementing some embodiments of the integrated cyanide removal method of the present invention, the duration (interval or period) of time required for (chemically) further decreasing the cyanide species concentration inside recycle tank 200 from the first concentration value {i.e., of about 10 percent of the initial concentration (of cyanide-containing water 12 of less than about 500 milligrams per liter (mg/l) [500 parts per million (ppm)])}, to the (final, clean treated water 210′) second concentration value {i.e., of less than 1 milligram per liter (mg/l) [1 part per million (ppm)}, is in a range of between about 6% and 23% [i.e., about 5-17% compared to about 58-83%] of the duration (interval or period) of time required for (electrolytically only) further decreasing the cyanide species concentration when implementing a cyanide removal method based on similar electrolytic only treatment (i.e., without chemical treatment [via Steps (b)-(d) of the method of the present invention]) of cyanide-containing water 12.

The preceding discussion leads to the overall general conclusion that implementing some embodiments of the hereinabove illustratively described, and hereinbelow exemplified, integrated cyanide removal method (FIG. 1) of the present invention, for example, by using the hereinabove illustratively described integrated cyanide removal system 10 (FIG. 2), is significantly less time consuming than implementing a cyanide removal method based on similar electrolytic only treatment (i.e., without chemical treatment [via Steps (b)-(d) of the method of the present invention]).

### EXAMPLES

Selected embodiments of the present invention, including novel and inventive aspects, characteristics, special technical features, and advantages thereof, as illustratively described hereinabove, and as claimed in the claims section hereinbelow, are exemplified and have experimental support in the following examples, which are not intended to be limiting.

Electrolytically and Chemically Removing Cyanide Species from Cyanide-Containing Water

These Examples provide exemplary implementations of some embodiments of the integrated electrolytic and chemical method for electrolytically and chemically removing cyanide species from cyanide-containing water wherein cyanide species concentration is less than about 500 milligrams per liter (mg/l) [500 parts per million (ppm)], of the present invention, using an exemplary integrated cyanide removal system (i.e., the integrated cyanide species removal system 10 shown in FIG. 2), as illustratively described hereinabove. In the below description of the Examples, parenthesized reference numbers refer to the components of the exemplary integrated cyanide species removal system 10 shown in FIG. 2.

The integrated electrolytic and chemical method for electrolytically and chemically removing cyanide species from cyanide-containing water, for producing clean treated water wherein cyanide species concentration is less than 1 milligram per liter (mg/l) [1 part per million (ppm)], was found to be generally applicable to removing cyanide species from various different types or kinds (sources) of cyanide-containing water, wherein the cyanide-containing water included a single type or kind of cyanide species, or included a combination of two or more different types or kinds of cyanide species.

Exemplary implementations of the integrated electrolytic and chemical method for electrolytically and chemically removing cyanide species from cyanide-containing water, were performed using the same or similar procedures involving different sized (e.g., 1500 liter, 2000 liter, 3000 liter) batches of cyanide-containing water, wherein each batch the (initial) cyanide species concentration was less than about 500 milligrams per liter (mg/l) [500 parts per million (ppm)], which were obtained from an external source being (effluent) output of an actual commercial scale industrial mining, metal electroplating, chemical, petrochemical, metallurgical, or paper milling, process, and where the cyanide-containing water contained a single transition metal cyanide, being nickel cyanide [Ni(CN)₂], copper cyanide [CuCN], zinc cyanide [Zn(CN)₂], cadmium cyanide [CdCN], or gold cyanide [AuCN]. In general, for all of the exemplary implementations, the same or similar overall results were obtained which lead to the same or similar overall general conclusions.

### Materials and Methods

### Cyanide-Containing Water

The following Examples provide typical, exemplary implementations of the integrated electrolytic and chemical method for electrolytically and chemically removing cyanide species from cyanide-containing water. For the immediately following Examples provided herein, three separate 1000 liter batches of cyanide-containing water (12), wherein each batch the (initial) cyanide species concentration was less than about 500 milligrams per liter (mg/l) [500 parts per million (ppm)], specifically, 490 (mg/l; ppm), 300 (mg/l; ppm), or 100 (mg/l; ppm), were obtained from an external source (24) being (effluent) output of an actual commercial scale industrial metal electroplating process. The cyanide-containing water (12) contained a single transition metal cyanide, being zinc cyanide [Zn(CN)₂].

In each of a first set and a (comparative or reference) second set, herein, also referred to as First Set and Second Set, respectively, three separate 1000 liter batches of cyanide-containing water (12), wherein each batch had a different initial cyanide species concentration less than about 500 milligrams per liter (mg/l) [500 parts per million (ppm)], were identified as follows:

Experimental Batch No. 1: 490 (mg/l; ppm) initial cyanide species concentration.
Experimental Batch No. 2: 300 (mg/l; ppm) initial cyanide species concentration.
Experimental Batch No. 3: 100 (mg/l; ppm) initial cyanide species concentration.

### Cyanide Removal System

For these Examples, there was using an actual experimental and testing set up of the hereinabove illustratively described exemplary integrated cyanide removal system (10, FIG. 2).

### Cyanide Removal Method

In the first part of these Examples, the First Set of three separate 1000 liter batches of the cyanide-containing water (12) was subjected to the integrated cyanide species removal method for producing clean treated water (210′) wherein cyanide species concentration was less than 1 milligram per liter (mg/l) [1 part per million (ppm)], with including chemical treatment via in-situ real time freshly generated hypochlorite ion solution (230) electrolytically produced by the in-situ hypochlorite ion solution generating electrolytic reactor assembly (202) configured in-line with the recycle tank (200).

Accordingly, the first part of these Examples was performed by using the hereinabove illustratively described integrated electrolytic and chemical method for electrolytically and chemically removing cyanide species from cyanide-containing water, including Steps (a), (b), (c), (d), and (e), [blocks (frames) 2, 4, 6, 8, and 9, respectively, in FIG. 1], and various sub-steps thereof, via using the preceding stated experimental and testing set up of the exemplary integrated cyanide removal system.

In the second part of these Examples, the (comparative or reference) Second Set of three separate 1000 liter batches of the cyanide-containing water (12) was subjected to the same electrolytic treatment as the first set, but without including chemical treatment via electrolytically generated fresh hypochlorite ion solution (230).

Accordingly, the (comparative or reference) second part of these Examples was performed by using an ‘abbreviated or modified’ embodiment of the hereinabove illustratively described integrated cyanide species removal method, including Step (a), a modified merge or combination of Steps (b) and (d), and Step (e). In the modified merge or combination of Steps (b) and (d), there was ‘stopping (terminating) the electrolytic treatment when the cyanide species concentration of the recycled electrolytically treated cyanide-containing water (210) decreased to the second concentration value of less than 1 milligram per liter, for forming the clean treated water (210′) of the second concentration value contained inside the recycle tank (200), and various sub-steps thereof, via using the preceding stated experimental and testing set up of the exemplary integrated cyanide removal system.

In these Examples, for performing each of the preceding described first and second parts, for each 1000 liter batch of the cyanide-containing water (12), during the stage of performing Step (a), there was included the hereinabove illustratively described ‘one-time’ addition of a small (volumetric or mass) amount of aqueous sodium chloride [NaCl] solution to the recycled electrolytically treated cyanide-containing water (210) inside the recycle tank (200), for the main purpose of increasing ion content, and therefore, increasing electrical conductivity, of the recycled electrolytically treated cyanide-containing water (210) which was recycled through the electrolytic reactor unit (16).

### Result Oriented Parameters Measured

For the first part (First Set) of these Examples, for each Experimental Batch No. 1, 2, and 3, there was measured the cyanide species concentration (mg/l; ppm), and the elapsed time (minutes), at selected main stages of implementing the integrated cyanide species removal method.

For the (comparative or reference) second part (Second Set) of these Examples, for each Experimental Batch No. 1, 2, and 3, there was measured the cyanide species concentration (mg/l; ppm), and the elapsed time (minutes), at selected main stages of implementing the same electrolytic treatment as the First Set (but without including chemical treatment via electrolytically generated fresh hypochlorite ion solution).

For each of the first part (First Set) and (comparative or reference) second part (Second Set) of these Examples, the ‘elapsed time’ is defined as the duration (interval or period) of time spanning from the time of starting the procedure in Step (a) of initiating and directing the electrolytic reactor unit feed solution (15) to flow from the water holding and mixing vessel (110) and into the reactor housing bottom section (42b) of the reactor housing assembly (42) of the electrolytic reactor unit (16), through the time of attaining the indicated cyanide species concentration value (i.e., the first concentration value, or the second concentration value) inside the recycle tank (200).

Accordingly, for the First Set of Experimental Batch Nos. 1, 2, and 3, the ‘total elapsed time’ corresponds to the total duration (interval or period) of time spanning from the time of starting the procedure in Step (a) of initiating and directing the electrolytic reactor unit feed solution (15) to flow from the water holding and mixing vessel (110) and into the electrolytic reactor unit (16), through the time of attaining the second concentration value (i.e., of less than 1 milligram per liter (mg/l) [1 part per million (ppm)]) of the cyanide species inside the recycle tank (200). For the first set of Experimental Batch Nos. 1, 2, and 3, the ‘total elapsed time’ corresponds to the ‘electrolytic and chemical treatment total processing time’, which, in turn, is also referred to as the ‘cyanide species concentration reduction processing time’.

Similarly (but not identically), for the purpose of comparison or reference, for the Second Set of Experimental Batch Nos. 1, 2, and 3, the ‘total elapsed time’ corresponds to the ‘electrolytic only treatment total processing time’, which, in turn, is also referred to as the ‘cyanide species concentration reduction processing time’.

### Analytical Procedures

Cyanide species concentration of the various different forms of cyanide-containing water, i.e., (i) the (initial) cyanide-containing water (12) supplied from the external source (24), wherein the initial cyanide species concentration was less than about 500 milligrams per liter (mg/l) [500 parts per million (ppm)], (ii) the recycled electrolytically treated cyanide-containing water (210), (iii) the recycled electrolytically treated cyanide-containing water (210) of the first concentration value (of about 10 percent of the initial concentration) contained inside the recycle tank (200) of the recycle unit (22), and (iv) clean treated water (210′) of the second concentration value (of less than 1 milligram per liter (mg/l) [1 part per million (ppm)] contained inside the recycle tank (200) of the recycle unit (22) and subsequently output to a sink (92) of the output unit (20), was ‘manually’ measured by using standard wet chemistry analytical instrumentation and techniques, such as spectrophotometry, which are well known in the art of determining cyanide species concentration in cyanide-containing water samples.

Additionally, cyanide species concentration of: (ii) the recycled electrolytically treated cyanide-containing water (210), (iii) the recycled electrolytically treated cyanide-containing water (210) of the first concentration value (of about 10 percent of the initial concentration) contained inside the recycle tank (200) of the recycle unit (22), and (iv) clean treated water (210′) of the second concentration value (of less than 1 milligram per liter (mg/l) [1 part per million (ppm)] contained inside the recycle tank (200) of the recycle unit (22) and subsequently output to a sink (92) of the output unit (20), were also ‘automatically’ measured via the cyanide species concentration measuring loop 274, via the recycle water redox (reduction-oxidation) potential measuring mechanism 204. The recycle water redox (reduction-oxidation) potential measuring mechanism 204 was configured and functioned for continuously measuring the redox (reduction-oxidation) potential (in units of millivolts) of the recycled electrolytically treated cyanide-containing water 210 inside the recycle tank 200.

### Results

Results of these Examples are tabulated and presented in Tables 1, 2, and 3, below, and are discussed in the following two main sections, (1) and (2), as follows.

### (1) Cyanide Species Concentration Reduction Processing Time

Table 1 includes a tabulation of the ‘cyanide species concentration reduction processing time’ (or, equivalently, the ‘total elapsed time’), expressed in time units of minutes, required for completing the main stage of attaining the second concentration value (i.e., of less than 1 milligram per liter (mg/l) [1 part per million (ppm)]) of cyanide species inside the recycle tank (200), for each of the First and Second sets of three separate experimental 1000 liter batches (i.e., Experimental Batch Nos. 1, 2, and 3) of cyanide-containing water, wherein each batch had a different initial cyanide species concentration.

TABLE 1
Cyanide Species Conc. Reduction Processing Time (minutes)

| | First Set | Second Set |
|---|---|---|
| | With Chemical | Without Chemical |
| Experimental | Treatment via Fresh | Treatment via Fresh |
| Batch No. | Hypochlorite Ion Solution | Hypochlorite Ion Solution |
| 1 | 157 | 400 |
| 2 | 85 | 240 |
| 3 | 32 | 80 |

Cyanide species concentration reduction processing time (total elapsed time) (minutes) required for completing the main stage of attaining the second concentration value (of less than 1 milligram per liter (mg/l) [1 part per million (ppm)]) of cyanide species, for the First and Second sets of three separate experimental 1000 liter batches (i.e., Experimental Batch Nos. 1, 2, and 3) of cyanide-containing water, wherein each batch had a different initial cyanide species concentration.

As explained in further detail in the hereinabove section preceding this Examples section, for characterizing a main aspect of the integrated cyanide removal method of the present invention, in general, and for characterizing a main aspect of performing of Steps (b)-(d), in particular, herein, there is defined and used the critically important time parameter of the ‘cyanide species concentration reduction processing time’ (also referred to as the ‘electrolytic and chemical treatment total processing time’), which refers to the total duration (interval or period) of time required to decrease the cyanide species concentration from the initial cyanide species concentration (i.e., of less than about 500 milligrams per liter (mg/l) [500 parts per million (ppm)]) in the cyanide-containing water (12) to the second concentration value (i.e., of less than 1 milligram per liter (mg/l) [1 part per million (ppm)]) of the clean (electrolytically and chemically) treated water (210′) (the clean treated water (210′)) contained inside the recycle tank (200) of the recycle unit (22).

The time parameter ‘cyanide species concentration reduction processing time’ is especially useful for comparing, analyzing, and understanding the differences between, the data presented in Table 1 of the first part (First Set) and second part (Second Set) of these Examples. Such comparison corresponds to comparing exemplary implementation of specific embodiments of the integrated cyanide removal method of the present invention to exemplary implementation of a cyanide removal method based on similar electrolytic only treatment (i.e., without chemical treatment [via Steps (b)-(d) of the method of the present invention]) of the cyanide-containing water (12), wherein such a case, the ‘cyanide species concentration reduction processing time’ corresponds to an ‘electrolytic only treatment total processing time’.

Comparison of the data of the First Set and the Second Set presented in Table 1 shows that the ‘cyanide species concentration reduction processing time’ (i.e., the ‘electrolytic and chemical treatment total processing time’) of the First Set of Experimental Batch Nos. 1, 2, and 3, corresponding to exemplary implementation of a specific embodiment of the integrated cyanide removal method of the present invention, was unexpectedly, significantly less (e.g., up to about 65% less) compared to the ‘cyanide species concentration reduction processing time’ (i.e., the ‘electrolytic only treatment total processing time’) of the (comparative or reference) Second Set of Experimental Batch Nos. 1, 2, and 3, corresponding to exemplary implementation of a cyanide removal method based on similar electrolytic only treatment (i.e., without chemical treatment [via Steps (b)-(d) of the method of the present invention]) of the cyanide-containing water (12). Specifically, for Experimental Batch Nos. 1, 2, and 3: 157 minutes (First Set) compared to 400 minutes (Second Set)=[1−(157/400)]×100%=61% less time; 85 minutes (First Set) compared 240 minutes (Second Set)=[1−(85/240)]×100%=65% less time; and 32 minutes (First Set) compared 80 minutes (Second Set)=[1−(32/80)]×100%=60% less time.

As indicated above, for each Experimental Batch No., the % less time was calculated as follows:

% less time=[1−(t₁{First Set})/(t₂{Second Set})]×100%,

where
t₁{First Set}=First Set ‘cyanide species concentration reduction processing time’ ('electrolytic and chemical treatment total processing time') (minutes), and
t₂{Second Set}=Second Set ‘cyanide species concentration reduction processing time’ (‘electrolytic only treatment total processing time’) (i.e., without chemical treatment [via Steps (b)-(d) of the method of the present invention]) (minutes).
(2) Duration (Interval or Period) of Time Required for Further Decreasing Cyanide Species Concentration from the First Concentration Value to the Second Concentration Value

Table 2 includes a tabulation of the cyanide species concentration (mg/l; ppm), and the elapsed time (minutes), at selected main stages of implementing the integrated cyanide species removal method, for the First Set of three separate experimental 1000 liter batches (i.e., Experimental Batch Nos. 1, 2, and 3) of cyanide-containing water wherein each batch had a different initial cyanide species concentration.

TABLE 2
First Set - Cyanide Species Concentration
(mg/l; ppm), and elapsed time

| Experimental | Initial | First | Second |
|---|---|---|---|
| Batch No. | Concentration | Concentration Value | Concentration Value |
| 1 | 490 | 49, at 150 minutes | <1, at 157 minutes |
| 2 | 300 | 30, at 80 minutes | <1, at 85 minutes |
| 3 | 100 | 10, at 30 minutes | <1, at 32 minutes |

Cyanide species concentration (mg/l; ppm), and elapsed time (minutes), at selected main stages of implementing the integrated cyanide species removal method, for the First Set of three separate experimental 1000 liter batches of cyanide-containing water wherein each batch had a different initial cyanide species concentration.

Table 3 includes a tabulation of the cyanide species concentration (mg/l; ppm), and the elapsed time (minutes), at selected main stages of implementing the same electrolytic treatment as the First Set (but without including chemical treatment via electrolytically generated fresh hypochlorite ion solution), for the (comparative or reference) Second Set of three separate experimental 1000 liter batches (i.e., Experimental Batch Nos. 1, 2, and 3) of cyanide-containing water wherein each batch had a different initial cyanide species concentration.

TABLE 3
Second Set - Cyanide Species Concentration
(mg/l; ppm), and elapsed time

| Experimental | Initial | First | Second |
|---|---|---|---|
| Batch No. | Concentration | Concentration Value | Concentration Value |
| 1 | 490 | 49, at 150 minutes | <1, at 400 minutes |
| 2 | 300 | 30, at 80 minutes | <1, at 240 minutes |
| 3 | 100 | 10, at 30 minutes | <1, at 80 minutes |

Cyanide species concentration (mg/l; ppm), and elapsed time (minutes), at selected main stages of implementing the same electrolytic treatment as the First Set (but without including chemical treatment via electrolytically generated fresh hypochlorite ion solution), for the (comparative or reference) Second Set of three separate experimental 1000 liter batches of cyanide-containing water wherein each batch had a different initial cyanide species concentration.

The results presented in Table 2 show that by taking the differences of the elapsed times between the second and first concentrations values, then, for the First Set of Experimental Batch Nos. 1, 2, and 3, a duration (interval or period) of time of 7 minutes, 5 minutes, and 2 minutes, respectively, was required for (chemically) further decreasing the cyanide species concentration inside the recycle tank (200) from the first concentration value to the (final, clean treated water (210′)) second concentration value of cyanide species concentration less than 1 milligram per liter (mg/l) [1 part per million (ppm)], with including chemical treatment via electrolytically generated fresh hypochlorite ion solution (230).

The results presented in Table 3 show that by taking the differences of the elapsed times between the second and first concentrations values, then, for the (comparative or reference) Second Set of Experimental Batch Nos. 1, 2, and 3, a duration (interval or period) of time of 250 minutes, 160 minutes, and 50 minutes, respectively, was required for (electrolytically only) further decreasing the cyanide species concentration inside the recycle tank (200) from the first concentration value to the (final, clean treated water (210′)) second concentration value of cyanide species concentration less than 1 milligram per liter (mg/l) [1 part per million (ppm)], without including chemical treatment via electrolytically generated fresh hypochlorite ion solution (230).

Further analysis of the results presented in Tables 2 and 3 of these Examples lead to the following two critically important observations.

### First Observation Regarding the First Set of Experimental Batch Nos. 1, 2, and 3 (Table 2)

Based on the data presented in Table 2 for the First Set of Experimental Batch Nos. 1, 2, and 3, corresponding to exemplary implementations of specific embodiments of the integrated cyanide removal method of the present invention, the step of chemically treating the recycled electrolytically treated cyanide-containing water (210) required a ‘duration of time’ in a range of between about 4.5-6.3% of the ‘total duration of time’ required to decrease the cyanide species concentration from the initial cyanide species concentration to the second concentration value of the clean treated water (210′) contained inside the recycle tank (200). More specifically, the duration (interval or period) of time required for (chemically) further decreasing the cyanide species concentration inside the recycle tank (200) from the first concentration value {i.e., of about 10 percent of the initial concentration (of the cyanide-containing water (12) of less than about 500 milligrams per liter (mg/l) [500 parts per million (ppm)])}, corresponding to the point of time between completion of Step (b) and initiation of Step (c), to the (final, clean treated water (210′)) second concentration value {i.e., of less than 1 milligram per liter (mg/l) [1 part per million (ppm)}, corresponding to the point of time at completion of Step (d), unexpectedly accounted for ‘as low as’ in a range of between about 4.5-6.3% of the ‘cyanide species concentration reduction processing time’ (i.e., the ‘electrolytic and chemical treatment total processing time’).

From the data presented in Table 2 for the First Set of Experimental Batch Nos. 1, 2, and 3, the % ‘duration of time’ for performing the step of chemically treating the recycled electrolytically treated cyanide-containing water (210) of the ‘total duration of time’ required to decrease the cyanide species concentration from the initial cyanide species concentration to the second concentration value of the clean treated water (210′) contained inside the recycle tank (200) was calculated as follows:

% ‘duration of time’ for chemical treatment of the ‘total duration of time’=Δet×100,

where
Δet=(et₂−et₁)/et₂,
et₁=elapsed time (minutes) at cyanide species First Concentration Value, and
et₂=elapsed time (minutes) at cyanide species Second Concentration Value.
Thus, based on the data presented in Table 2 for the First Set of Experimental Batch Nos. 1, 2, and 3:

for Experimental Batch No. 1: % ‘duration of time’ for chemical treatment of the ‘total duration of time’=[(157−150)/157]×100=4.5%.

for Experimental Batch No. 2: % ‘duration of time’ for chemical treatment of the ‘total duration of time’=[(85−80)/85]×100=5.9%.

for Experimental Batch No. 3: % ‘duration of time’ for chemical treatment of the ‘total duration of time’=[(32−30)/32]×100=6.3%.

### Second Observation Regarding the Second Set of Experimental Batch Nos. 1, 2, and 3 (Table 3)

Based on the data presented in Table 3 for the (comparative or reference) Second Set of Experimental Batch Nos. 1, 2, and 3, corresponding to exemplary implementations of a cyanide removal method based on similar electrolytic only treatment (i.e., without chemical treatment [via Steps (b)-(d) of the method of the present invention]) of the cyanide-containing water (12), the duration (interval or period) of time required for (electrolytically only) further decreasing the cyanide species concentration inside the recycle tank (200) from the first concentration value {i.e., of about 10 percent of the initial concentration (of the cyanide-containing water (12) of less than about 500 milligrams per liter (mg/l) [500 parts per million (ppm)])}, to the (final, clean treated water (210′)) second concentration value {i.e., of less than 1 milligram per liter (mg/l) [1 part per million (ppm)}, accounted for ‘as high as’ in a range of between about 63-67% of the ‘cyanide species concentration reduction processing time’ (i.e., the ‘electrolytic only treatment total processing time’).

From the data presented in Table 3 for the Second Set of Experimental Batch Nos. 1, 2, and 3, the % ‘duration of time’ for (electrolytically only) further decreasing the cyanide species concentration of the recycled electrolytically treated cyanide-containing water (210) of the ‘total duration of time’ required to decrease the cyanide species concentration from the initial cyanide species concentration to the second concentration value of the clean treated water (210′) contained inside the recycle tank (200) was calculated as follows:

% ‘duration of time’ for ‘electrolytic only’ treatment of the ‘total duration of time’=Δet×100,

where
Δet=(et₂−et₁)/et₂,
et₁=elapsed time (minutes) at cyanide species First Concentration Value, and
et₂=elapsed time (minutes) at cyanide species Second Concentration Value.
Thus, based on the data presented in Table 3 for the Second Set of Experimental Batch Nos. 1, 2, and 3:

for Experimental Batch No. 1: % ‘duration of time’ for ‘electrolytic only’ treatment of the ‘total duration of time’=[(400−150)/400]×100=63%.

for Experimental Batch No. 2: % ‘duration of time’ for ‘electrolytic only’ treatment of the ‘total duration of time’=[(240−80)/240]×100=67%.

for Experimental Batch No. 3: % ‘duration of time’ for ‘electrolytic only’ treatment of the ‘total duration of time’=[(80−30)/80]×100=63%.

The preceding two critically important observations lead to the general conclusion that by implementing some embodiments of the integrated cyanide removal method of the present invention, the duration (interval or period) of time required for (chemically) further decreasing the cyanide species concentration inside the recycle tank 200 from the first concentration value {i.e., of about 10 percent of the initial concentration (of cyanide-containing water 12 of less than about 500 milligrams per liter (mg/l) [500 parts per million (ppm)])}, to the (final, clean treated water 210′) second concentration value {i.e., of less than 1 milligram per liter (mg/l) [1 part per million (ppm)}, was on the order of ‘less than’ one-tenth (< 1/10 or 0.1) [i.e., about 4.5-6.3% compared to about 63-67%] of the duration (interval or period) of time required for (electrolytically only) further decreasing the cyanide species concentration when implementing a cyanide removal method based on similar electrolytic only treatment (i.e., without chemical treatment [via Steps (b)-(d) of the method of the present invention]) of the cyanide-containing water 12. This general conclusion translates into a significant savings in time, and therefore, expense, for removing cyanide species from cyanide-containing water, for producing clean treated water wherein cyanide species concentration is less than 1 milligram per liter (mg/l) [1 part per million (ppm)].

The above Examples provide typical, exemplary implementations of the integrated electrolytic and chemical method for electrolytically and chemically removing cyanide species from cyanide-containing water, for three separate 1000 liter batches of cyanide-containing water, wherein each batch the (initial) cyanide species concentration was less than about 500 milligrams per liter (mg/l) [500 parts per million (ppm)], which were obtained from an external source being (effluent) output of an actual commercial scale industrial metal electroplating process, and where the cyanide-containing water contained a single transition metal cyanide, being zinc cyanide [Zn(CN)₂].

### Additional Examples

Additional exemplary implementations of the integrated electrolytic and chemical method for electrolytically and chemically removing cyanide species from cyanide-containing water, were performed using the same or similar procedures involving different sized (e.g., 1500 liter, 2000 liter, 3000 liter) batches of cyanide-containing water, wherein each batch the (initial) cyanide species concentration was less than about 500 milligrams per liter (mg/l) [500 parts per million (ppm)], which were obtained from an external source being (effluent) output of an actual commercial scale industrial mining, metal electroplating, chemical, petrochemical, metallurgical, or paper milling, process, and where the cyanide-containing water contained a single transition metal cyanide, being nickel cyanide [Ni(CN)₂], copper cyanide [CuCN], zinc cyanide [Zn(CN)₂], cadmium cyanide [CdCN], or gold cyanide [AuCN]. In general, for such additional exemplary implementations, the same or similar overall results were obtained which lead to the same or similar overall general conclusions, as those described above.

Analysis of the results of Additional Examples lead to the following two critically important observations.

### First Observation Regarding the First Sets of Experimental Batches

Based on the data obtained for several First Sets of Experimental Batches, corresponding to exemplary implementations of specific embodiments of the integrated cyanide removal method of the present invention, the step of chemically treating the recycled electrolytically treated cyanide-containing water (210) required a ‘duration of time’ in a range of between about 5-17% of the ‘total duration of time’ required to decrease the cyanide species concentration from the initial cyanide species concentration to the second concentration value of the clean treated water (210′) contained inside the recycle tank (200). More specifically, the duration (interval or period) of time required for (chemically) further decreasing the cyanide species concentration inside the recycle tank (200) from the first concentration value {i.e., of about 10 percent of the initial concentration (of the cyanide-containing water (12) of less than about 500 milligrams per liter (mg/l) [500 parts per million (ppm)])}, corresponding to the point of time between completion of Step (b) and initiation of Step (c), to the (final, clean treated water (210′)) second concentration value {i.e., of less than 1 milligram per liter (mg/l) [1 part per million (ppm)}, corresponding to the point of time at completion of Step (d), unexpectedly accounted for ‘as low as’ in a range of between about 5-17% of the ‘cyanide species concentration reduction processing time’ (i.e., the ‘electrolytic and chemical treatment total processing time’).

### Second Observation Regarding the Second Sets of Experimental Batches

Based on the data obtained for several (comparative or reference) Second Sets of Experimental Batches, corresponding to exemplary implementations of a cyanide removal method based on similar electrolytic only treatment (i.e., without chemical treatment [via Steps (b)-(d) of the method of the present invention]) of the cyanide-containing water (12), the duration (interval or period) of time required for (electrolytically only) further decreasing the cyanide species concentration inside the recycle tank (200) from the first concentration value {i.e., of about 10 percent of the initial concentration (of the cyanide-containing water (12) of less than about 500 milligrams per liter (mg/l) [500 parts per million (ppm)])), to the (final, clean treated water (210′)) second concentration value {i.e., of less than 1 milligram per liter (mg/l) [1 part per million (ppm)}, accounted for ‘as high as’ in a range of between about 58-83% of the ‘cyanide species concentration reduction processing time’ (i.e., the ‘electrolytic only treatment total processing time’).

The preceding two critically important observations lead to the general conclusion that by implementing some embodiments of the integrated cyanide removal method of the present invention, the duration (interval or period) of time required for (chemically) further decreasing the cyanide species concentration inside the recycle tank 200 from the first concentration value {i.e., of about 10 percent of the initial concentration (of cyanide-containing water 12 of less than about 500 milligrams per liter (mg/l) [500 parts per million (ppm)])}, to the (final, clean treated water 210′) second concentration value {i.e., of less than 1 milligram per liter (mg/l) [1 part per million (ppm)}, was in a range of between about 6% and 23% [i.e., about 5-17% compared to about 58-83%] of the duration (interval or period) of time required for (electrolytically only) further decreasing the cyanide species concentration when implementing a cyanide removal method based on similar electrolytic only treatment (i.e., without chemical treatment [via Steps (b)-(d) of the method of the present invention]) of the cyanide-containing water 12. This general conclusion confirms the above obtained general conclusion, translating into a significant savings in time, and therefore, expense, for removing cyanide species from cyanide-containing water, for producing clean treated water wherein cyanide species concentration is less than 1 milligram per liter (mg/l) [1 part per million (ppm)].

The present invention, as illustratively described and exemplified hereinabove, has several beneficial and advantageous aspects, characteristics, and features.

The present invention is particularly applicable for electrolytically and chemically decreasing low levels, specifically, less than about 500 milligrams per liter (mg/l) [500 parts per million (ppm)], of cyanide species concentration in cyanide-containing water produced during a high volume throughput (for example, on the order of at least about 1000 liters per hour (l/hr) [1000 cubic meters per hour (m³/hr)]) commercial scale industrial process, such as a mining, metal electroplating, chemical, petrochemical, metallurgical, or paper milling, process. The present invention is generally applicable to removing cyanide species from various different types or kinds (sources) of cyanide-containing water, wherein the cyanide-containing water includes a single type or kind of cyanide species, or includes a combination of two or more different types or kinds of cyanide species. The present invention is readily commercially applicable, practical, and economically feasible to implement. Moreover, implementation of the hereinabove illustratively described and exemplified integrated cyanide removal method of the present invention, for example, by using the hereinabove illustratively described exemplary integrated cyanide removal system, is significantly less time consuming than implementing a cyanide removal method based on similar electrolytic only treatment (i.e., without chemical treatment of the method of the present invention).

The present invention successfully addresses and overcomes various shortcomings and limitations, and widens the scope, of currently known techniques in the relevant field(s) and art(s) of the invention, as relating to electrolytically and chemically removing cyanide species from cyanide-containing water.

It is to be fully understood that certain aspects, characteristics, and features, of the present invention, which are illustratively described and presented in the context or format of a plurality of separate embodiments, may also be illustratively described and presented in any suitable combination or sub-combination in the context or format of a single embodiment. Conversely, various aspects, characteristics, and features, of the present invention, which are illustratively described and presented in combination or sub-combination in the context or format of a single embodiment, may also be illustratively described and presented in the context or format of a plurality of separate embodiments.

Although the invention has been illustratively described and presented by way of specific embodiments, and examples thereof, it is evident that many alternatives, modifications, and variations, thereof, will be apparent to those skilled in the art. Accordingly, it is intended that all such alternatives, modifications, and variations, fall within, and are encompassed by, the scope of the appended claims.

All patents, patent applications, and publications, cited or referred to in this specification are herein incorporated in their entirety by reference into the specification, to the same extent as if each individual patent, patent application, or publication, was specifically and individually indicated to be incorporated herein by reference. In addition, citation or identification of any reference in this specification shall not be construed or understood as an admission that such reference represents or corresponds to prior art of the present invention. To the extent that section headings are used, they should not be construed as necessarily limiting.

### REFERENCES

1. U.S. Pat. No. 6,551,514, “Cyanide Detoxification Process”, Misra, et al.
2. CA (Canada) (Patent) Publication No. CA 1027514 (1978), “Decreasing Cyanide Content By An Electrochemical Technique”, Tarjanyi, M., and Strier, M. P.
3. GB (Great Britain) (Patent) Publication No. GB 1025282A (1966), “Improvements In Or Relating To The Treatment By Electrolytic Oxidation Of Cyanide Wastes”, Dart, M. C.
4. DE (German) (Patent) Publication No. DE 4014023A1 (1991), “Decontamination Of Substance Containing Cyanide, Especially Waste Water—By Treatment With Acid, And Stripping And Destruction Of Hydrogen Cyanide Formed”, Ochotta, G.
5. CN (China) (Patent) Publication No. CN 1219705CC (2003), “Double-recovering Circulation Method For Cyanic Electroplating Effluent And Heavy Metal-containing Electroplating Effluent”, Zhengshu, C.
6. JP (Japan) (Patent) Publication No. JP 2005219001A (2005), “Cyanide Removal Method By Electrolytic Process, And Its Apparatus”.
7. JP (Japan) (Patent) Publication No. JP 2005161247A (2005), “Method For Removing Cyanide Compound By Electrolysis”.
8. U.S. Pat. No. 4,800,024, “Removal Of Heavy Metals And Heavy Metal Radioactive Isotopes From Liquids”, Elfline.
9. U.S. Pat. No. U.S. Pat. No. 5,354,458, “Sequencing Batch Liquid Treatment”, Wang et al.
10. U.S. Pat. No. 6,596,916, “Methods Of Destruction Of Cyanide In Cyanide-Containing Waste”, Fisher.
11. U.S. Pat. No. 6,774,277, “Methods Of Destruction Of Cyanide In Cyanide-Containing Waste”, Fisher.
12. U.S. Pat. Appl. Pub. No. 2003-0069462, “Methods Of Destruction Of Cyanide In Cyanide-Containing Waste”, Fisher.
13. U.S. Pat. Appl. Pub. No. 2005-0070752, “Method For Treating Cyanide Waste Liquid”, Kojima et al.
14. U.S. Pat. No. 6,270,679, “Method For Recovering And Separating Metals From Waste Streams”, Kreisler.
15. GB (Great Britain) (Patent) Publication No. GB 895742A (1962), “Apparatus For Continuously Detoxifying Waste Liquors Containing Soluble Cyanides Or Free Hydrocyanic Acid”, Gold, D., and Roessler, S.-C. V.
16. JP (Japan) (Patent) Publication No. JP 52078763A (1977), “Decomposition Of Cyanide”.
17. JP (Japan) (Patent) Publication No. JP 61071890A (1986), “Treatment Of Waste Water”.
18. JP (Japan) (Patent) Publication No. JP 2001300553A (2001), “Method For Treating Cyanide-Containing Wastewater”.
19. JP (Japan) (Patent) Publication No. JP 2003147444A (2003), “Method For Recovering Valuable Metal From Metal Cyanide-Containing Solution”.
20. JP (Japan) (Patent) Publication No. JP 2006026496A (2006), “Method And Equipment For Treating Cyanide-Containing Waste Water”.
21. GB (Great Britain) (Patent) Publication No. GB1435503A (1976), “Improvements In And Relating To Fluid Treatment”, Birch, D.
22. JP (Japan) (Patent) Publication No. JP 55018501A (1980), “Recovering Method For Valuable Metal From Metal Solution Containing Cyanide Compound Of Valuable Metal”.
23. U.S. Pat. No. 4,975,193, “Method For Removing Cyanide From A Fluid”, Hitzman.
24. EP (Europe) (Patent) Publication No. EP 0613936A1 (1994), “Process For Reducing Of Sour Water Corrosiveness”, Brucken, V., et al.
25. U.S. Pat. No. 5,792,336, “Method For Purification Of Wastewater From Soluble Substances”, Nikolaevsky et al.
26. U.S. Pat. No. 4,145,268, “Method Of Conducting An Electrolysis”, Oehr.
27. U.S. Pat. No. 3,900,377, “Reduction Of Toxicity Of Aqueous Solutions”, Enns et al.
28. KR (Republic of Korea) (Patent) Publication No. KR 100311951BB1 (2001), “Apparatus And Method For Treating Cyanide Wastewater Using Electrolysis”.

What is claimed is:

1. An integrated electrolytic and chemical method for producing clean treated water wherein cyanide species concentration is less than 1 milligram per liter, the method comprising:
electrolytically treating a batch amount of cyanide-containing water wherein initial cyanide species concentration is less than about 500 milligrams per liter, via synchronized operation of an input unit, an electrolytic reactor unit, a recycle unit, an output unit, and, a power supply and process control unit, for forming recycled electrolytically treated cyanide-containing water;
stopping said electrolytic treatment when cyanide species concentration of said recycled electrolytically treated cyanide-containing water decreases to a first concentration value of about 10 percent of said initial concentration, for forming recycled electrolytically treated cyanide-containing water of said first concentration value contained inside a recycle tank of said recycle unit;
chemically treating said recycled electrolytically treated cyanide-containing water of said first concentration value inside said recycle tank with in-situ real time freshly generated hypochlorite ion solution electrolytically produced by an in-situ hypochlorite ion solution generating electrolytic reactor assembly configured in-line with said recycle tank;
stopping said chemical treatment when cyanide species concentration inside said recycle tank decreases to a second concentration value of less than 1 milligram per liter, for forming clean treated water of said second concentration value contained inside said recycle tank; and
outputting said clean treated water of said second concentration value from said recycle tank to said output unit.

2. The method of claim 1, wherein said synchronized operation includes utilizing an empirically determined database of empirically determined values derived from an empirically determined calibration curve or table of empirically determined values of redox potential of said recycled electrolytically treated cyanide-containing water as a function of empirically known or/and determined values of the cyanide species concentration of said recycled electrolytically treated cyanide-containing water.

3. The method of claim 2, wherein the step of stopping said electrolytic treatment is performed by utilizing data and information provided by said empirically determined database.

4. The method of claim 1, wherein the step of stopping said electrolytic treatment includes stopping said recycled electrolytically treated cyanide-containing water inside said recycle tank from exiting said recycle tank.

5. The method of claim 1, wherein the step of stopping said electrolytic treatment includes temporarily stopping of supplying power to electrodes of said electrolytic reactor unit, thereby saving energy (electricity) for operating said electrolytic reactor unit.

6. The method of claim 1, wherein the step of chemically treating said recycled electrolytically treated cyanide-containing water includes preparing a fresh aqueous solution of sodium chloride in a mixing vessel operatively connected to said in-situ hypochlorite ion solution generating electrolytic reactor assembly.

7. The method of claim 6, wherein said sodium chloride is provided to said mixing vessel and is dissolved in water originating from a water source selected from the group consisting of: an externally available water source, and an internally available water source being said recycled electrolytically treated cyanide-containing water of said first concentration value contained inside said recycle tank.

8. The method of claim 6, wherein said sodium chloride is provided to said mixing vessel and is dissolved in water originating from an internally available water source being said recycled electrolytically treated cyanide-containing water of said first concentration value contained inside said recycle tank.

9. The method of claim 6, wherein said freshly prepared aqueous solution of sodium chloride has a sodium chloride concentration in a range of between 40 grams per liter and about 60 grams per liter.

10. The method of claim 1, wherein said electrolytic production of said in-situ real time freshly generated hypochlorite ion solution by said in-situ hypochlorite ion solution generating electrolytic reactor assembly is initiated and performed at a time before, during, or following, said stopping of said electrolytic treatment.

11. The method of claim 1, wherein said in-situ real time freshly generated hypochlorite ion solution has a hypochlorite ion concentration in a range of between about 8 grams per liter and about 12 grams per liter.

12. The method of claim 1, wherein said in-situ real time freshly generated hypochlorite ion solution and said recycled electrolytically treated cyanide-containing water continuously mix and react with each other while inside of said recycle tank, and while circulating through components of a cyanide species measuring loop operatively connected to said recycle tank.

13. The method of claim 2, wherein the step of stopping said chemical treatment is performed by utilizing data and information provided by said empirically determined database.

14. The method of claim 1, wherein the step of stopping said chemical treatment includes temporarily stopping of supplying power to electrodes of said in-situ hypochlorite ion solution generating electrolytic reactor assembly, in a manner for temporarily stopping said electrolytic production of said in-situ real time freshly generated hypochlorite ion solution, thereby saving energy (electricity) for operating said in-situ hypochlorite ion solution generating electrolytic reactor assembly.

15. The method of claim 1, wherein said clean treated water of said second concentration value contained inside said recycle tank has a cyanide concentration of about 0.1 milligram per liter.

16. The method of claim 1, wherein the step of chemically treating said recycled electrolytically treated cyanide-containing water is performed for a duration of time in a range of between about 5-17% of total duration of time required to decrease the cyanide species concentration from said initial cyanide species concentration to said second concentration value of said clean treated water contained inside said recycle tank.

17. The method of claim 1, wherein the step of chemically treating said recycled electrolytically treated cyanide-containing water is performed for a duration of time in a range of between about 4.5-6.3% of total duration of time required to decrease the cyanide species concentration from said initial cyanide species concentration to said second concentration value of said clean treated water contained inside said recycle tank.

18. The method of claim 1, wherein said batch of said cyanide-containing water contains cyanide species in a form selected from the group consisting of free cyanide [CN⁻], a compound containing cyanide, and a radical or ion containing cyanide.

19. The method of claim 18, wherein said compound containing cyanide is selected from the group consisting of hydrogen cyanide or cyanic acid [HCN], simple salts of cyanide, simple metal cyanides, complex alkali-metallic cyanides, and complex ammonium-metallic cyanides.

20. The method of claim 19, wherein said simple metal cyanide is a transition metal cyanide selected from the group consisting of nickel cyanide [Ni(CN)₂], copper cyanide [CuCN], zinc cyanide [Zn(CN)₂], silver cyanide [AgCN], cadmium cyanide [CdCN], gold cyanide [AuCN], and mercury cyanide [Hg(CN)₂].

21. The method of claim 1, wherein said batch of said cyanide-containing water is obtained from an external source being (effluent) output of a commercial scale industrial mining, metal electroplating, chemical, petrochemical, metallurgical, or paper milling, process.

22. The method of claim 1, wherein said batch of said cyanide-containing water has a volume of at least about 1000 liters.

23. The method of claim 1, wherein said initial cyanide species concentration is less than about 100 milligrams per liter.
